(19) United States
(12) Patent Application Publication
(10) Pub. No.: US 2014/0129457 A1
(43) Pub. Date: May 8, 2014

(54) AN INTERACTIVE ORGANIZATIONAL DECISION-MAKING AND COMPLIANCE FACILITATION PORTAL

(71) Applicant: Stroz Friedberg, LLC, New York, NY (US)

(72) Inventor: Matthew Scott Peeler, New York, NY (US)

(73) Assignee: Stroz Friedberg, LLC, New York, NY (US)

(21) Appl. No.: 14/070,025

(22) Filed: Nov. 1, 2013

Related U.S. Application Data
(60) Provisional application No. 61/721,619, filed on Nov. 2, 2012.

(51) Int. Cl. G06Q 30/00

(52) U.S. Cl. CPC G06Q 30/018
USPC 705/317

(57) ABSTRACT

Systems and methods are disclosed for facilitation of enterprise compliance with managed rules or policies, including the use of and interactive compliance application including a decision tree structure with decision nodes, wherein an enterprise user may answer one or more specific questions and compliance guidance with respect to one or more managed rules or policies is provided according to received answers to the questions. An interactive decision facilitation portal enables the decision tree structure, by enabling both computer-algorithm-implemented decision nodes and human-aided decision nodes of the decision tree structure.

### CROSS-REFERENCE TO RELATED APPLICATIONS

This application claims the benefit of the following United States Provisional patent application, which is hereby incorporated by reference herein in its entirety: U.S. Provisional Patent Application Ser. No. 61/721,619, entitled “An Interactive Organizational Decision and Compliance Facilitation Portal”, filed Nov. 2, 2012.

### BACKGROUND

### Field

This disclosure is related to the development and implementation of an interactive organizational decision-making and compliance and compliance facilitation portal.

Human decision-making and computer-based decision-making each have unique strengths and weaknesses. Human decision-making may take advantage of the decision-maker's judgment and experience, but may be inconsistent and may improperly apply rules to facts. Computer-aided decision-making is logical and may consistently apply rules, but lacks intuition and judgment. In the context of organizational decision-making, employees and agents of organizations may fail to comply with policies, such as organization or governmental policies, because they are not aware of the details of those policies or because they are not able to apply those policies within the constraints of a given set of facts and circumstances. For example, in an environment in which many organizations operate in multiple countries to which various sets of compliance rules apply, employees and agents of such organizations may unintentionally or accidentally fail to comply with an organizational rule or an applicable law or regulation. Communicating with employees and agents regarding compliance issues and monitoring compliance may be difficult. Lack of adequate compliance mechanisms may result in unethical conduct. Organizations may become complacent about complying with all of the applicable rules and regulations of one or more countries in which they operate.

Therefore, a need exists for an organizational decision facilitation portal that efficiently integrates human and computer-based decision-making capabilities.

### SUMMARY

Provided herein are methods and systems for an interactive decision facilitation portal with available sources of information and applicable rules, that efficiently allocates human and computer-based decision-making resources for optimal outcomes, and that provides mechanisms for recording, analyzing and reporting on organizational decision-making processes and outcomes. Such an interactive decision portal may have utility in a wide range of decision-making contexts, including (1) compliance with laws, rules, policies, and regulations, (2) investigations, (3) operational management, and (4) collaborative research. In embodiments, provided herein are methods and systems for a decision portal that may offer one or more of the following: (1) a tool that provides assistance to employees and agents of an organization in following organizational policies and the rules and laws of countries in which the organization operates, and which may also help employees and agents to avoid activities contrary to organizational standards; (2) reduction or elimination of accidental or unintentional noncompliance with applicable laws and regulations; (3) creation and implementation of a monitoring system that may require employees and agents to obtain approval from a compliance manager before taking certain actions, thereby reducing the chances of conduct that does not conform to defined policies; (4) processes that foster and help to ensure ethical conduct by employees and agents; and (5) resources, including communication channels and information distribution tools, that may enhance the ability of an organization to comply with the rules, regulations, and laws of the country or countries in which that organization operates.

In embodiments, the systems and methods discussed herein may include a computer program product embodied in a non-transitory computer readable medium, that, when executing on one or more computers, performs method steps for facilitation of enterprise compliance with managed rules or policies. In embodiments, the method may perform the steps of deploying an interactive mobile device compliance application to each of a plurality of enterprise users, wherein the compliance application includes a decision tree structure with decision nodes, and wherein an enterprise user answers one or more specific questions, and compliance guidance with respect to one or more managed rules or policies is provided according to received answers to the questions. The method may include managing an interactive decision facilitation portal to enable the decision tree structure, wherein the interactive decision facilitation portal enables both computer-algorithm-implemented decision nodes and human-aided decision nodes for the decision tree structure. In embodiments, the managed rules or policies may be promulgated by a government and/or an enterprise. The method may further include recording, in a database, interactions of each of the enterprise users with the compliance application to provide a searchable record of enterprise compliance with the managed rules or policies, analyzing the recorded interactions of the enterprise users, and preparing reports regarding compliance with the managed rules or policies by the enterprise users. The method may include establishing bi-directional communication between enterprise users to facilitate a decision with respect to a human-aided decision node, wherein the bi-directional communication comprises email messages and/or voice communication, or the like.

In embodiments, the decision tree structure may include decision nodes relating to at least one of: a selection of a rule or policy, a selection of a country in which a rule or policy applies, a selection of a language, a selection of a currency, a currency amount, a help process relating to a rule or policy, an education process relating to a rule or policy, and an approval process relating to a rule or policy.

In embodiments, the method may include receiving from an administrative user at least one of: information regarding which enterprise users are allowed access to the interactive decision facilitation portal, information regarding country management, information regarding rule and policy management, and metadata management related to an enterprise structure.

In embodiments, the systems and methods discussed herein may include a computer program product embodied in a non-transitory computer readable medium, that, when executing on one or more computers, performs method steps for facilitation of enterprise compliance with managed rules or policies. In embodiments, the method may perform the steps of: providing access for each of a plurality of enterprise users to a web-based compliance application, wherein the compliance application includes a decision tree structure with decision nodes, wherein an enterprise user answers one or more specific questions and compliance guidance with respect to one or more managed rules or policies is provided according to received answers to the questions; and managing an interactive decision facilitation portal to enable the decision tree structure, wherein the interactive decision facilitation portal enables both computer-algorithm-implemented decision nodes and human-aided decision nodes for the decision tree structure.

In embodiments, the systems and methods discussed herein may include a computer program product embodied in a non-transitory computer readable medium, that when executing on one or more computers, performs method steps for facilitation of enterprise compliance with governmental rules. The method may comprise deploying an interactive mobile device compliance application to each of a plurality of enterprise users, wherein the compliance application includes a decision tree structure in which a user answers one or more specific questions and compliance guidance with respect to government rules is provided according to received answers to the questions; managing an interactive decision facilitation portal to enable the decision tree structure, wherein the interactive decision facilitation portal enables both computer-algorithm-implemented decision nodes and human-aided decision nodes for the decision tree structure; and recording, in a relational database, interactions of each of the enterprise users with the compliance application to provide a searchable record of enterprise compliance with government rules. In embodiments, the government rules may include rules related to at least one of gift giving, third party associations with an enterprise, import/export laws, anti-corruption law, and anti-trust laws. The interactions of the enterprise users may be recorded and preparing reports with the managed rules by the enterprise users according to each specific managed rule may be prepared. The interactive compliance application may include various versions for multiple platforms. A user interface for analyzing and viewing the recorded interactions of the enterprise users may be provided.

### BRIEF DESCRIPTION OF THE FIGURES

The invention and the following detailed description of certain embodiments thereof may be understood by reference to the following figures:

FIG. 1 illustrates functionality that users may access through an interactive mobile device compliance application and through an interactive web compliance application.

FIG. 2 illustrates functionality available to client administrators of the compliance application.

FIG. 3 illustrates functionality available to compliance application administrators.

FIG. 4 illustrates functionality available to a compliance manager using the compliance application.

FIG. 5 illustrates a simplified example of a user's interaction with the compliance application.

FIG. 6 depicts a log-in screen from within the compliance application that is operating on a mobile device.

FIG. 7 depicts a welcome screen from within the compliance application that is operating on a mobile device indicating the country in which the user is located.

FIG. 8 depicts a country-selection screen from within the compliance application that is operating on a mobile device.

FIG. 9 depicts a welcome screen from within the compliance application that is operating on a mobile device indicating a country that has been selected by the user.

FIG. 10 depicts an expense selection screen from within the compliance application that is operating on a mobile device.

FIG. 11 depicts a gift direction screen from within the compliance application that is operating on a mobile device.

FIG. 12 depicts a screen from within the compliance application that is operating on a mobile device where a user may indicate whether the intended recipient of a gift is a government official.

FIG. 13 depicts an information screen from within the compliance application that is operating on a mobile device on which a definition of the term “government official” is provided.

FIG. 14 depicts a gift value screen within the compliance application that is operating on a mobile device.

FIG. 15 depicts a Portuguese-language version of a gift value screen from within the compliance application that is operating on a mobile device.

FIG. 16 depicts a Chinese-language version of a gift value screen from within the compliance application that is operating on a mobile device.

FIG. 17 depicts an approval determination screen from within the compliance application that is operating on a mobile device.

FIG. 18 depicts a phone call status screen from within the compliance application that is operating on a mobile device.

FIG. 19 depicts an approval form submission screen from within the compliance application that is operating on a mobile device.

FIG. 20 depicts the appearance of a keyboard to allow user input into an approval form submission screen from within the compliance application that is operating on a mobile device.

FIG. 21 illustrates the availability of country, currency, and frequency options that a user may enter into an approval form submission screen from within the compliance application that is operating on a mobile device.

FIG. 22 depicts a message center screen from within the compliance application that is operating on a mobile device.

FIG. 23 illustrates a simplified country management process that may be available to application administrators using the compliance application.

FIG. 24 illustrates a simplified client management process that may be available to application administrators using the compliance application.

FIG. 25 illustrates a simplified process of client user management that may be available to client administrators using the compliance application.

FIG. 26 illustrates a simplified process of policy management that may be available to application administrators using the compliance application.

FIG. 27 illustrates a simplified process of rule management that may be available to application administrators using the compliance application.

FIG. 28 illustrates a simplified process of rule hierarchy management that may be available to application administrators using the compliance application.

FIG. 29 illustrates a simplified process of metadata management that may be available to application administrators using the compliance application.

FIG. 30 illustrates a simplified approval process that may be used in association with the compliance application.

FIG. 31 illustrates a simplified compliance manager approval process that may be used in association with the compliance application.

FIG. 32 depicts a simplified architecture for an interactive decision and compliance portal and related facilities.

FIG. 33 depicts an interactive portal logical application architecture embodiment illustrating how a component-based architecture may be layered across multiple tiers.

FIG. 34 illustrates a model-view-controller pattern.

FIG. 35 lists examples of user interface processes.

FIG. 36 depicts a folder structure illustrating possible modules that may be associated with the compliance application.

FIG. 37 illustrates an embodiment of possible WCF client communication processes.

FIG. 38 illustrates possible WCF client contract attributes.

FIG. 39 lists possible WCF hosting environment options and some of their benefits and limitations.

FIG. 40 depicts a folder structure illustrating a possible organization of files that may be contained in an embodiment of a module specific data access layer.

FIG. 41 illustrates an embodiment of a shared database storage architecture.

FIG. 42 illustrates an embodiment of a dedicated database storage architecture.

FIG. 43 illustrates an embodiment of a possible Asp.NET authentication flow.

FIG. 44 illustrates an embodiment of a possible form authentication control flow.

FIG. 45 lists possible security coding standards that may, in embodiments, be used to perform various functions.

FIG. 46 illustrates a possible exception management sequence that may be associated with the compliance application.

FIG. 47 illustrates a configuration management flow that may be used in association with the compliance application.

FIG. 48 illustrates a Windows Service Application Fabric Architecture that may be associated with the compliance application.

FIG. 49 illustrates a system of administrative and web user-interface communication that may be associated with the compliance application.

FIG. 50 illustrates a system of communication with mobile devices that may be associated with the compliance application.

FIG. 51 illustrates an example of an iOS design approach that may be associated with the compliance application.

FIG. 52 presents a table illustrating an example of using various factors to calculate a preliminary risk score for business relationships.

### DETAILED DESCRIPTION

Detailed embodiments of the present disclosure are disclosed herein; however, it is to be understood that the disclosed embodiments are merely exemplary of the disclosure, which may be embodied in various forms. Therefore, specific structural and functional details disclosed herein are not to be interpreted as limiting, but merely as a representative basis for teaching one skilled in the art to variously employ the present disclosure in virtually any appropriately detailed structure. Further, the terms and phrases used herein are not intended to be limiting, but rather to provide an understandable description of the disclosure.

The terms “a” or “an,” as used herein, are defined as one or more than one. The term “another,” as used herein, is defined as at least a second or more. The terms “including” and/or “having”, as used herein, are defined as comprising (i.e., open transition). The term “coupled” or “operatively coupled,” as used herein, is defined as connected, although not necessarily directly and not necessarily mechanically.

As used herein, the term “organization” refers to a group of two or more individuals with some relationship to one another. These relationships may be legal, such as in the cases of corporations, partnerships, associations, employees, collaborators, and the like, or these relationships may be informal, such as among a group of individuals seeking to work together to optimize results (e.g. investigators seeking to collaborate on a forensic research project). As used herein, the term “organizational” refers to anything having to do with an organization, as defined above.

As used herein, the term “computer” may refer, but is not limited to a laptop or desktop computer, mobile computing facility (e.g., in-dash automobile computer) or a mobile device, such as a desktop, laptop, tablet, cellular phone, smart phone, personal media player (e.g. iPod), wearable computer, implantable computer, or the like. Such computing devices may operate using one or more operating systems, including, but not limited to, Windows, MacOS, Linux, Unix, iOS, Android, Chrome OS, Windows Mobile, Windows CE, Windows Phone OS, Blackberry OS, and the like.

As used herein, the term “mobile device” may refer, but is not limited to any computer, as defined herein, that is not fixed in one location. Examples of mobile devices include smart phones, personal media players, portable digital assistants, tablet computers, wearable computers, implanted computers, and laptop computers.

As used herein, the term “client user” may refer, but is not limited to someone affiliated with a client organization who interacts with the interactive compliance portal through a computer for purposes of using the interactive decision portal's functionality, such client users may include, but are not limited to, employees, agents, affiliates, partners, and contractors of the organization.

As used herein, the term “client administrator” may refer, but is not limited to someone who supervises client users.

As used herein, the term “decision tree” may refer, but is not limited to a set of and/or sequence of questions or decisions and resulting options and actions where a response to a question or decision may determine the next question, option or action.

As used herein, the term “policy resources” may refer, but is not limited to laws, regulations, rules, guidelines, instructions, or other operating principles that may be used as a factor in making decisions. Such policy resources may take the form of written documents, data, videos, audio files, pictures, and the like. For example, a video describing a country's restrictions on gifts to elected officials would constitute a policy resource, as would a statute or court decision.

As used herein, the term “portal data” may refer, but is not limited to information regarding communications, actions, decisions, results, and other data and processes related to the interactive decision portal's operations and functions.

As used herein, the term “system element” may refer, but is not limited to a computer that is being used as part of the interactive decision portal, whether or not that computer is being operated by a human. Where a task is assigned to a system element that consists of a computer being operated by a human operator (e.g. a mobile phone running an application being used by a client user), that task is being assigned to the computer's human operator. Similarly, when an inquiry is directed at a system element that consists of a computer being operated by a human user, that query is directed to the computer's human operator.

The present disclosure describes an interactive organizational decision facilitation portal (the “interactive decision portal”) that is enabled to facilitate organizational decision-making by integrating computer analysis with human decision-making to improve results, reporting and efficiency of decision-making processes. The interactive decision portal may employ one or more of the following techniques and strategies: (1) establishing bi-directional electronic communication between system elements, such elements providing information, displaying output, soliciting input, accepting input, processing data, or the like; (2) allocating tasks among system elements; (3) creating and implementing decision trees, which may be accomplished by one or more computers, by one or more human operators, or by a combination of one or more computers and one or more human operators and may involve the integration of rules, regulations, laws, policies, and similar parameters into decision trees; (4) making records of portal data, as defined herein, including records of communications, actions, decisions, results, and other data and processes related to the portal's operations and functions; (5) communicating and coordinating with other software systems, such software systems including but not limited to enterprise systems, such as human resources systems, financial systems, data storage systems, and the like; (6) analyzing portal data; (7) displaying and reporting portal data and analyses of portal data in text and graphical forms, including by use of a data visualization component or dashboard; (8) providing reminders and prompts that may or may not be integrated with calendar and task software and that may involve the generation of emails, text messages, and other forms of electronic communication; (9) translating and/or transcribing audio and/or text from one language into one or more other languages or data formats, including both human languages and computer languages; (10) collecting, processing, distributing, analyzing and otherwise interacting with multimedia elements, such elements possibly including digitally-stored images and sounds; and (11) establishing and implementing iterative feedback looks, which may enable or facilitate the use of data related to past activity (e.g. records of communications, actions, decisions, and results) to be used in determining future actions.

The interactive decision portal may involve multiple computers in multi-directional electronic communication with one another, such that a client user of one such computer may enter a query and receive a response using that computer, which may be a mobile device, such as an iPhone, iPad, Android Phone, or the like. Similarly, a computer that is part of the interactive decision portal may send an inquiry to one or more client user devices, which may respond to the inquiry. In an example, a client user may indicate that he has arrived in a country for a business meeting and the interactive decision portal may respond with instructions, questions, or both. Such instructions and questions may be based at least in part on the use of a decision tree.

The interactive decision portal may allocate tasks to system elements. For example, in an embodiment involving human resources functionality, the interactive decision portal may instruct client users who are recruiters to find qualified personnel to interview candidates for a given position. Similarly, the interactive decision portal may allocate a complex calculation to a computer with sufficient processing power and memory to perform the calculation quickly, and generate the analytic result (e.g., listing of personnel qualified to provide an employee with an approval for a contemplated action).

The interactive decision portal may create and implement decision trees based at least in part on policy resources. Such decision trees may be entered by client administrators or other computer operators with sufficient authority to do so; they may be developed using software algorithms using policy resources; or they may be developed using a combination of human and computer resources. For example, a client administrator may create a decision tree for answering client users' questions about gift giving, based on the amount of the proposed gift, whether the intended recipient is a government official, the country in which the recipient is located, and may then return an approval or denial based on the answers to those questions. Alternatively, there may be a gift approval application that would build gift-giving decision trees based on the laws of various countries, past experiences of client users in those countries, the past performance of the client user making the inquiry, and other relevant factors. It is also possible that the interactive decision portal may generate parts of a decision tree, but that input from a client administrator may be required to complete the decision tree. Algorithms may be used by the interactive decision portal to determine which decision tree to apply to a given situation. Implementation of decision trees may be prompted a by client user inquiry (e.g. “May I give a gift worth $1000 to a government official in China?”), by algorithm (e.g. a client user computer has arrived in a given country, triggering a decision tree), or by administrator action (e.g. instructing a group of client users to investigate a train crash, leading to a decision tree involving location of the crash, equipment failures, human errors, names of witnesses, etc.). Each point in a decision tree at which more than one path is possible (i.e. the next instruction or question varies depending on the response to the previous question) may be referred to as a decision node. Decision nodes may be controlled by the interactive decision portal (e.g. if the user seeks to give a gift worth more than $1,000, the request to give the gift will be automatically denied if regulations prohibit it) or by human input (e.g. if the user seeks to give a gift worth more than $1,000 that is not prohibited by law, the request may be routed to a supervisor). As such, the outcome of a decision tree, as implemented by the interactive decision portal, may depend on the answers given, as well as both human and computer decision-making Nodes in decision trees may also be designated as absolute or discretionary. Absolute nodes may be those in which a given input compels a given output, whereas discretionary nodes are those in which a given input allows more than one output. Discretionary nodes may be resolved with or without human input depending upon predetermined system parameters.

The interactive decision portal may record all portal data, as defined herein, such that the times and locations of all actions, queries, responses, decisions, results, and other data and processes related to the interactive decision portal's operations and functions are recorded. Such data may be recorded locally on client users' computers, such as mobile devices, then transmitted to servers or other repositories where the data may be stored, processed, aggregated, and analyzed. The recording on the client user's computers may be transient or long-term storage. For example, a client user's iPhone may record that at 1:00 PM local time, the client user requested to give a watch worth $500 to a local government official in Paris and that at 1:05 PM the request was denied.

The interactive decision portal may communicate and coordinate with other software systems, which may be part of the same enterprise, including human resources systems, financial systems, data storage systems, and the like. For example, in a human resources implementation, the interactive decision portal may query a human resources database to gather data on vacant positions for purposes of identifying positions for which recruiter-client users should identify qualified candidates. Similarly, a management implementation of the interactive decision portal may query an inventory system when determining whether to make changes to a supply chain. A compliance implementation of the interactive decision portal may instruct a financial system to reimburse a client user for a gift given to a president of a potential customer company. In this example, the interactive decision portal may first determine that the expenditure on the gift had been approved, who the gift was for, that the gift was actually purchased and delivered, and that the client user would like to be reimbursed for the expenditure. Upon making those determinations, the interactive decision portal may generate a request for the transfer, saving the employee the need to complete reimbursement paperwork, and generating a record of the transfer that may then be reported to other enterprise facilities, such as financial systems, auditing tools, and the like. In another example of the interactive decision portal interacting with a human resources software system, a client user may request a transaction for which the decision tree determines he does not have discretion. The interactive decision portal may route the request to his supervisor, Bob, but discover that Bob is no longer active on the system. The interactive decision portal may then query the enterprise's human resources database and learn that Bob has retired and been replaced by Ann. The interactive decision portal may then re-route the approval request to Ann. In yet another example, Bob may be retired but has not yet been replaced by another employee. Thus, the interactive decision portal may query a client administrator regarding who has replaced Bob as the client user's supervisor.

The interactive decision portal may analyze portal data, as defined herein, and generate reports. Client administrators have a wide range of reports available to them. For example, a client administrator may be able to create custom reports on activity of the organization's sales force in East Asia, including reports on each salesperson's results, results by division (e.g. surgical supplies), results by sales team, results by month, etc. Reports may include currency conversion and other display options. In some embodiments, analyses may involve comparing multiple data sets, such as correlating gift giving with sales results. Analyses may be conducted using computer algorithms, human input, or a combination of both. For example, in an investigatory implementation, the interactive decision portal may produce a report on which investigators gather the most relevant information using a software algorithm. In an example involving a compliance implementation, a supervisor may be asked to rate client users on the quality of their work. In an example involving a supply chain implementation, a software algorithm may generate a list of possible locations for a distribution center, but could then seek input from a client administrator for narrowing down the list.

The interactive decision portal may display portal data and analyses of portal data in text and graphical formats, including through the use of a data visualization component or a dashboard. Such displays may also be distributed through email, by text message, or in other formats. Such displays may be interactive, allowing users to click on displayed elements, to rotate, zoom in, change color, focus on a data subset, create new data sets, create new charts from existing data sets, compare data sets, and the like.

The interactive decision portal may provide reminders and prompts that may or may not be integrated with calendar and task management software. Such reminders and prompts may be initiated in accordance with a set schedule, generated based on computer algorithms, or be generated by human operators. Such reminders and prompts may be communicated as on-screen messages or displays, sounds, videos, emails, text messages, multimedia messages, and other forms of electronic communication. For example, each month the interactive decision portal may display a message on client users' computers that monthly reports were due to be filed in a week and could place a reminder in their calendar software that would remind them two days before the deadline. In another example, a software algorithm may be used by the interactive decision portal to determine that certain client users had exceeded their expense budgets and could email budget spreadsheets to them and display alerts in a message center application running on their mobile devices. In yet another example, a sales manager may send a text message with a link to recent sales data to all of the members of the organization's sales force reminding them of a bonus program for the person who made the most sales that month.

The interactive decision portal may include translation and transcription functionality that converts text and audio files from one language to another. For example, in embodiments involving compliance functionality, the mobile device of a client user who is a native German speaker working in an English-speaking country may display instructions, questions, and other information in a slit-screen window with English on one side and German on the other.

The interactive decision portal may include multimedia functionality, such as the ability to collect, process, distribute, analyze, and otherwise interact with multimedia elements. For example, an implementation involving compliance functionality may play a video on a given country's laws regulating gifts to public officials. Similarly, an implementation involving investigatory functionality may record interviews with witnesses, labeling and encoding those interviews and storing them in a database. An implementation of the interactive decision portal involving investigatory functionality may use face recognition and database query technology to identify potential witnesses from photographs or voice samples taken or recorded with a mobile device.

The interactive decision portal may have functionality for establishing and implementing iterative feedback loops, which may modify algorithms and decision trees based on portal data recorded and processed. For example, in a compliance implementation, a client user who had previously been granted discretion to spend up to $100 on gifts to private individuals may have this limit reduced based on a poor record of prior compliance with gift-giving laws and policies.

In addition to facilitating decision-making, in embodiments, the interactive decision portal may make determinations as to when a decision must be made and the relevant parameters, rules, data, and other factors that should be considered in making the decision, as well as how the decision should be made (e.g. by a computer algorithm, by a human supervisor, etc.), how the decision should be categorized for record-keeping purposes, and the like. In an example embodiment, when a user of a compliance portal arrives in a country, the portal may determine that a decision must be made as to whether the user should be shown a video on that country's applicable laws and regulations. The portal may determine that this decision would be best made by running a computer algorithm (for example, based on how long it has been since that user operated in that country) or it may determine that the decision about whether the user should watch the video should be made by the user's supervisor. The determination as to whether a decision should be made is in itself a form of decision that the interactive decision portal is enabled to make. Continuing the example, there may be strict parameters with black and white requirements or flexible parameters that are examined on a case-by-case basis. For instance, parameters may be set that every user who has less than one year of experience must watch a briefing video upon arriving in a country, that users with 2-5 years of experience need only watch the video if their supervisor deems it necessary, and that users with over 5 years of experience need not watch such briefing videos. Alternatively, parameters may be set that allow the portal to determine whether such videos should be watched and to apply a balancing test that involves multiple factors, including the experience level of the user, how recently the user operated in the country in question, the user's performance rating, etc. In such cases, the portal may determine whether the decision-making process would benefit from input from the user's supervisor and, if so, could send an appropriate inquiry (e.g. the portal may send an email to the supervisor, as follows: “Query: John Smith has just arrived in China. He has not previously worked in China, but he has eight years of experience operating in the region. Should he be required to watch the 57-minute video on doing business in China that was last updated on Oct. 22, 2012?”).

In embodiments, the interactive decision portal may have compliance functionality, investigatory functionality, operational management functionality, collaborative research functionality, or other functionality that involves decisions made by organizations.

In embodiments, the interactive decision portal may include compliance functionality that may allow an organization to assist its employees and agents in making decisions, including decisions based on policies and categories defined by individual client organizations around the world. In these embodiments, the interactive decision portal may include an interactive compliance application that may be available through web sites, on mobile devices as defined herein, or some other device type that is capable of operating or displaying a digital application (referred to herein collectively as a “client device”). When accessed on a client device, such as a mobile device, the interactive compliance application may be referred to as an “interactive mobile compliance application” or simply a “mobile application.” When it is accessed through an internet connection, it may be referred to as an “interactive web compliance application” or simply a “web application.” In examples of these embodiments, the iOS version of an interactive mobile compliance application may be developed as a native application for iPhone, iPod, and iPad enablement. The interactive decision portal may also include an administration application that allows administrators to perform various functions, which may include managing users, policies, rules, and content of the interactive compliance application. Such administrative application may be hosted on the web, may be deployed as part of an internal company network as a web application, and may be available as a Cloud service.

In embodiments involving compliance functionality, there may be defined roles for managing, using, and otherwise interacting with the compliance application and architecture: (1) client user, (2) compliance manager, (3) application administrator, and (4) client administrator. A client user may be someone affiliated with a client organization seeking to improve compliance with its rules and relevant laws and regulations, such client users including employees and contractors of the organization. A compliance manager, of which there may be one or more at each client organization, may perform the same functions as a client user, and may also manage the approval process for one or more client users. An application administrator may administer the overall interactive compliance application across multiple client organizations and may be responsible for managing the process of keeping rule management and information on users, countries, and policies up to date. A client administrator, of which there may be one or more per client organization, may have control over the user management section of the interactive decision portal and may be empowered to add, modify, and delete client users and compliance managers within the organization.

In embodiments involving compliance functionality, the interactive decision portal may include a mobile application, which may include one or more of the following modules: (1) a Splash Screen Module that may be responsible for the process of fetching a client-specific splash image and displaying that image on start up of the application; (2) a Login Screen Module that may show the user interface for the screen and use the controller layer to pass authentication information into a local database; (3) a Welcome Screen Module that may display user interface and profile information; (4) a Message Center Module that may be responsible for accessing the user's mailbox and looking for specific compliance messages—which may include pre-approval responses, compliance-related material, and compliance reminders—and displaying the indicators as well as a list of such messages in a Message List screen; (5) a Country Selection Module that may pre-select the current country by using GPS or other location technology to determine where the mobile device is located; (6) a Policy Selection Module that may select the current context of what the user would like to see, such that the policy selected may be a determining factor in the rest of the flow; (7) a Category Selection Module that may allow a user to choose one of various categories depending on the current context, these categories having been loaded dynamically based on the organization's internal categorization; (8) a Help/Information Module that may retrieve and display context-specific information depending on which module the user is in, providing navigation elements that permit the user to return to the screen from which the user navigated to the help screen; (9) a Multilevel Interactive Question Module that may offer choice screens, such that the user's answer to each choice determines the next screen that will be displayed in the tree; (10) a Pre-Approval Form Module that may display a form into which relevant data may be inputted, the exact nature of the form depending upon the current user's context, with data entered into the form either being returned to the backend or, if the user is off-line, stored locally until such time as an internet connection can be established; (11) a Multi-Lingual Support Module that may provide for use of the application in selected languages other than English by translating text into such other languages; and (12) a Tracing Module that may capture the path followed by the user during the user's interaction with the application and may store data on the traversed path in a database on the device and then upload that database to the backend for analytics and data mining. In addition to these modules, the application may include other modules and Navigation Components, which may be spread across various areas of the application and which may allow the user to navigate among the areas of the application.

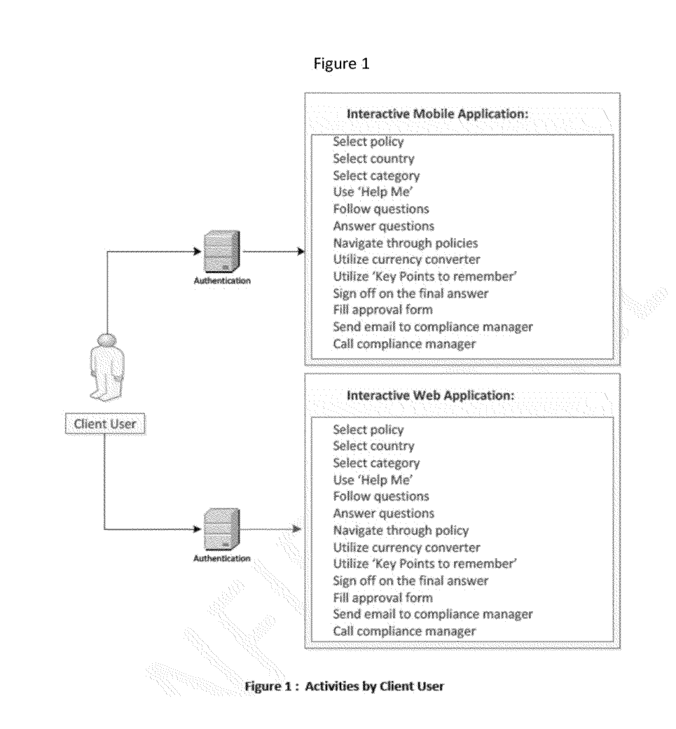

Referring to FIG. 1, in embodiments involving compliance functionality, a client user may use an interactive mobile application or an interactive web application to seek compliance review of proposed actions to determine whether those actions are consistent with the organization's rules, relevant laws and regulations, and other applicable policies. This process may involve one or more of the following steps: (1) selecting a policy, (2) selecting a country, (3) selecting a category, (4) using a help function, (5) presenting questions, (6) answering questions, (7) navigating through policy details, (8) using a currency converter, (9) reviewing key policy points, (10) initiating an approval process, (11) filling out approval form, (12) sending an email to the client user's compliance manager, (13) calling the client user's compliance manager, and (14) performing other related functions. In an example, a client user may run the compliance application on a mobile device to determine whether giving a gift worth 50 euros to a government official is consistent with applicable laws, regulations, and policies of a nation.

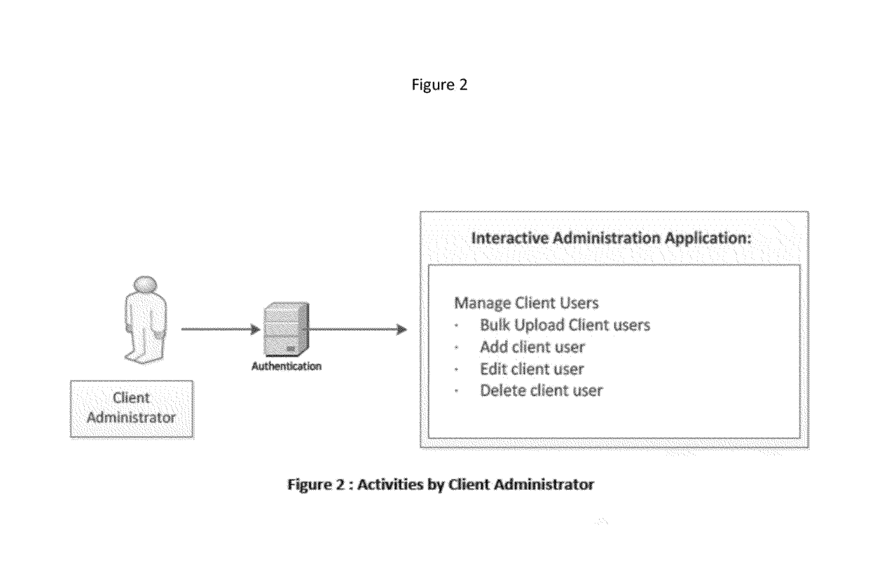

Referring to FIG. 2, in embodiments, a client administrator may manage client users. This process may include one or more of the following activities: (1) uploading client users in bulk, (2) adding client users one at a time, (3) editing client users, (4) deleting client users, (5) looking up client users, (6) searching for client users, and (7) conducting other client user management activities.

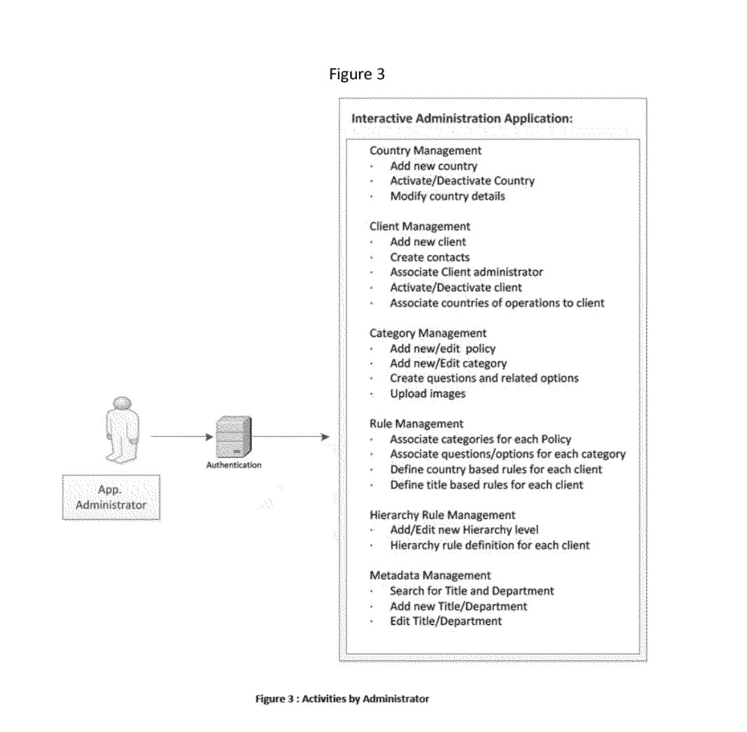

Referring to FIG. 3, in embodiments involving compliance functionality, an application administrator may use the interactive administration application for a range of purposes, including, without limitation, (1) country management, including adding countries, activating or deactivating countries, and modifying country details; (2) client management, including adding new clients, creating contacts, associating client administrators with client users and compliance managers, activating and deactivating clients, and associating countries of operation with clients; (3) policy management, including adding new policies, editing existing policies, adding new categories, editing existing categories, creating questions and related options, and uploading images, (4) rule management, including associating categories with policies, associating questions and options with categories, defining country-based rules for each client, and defining title based rules for each client, hierarchy rule management, including adding new hierarch levels, editing existing hierarchy levels, and defining hierarchy rules for each client; (5) hierarchy rule management, including modifying business rules and functionality, creating, modifying, and deleting associations, as well as establishing, modifying, and deleting relationships between rules (building and modifying a rule tree); and (6) metadata management, including searching for titles and departments, adding new titles and departments, and editing existing titles and departments.

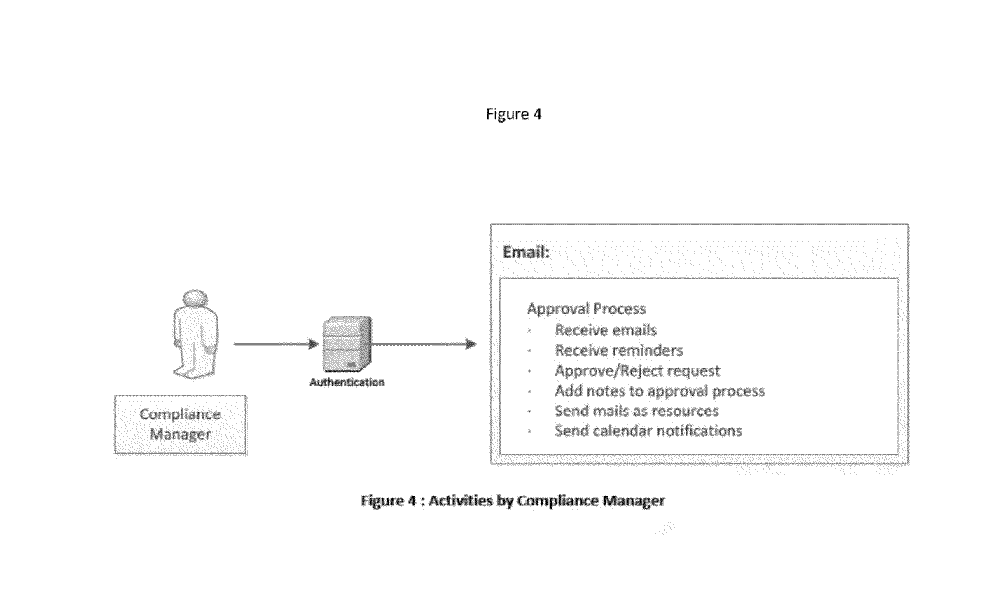

Referring to FIG. 4, in embodiments involving compliance functionality, a compliance manager may manage an approval process, including, without limitation: (1) receiving emails; (2) receiving reminders; (3) approving requests; (4) rejecting requests; (5) adding notes to approval requests and processes; (6) sending emails with links, attachments, and other resources; and (7) sending calendar notifications.

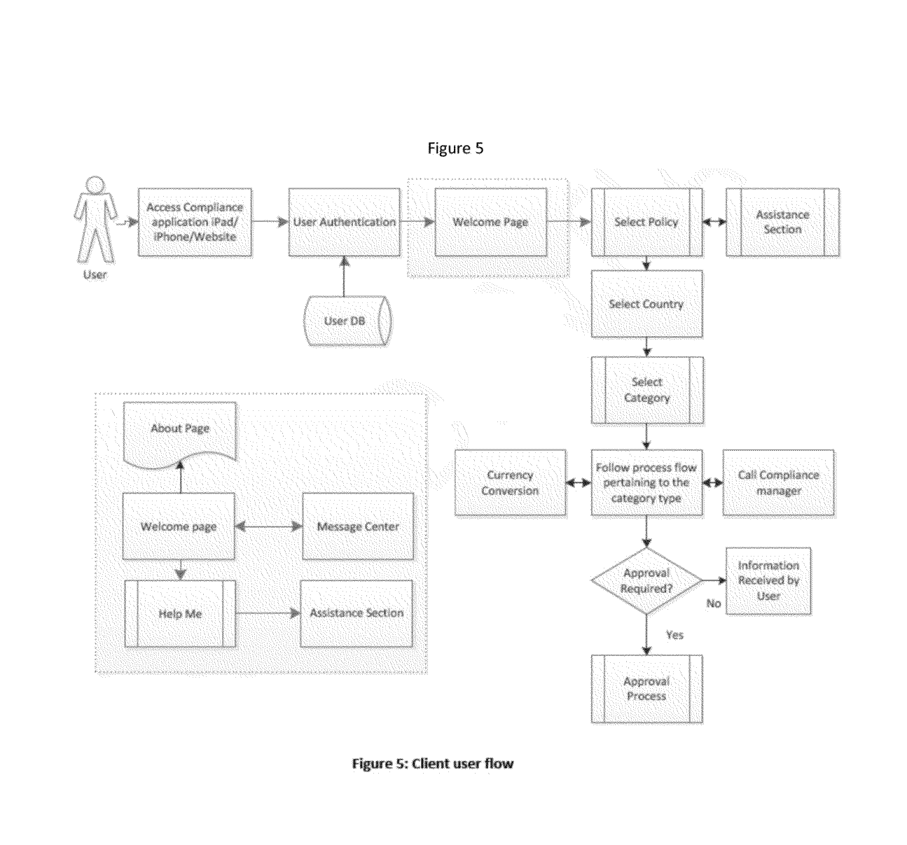

Referring to FIG. 5, in embodiments, a client user may follow an interactive process of selecting options, responding to questions, providing information, and receiving instructions.

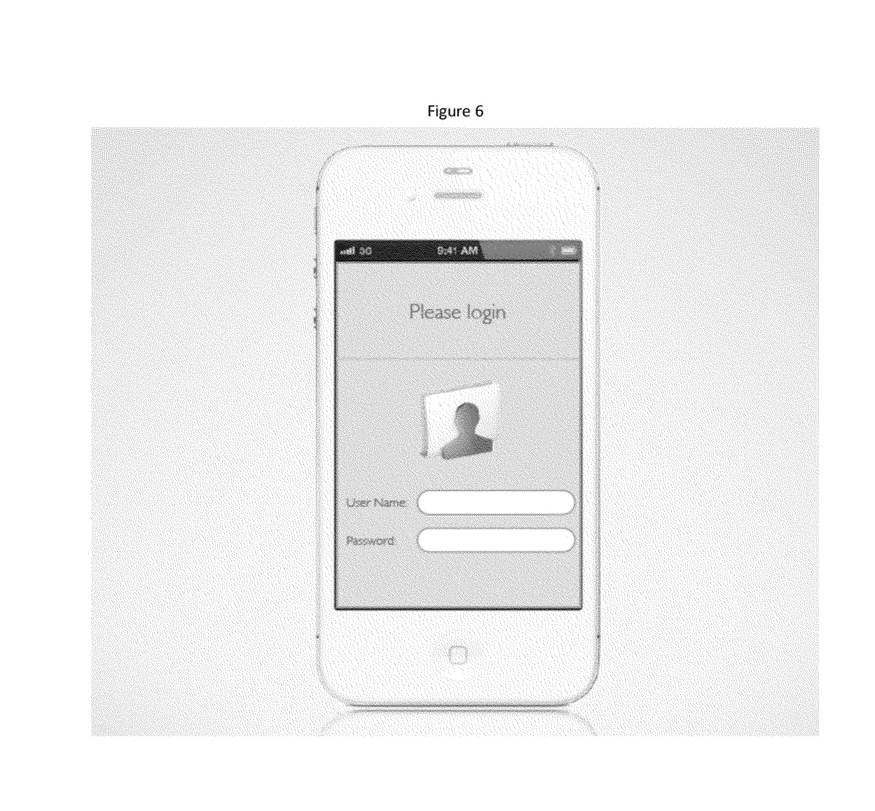

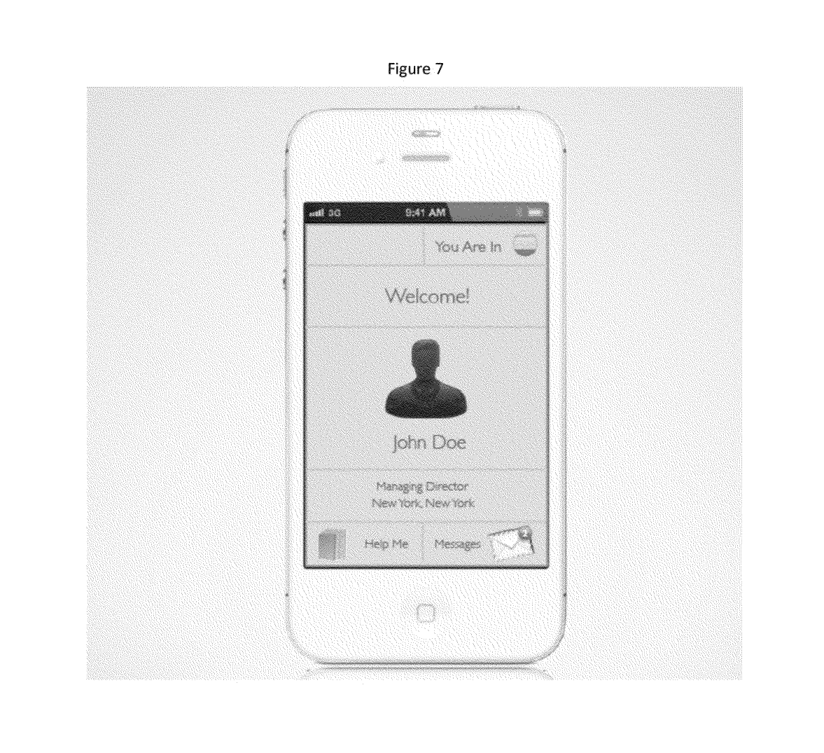

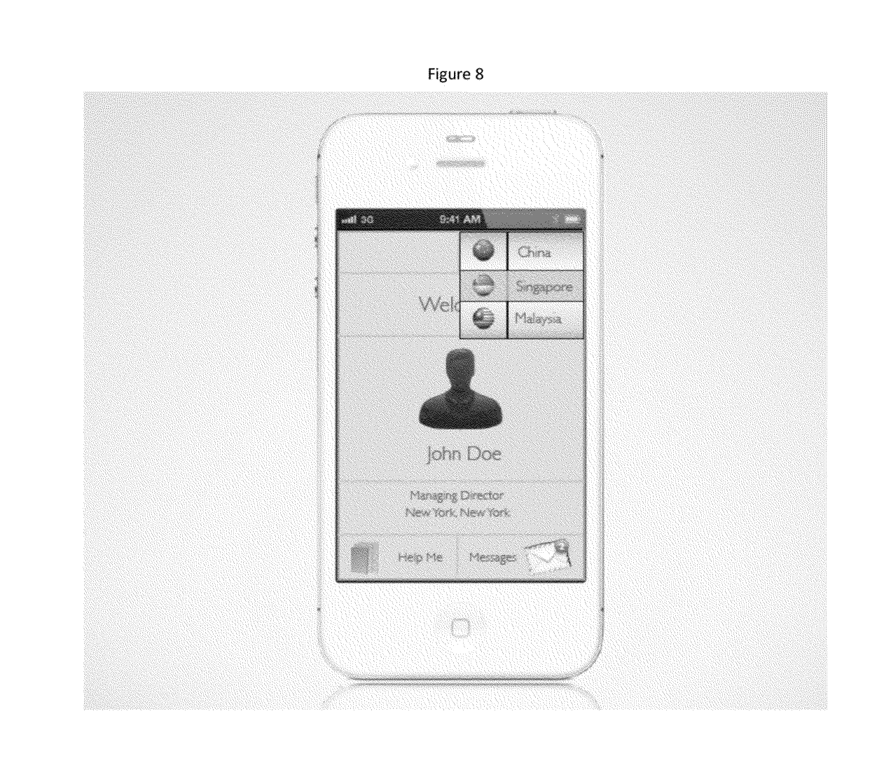

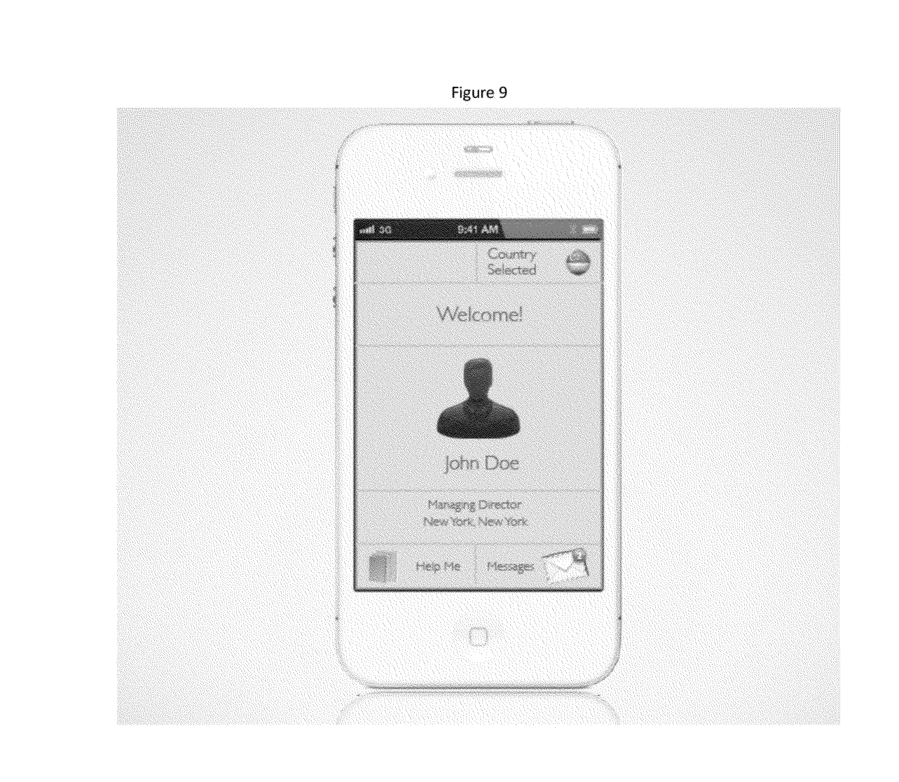

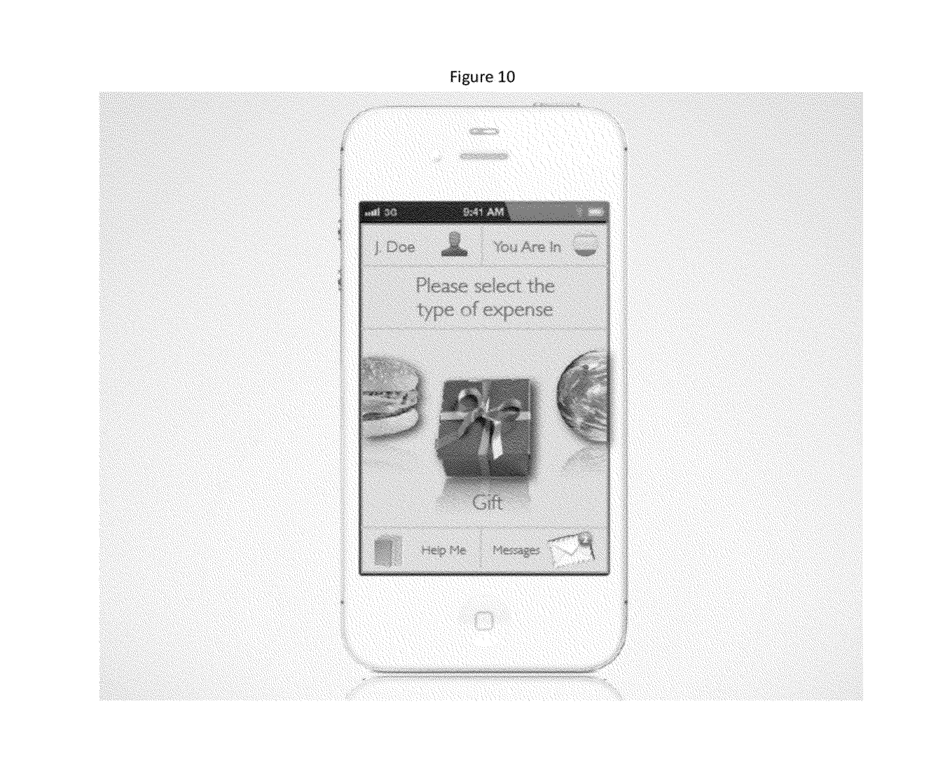

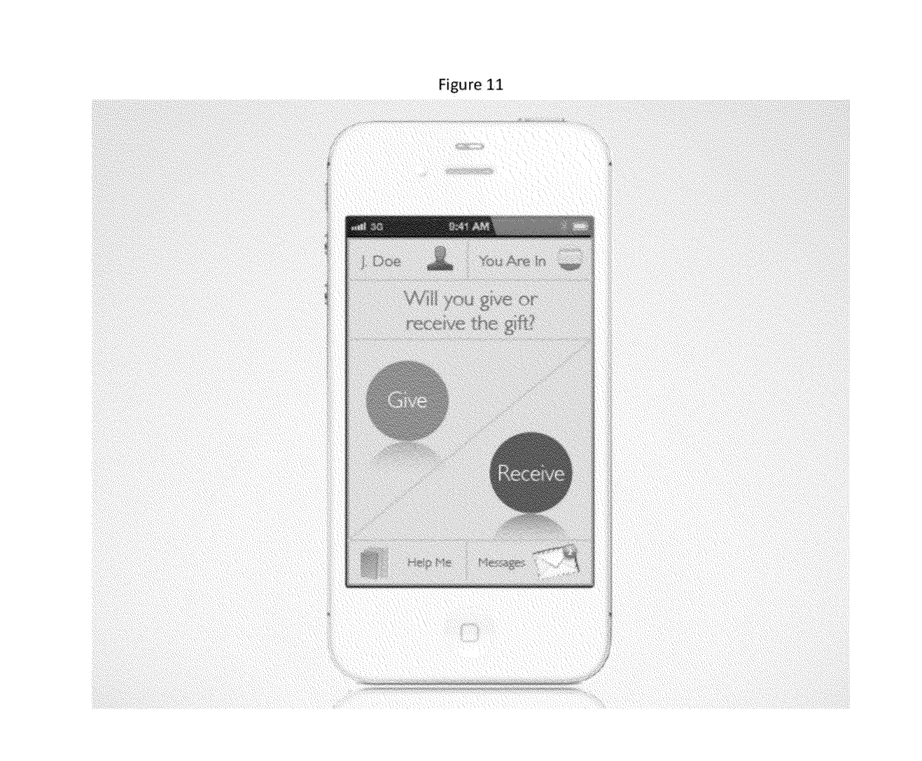

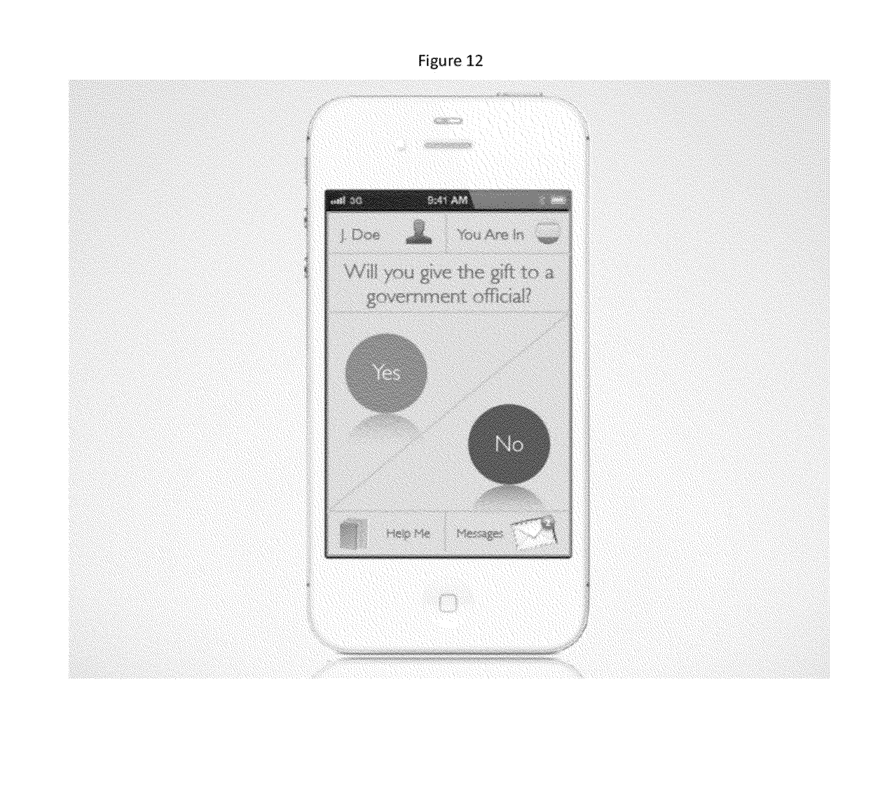

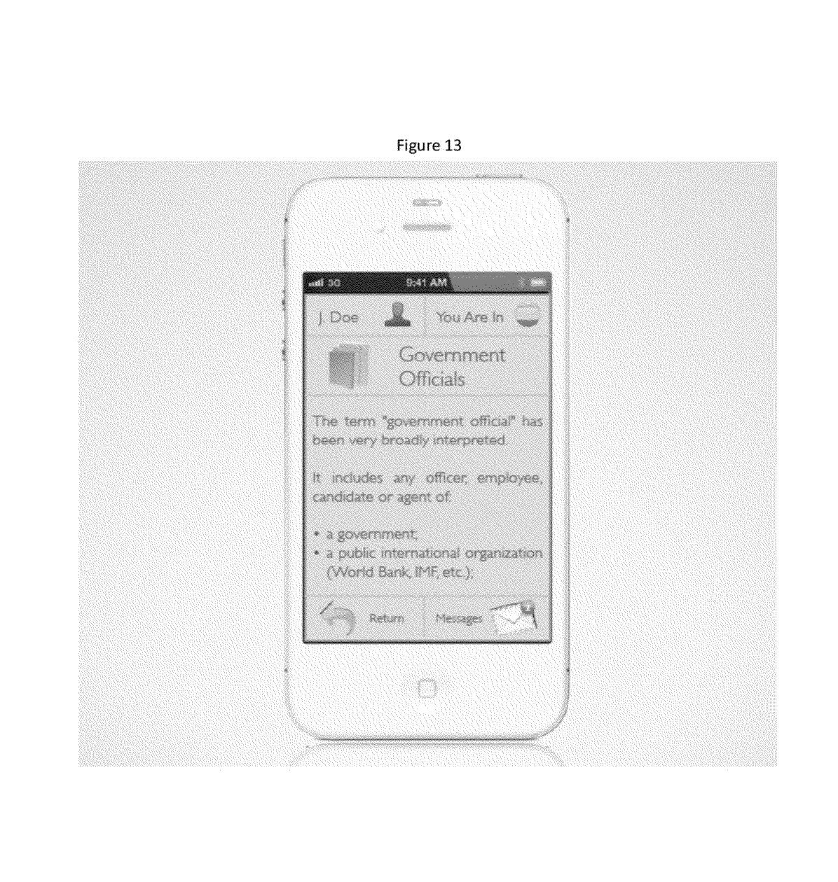

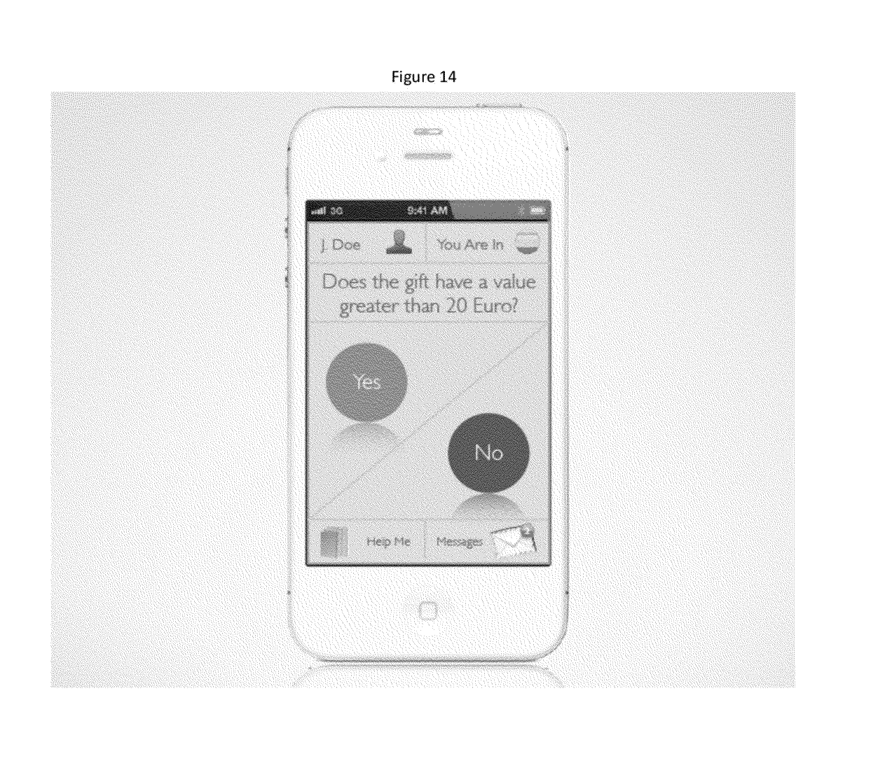

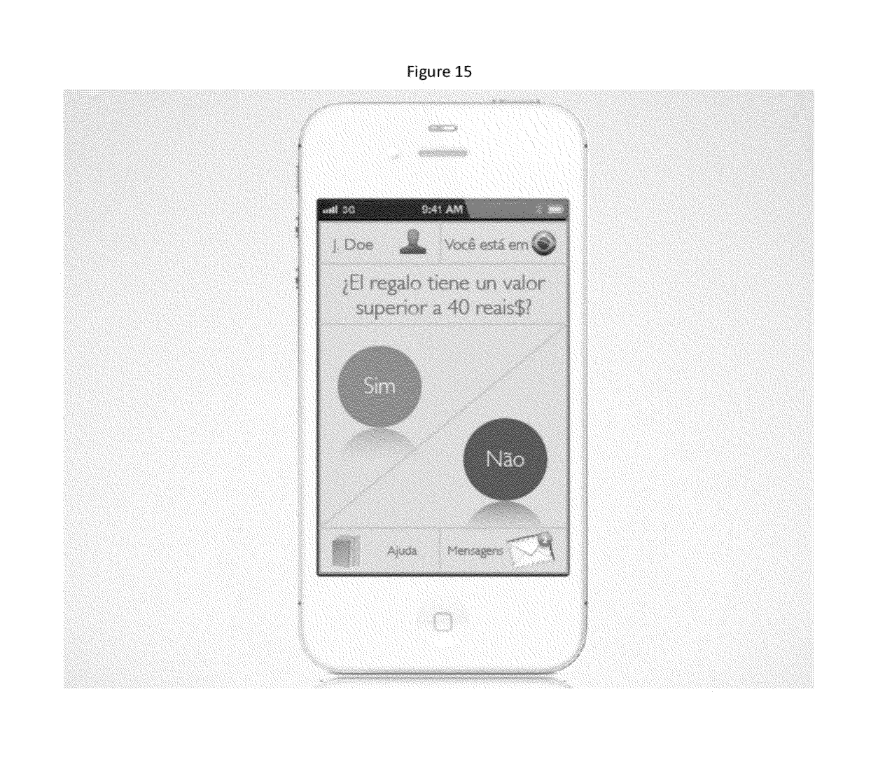

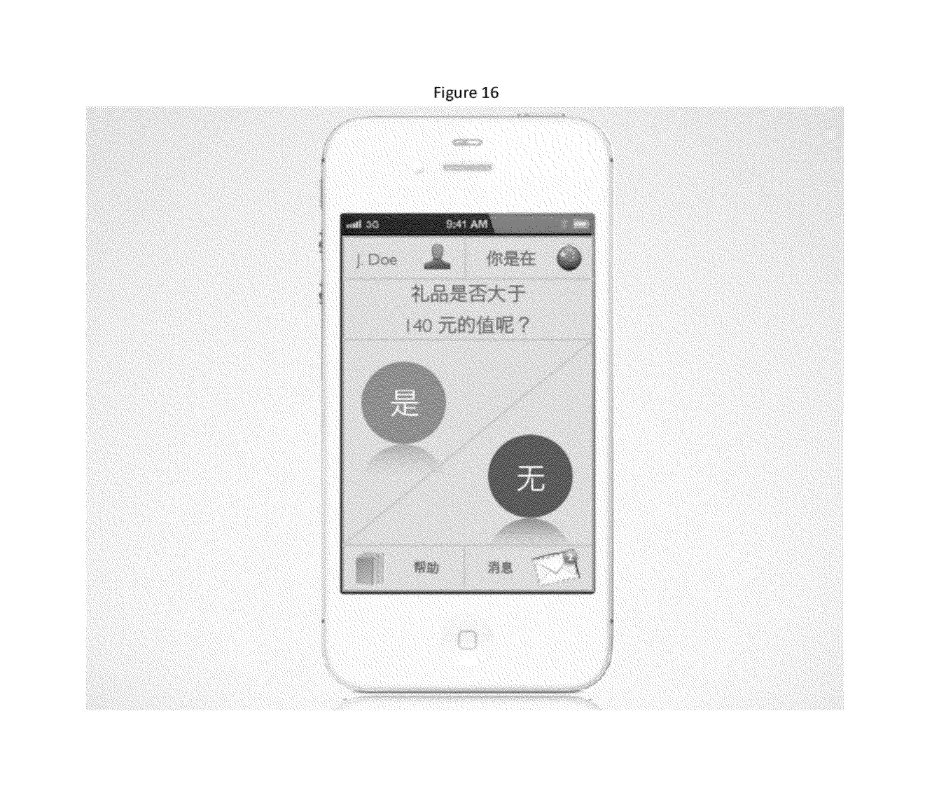

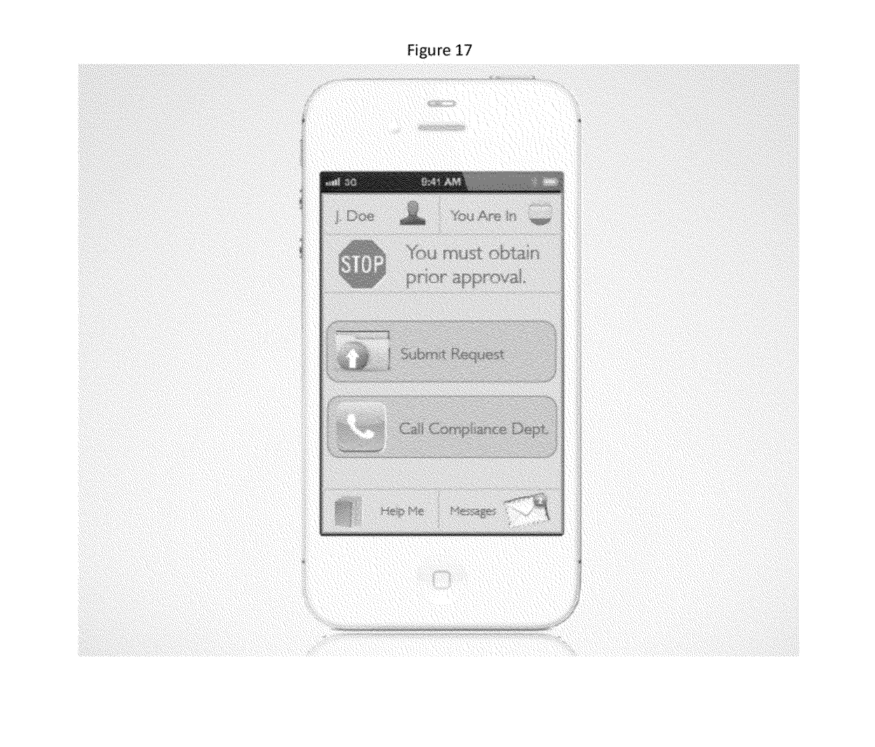

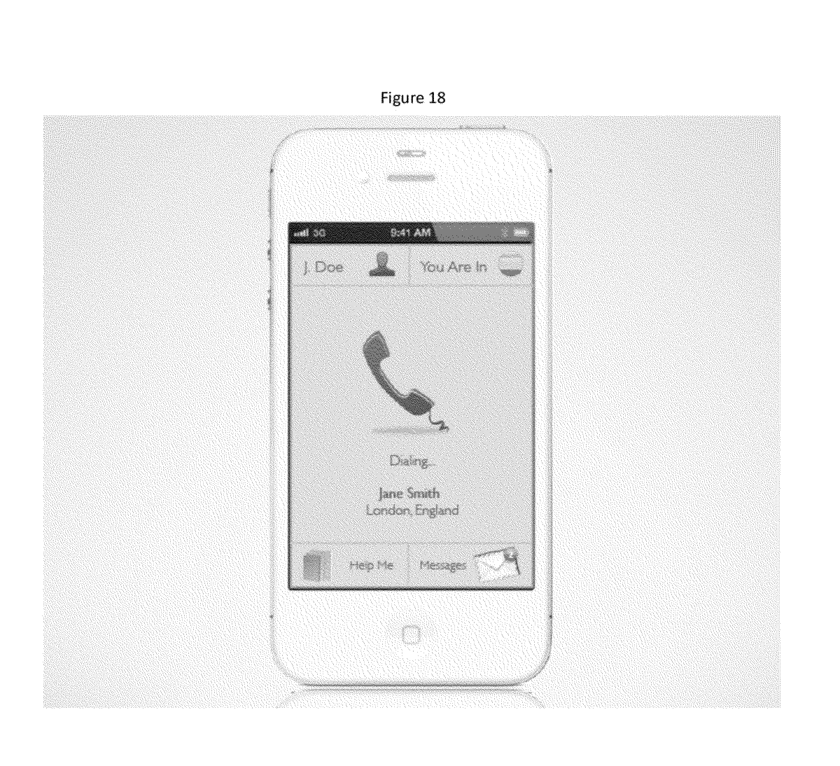

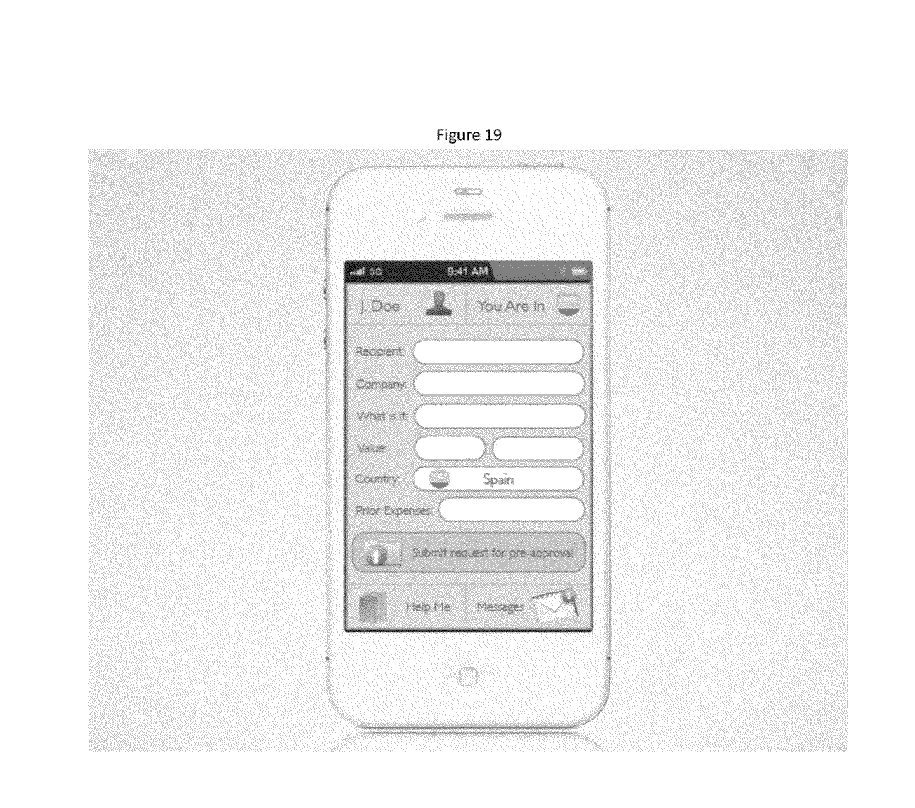

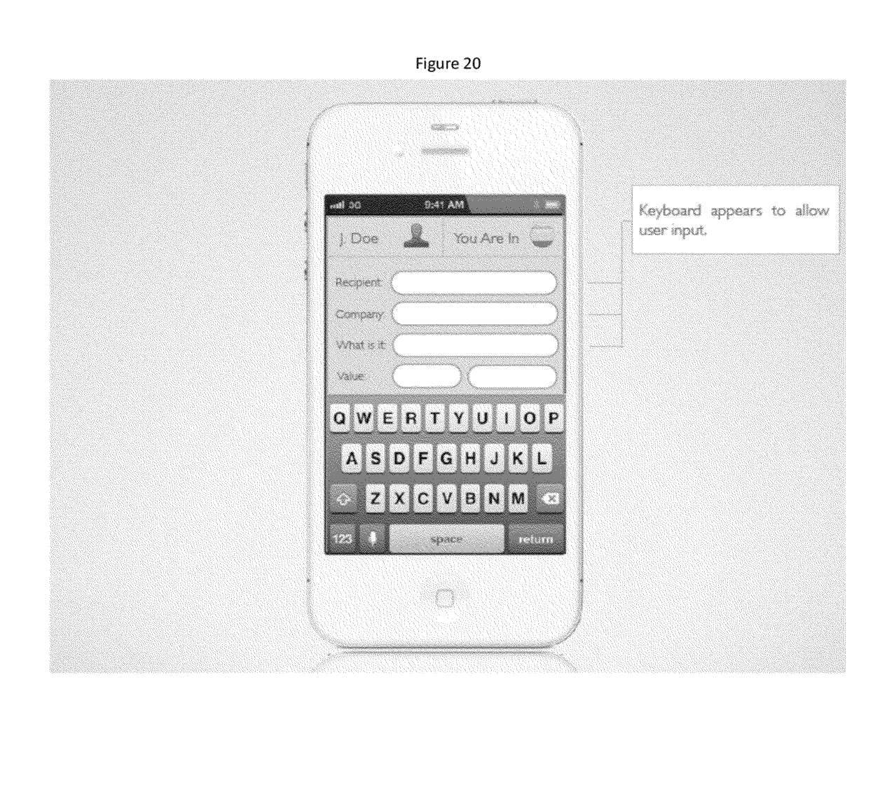

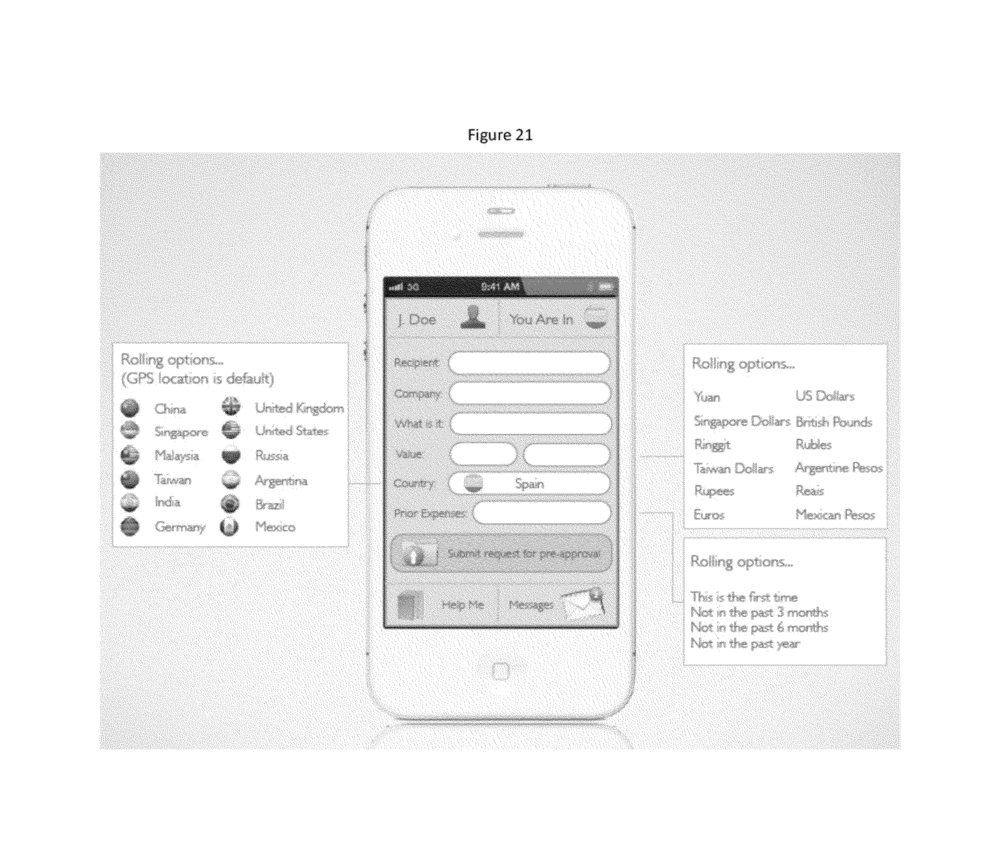

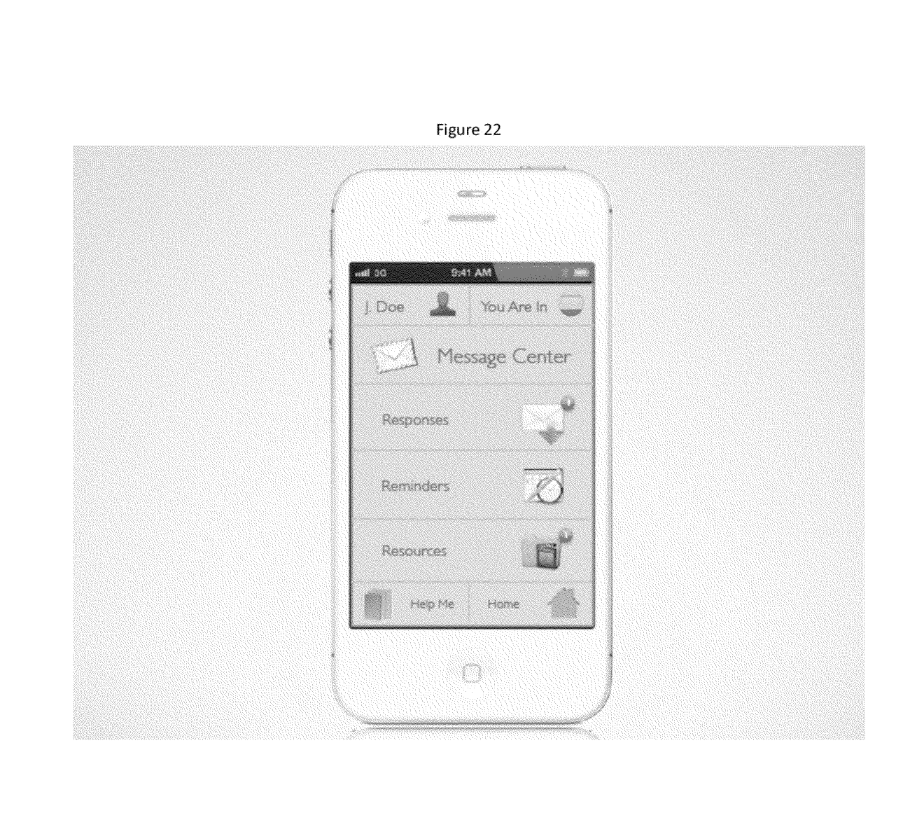

Referring to FIGS. 6 through 22, in an example of embodiments involving compliance functionality, the interactive compliance application may include one or more of the following interactive modules: (1) a login module that allows a user to access the application by entering a user name and password, as illustrated in FIG. 6; (2) a welcome module, which may identify the user and the country in which the user is currently located, as illustrated in FIG. 7; (3) a country-selection module that allows the user to select the country about which the user will be inquiring, as illustrated in FIG. 8, that may also include a confirmation screen, as illustrated in FIG. 9; (4) a policy selection module that allows a user to select the policy, law, rule or regulation about which the user would like to verify compliance from a list; (5) a category selection module that allows a user to select from a list of categories within the policy area selected on the policy selection screen; (6) an expense selection module that may be used when the compliance issue in question involves an expenditure, as illustrated in FIG. 10; (7) a gift information module for use when the compliance issue being checked involves gift-giving, where the user can indicate whether the user is inquiring about giving a gift or receiving one, as illustrated in FIG. 11. As depicted in FIG. 12, the interactive compliance application may query a user as to whether or not an intended recipient of a gift is a government official. The interactive compliance application may provide the user assistance in determining whether the recipient meets the definition of “government official,” as illustrated in FIG. 13, and may indicate whether the gift meets a specified value threshold, as illustrated in FIG. 14. The interactive compliance application may include an approval module that that may indicate to the user whether prior approval of the proposed action is required, may offer the user multiple avenues for seeking approval or more information, as illustrated in FIG. 17, and may include a phone call status screen, as illustrated in FIG. 18. The interactive compliance application may include an approval form submission screen with options for currency, frequency of gift-giving, country, and other relevant factors, as illustrated in FIGS. 19, 20, and 21; (10) a message center module that may allow users to access a number of resources, such as responses, reminders, and resources, as illustrated in FIG. 22; and (11) a currency conversion module that may determine currency names and provide conversions of currency amounts based on the country selected in the country selection module. Variations of any of the screens may be available in multiple languages and the user may be able to set the user interface language through a preferences control panel. FIGS. 15 and 16 illustrate non-English versions of the gift value screen. Depending upon screen size, functional elements from more than one module may be displayed simultaneously. For example, on an iPad, there may be a combined screen that has information from the welcome module and the policy selection module.

In embodiments, the log-in module may have one or more of the following features: (1) it may have an internal database that is used to validate user login when the device is off-line, such database being synchronized with the server database and the user name and password being stored locally each time the device goes online; (2) it may have a “remember me” feature that allows a user to save a user name locally, so that the user need not type it each time the user logs on to the application; (3) it may have a password recovery function that allows a registered user to generate an email with a reset password link where the server validates the email submitted; and (4) it may limit access only to registered users.

The welcome module may include one or more of the following features: (1) it may display the name, user name, and title of the user who is logged on to the device; (2) it may display a unisex silhouette image and an icon identifying the country in which the device is located; and (3) it may determine the country in which it is located using GPS, wireless internet connection, cell phone tower connection, IP address, or other location services technologies.

In embodiments involving compliance functionality, the policy selection module may feature one or more of the following: (1) it may include a bookshelf or tile effect that offers users the ability to select from among policy choices that are represented using a combination of graphics and text; (2) it may provide links to corresponding “help me” text that may be displayed along with available selections; and (3) it may interface with a given user's profile, confirming that the number of policies associated with the client user in the rule definition matches the number of policies shown.

The category selection module may feature one or more of the following: (1) a carousel effect in which the user may spin a display of possible selections involving images and text and (2) the display of corresponding “help me” text and links. The interface may be tailored to the client device type (e.g., tablet, smart phone, etc.).

In embodiments involving compliance functionality, the country selection module may have one or more of the following features: (1) it may provide the user with an option to select a country of operation from a list of countries, which may be organized by continent; (2) it may default to the country in which the mobile device is currently located, which may be determined by GPS, wireless connection, cell phone tower communication, IP address, or other location services method; (3) it may interact with the currency conversion module to translate currency names and values based on the country selected; (4) it may allow users to select from lists of countries organized by continent using a rotary ticker (similar to how an iPhone alarm clock is set); (5) in examples on a small mobile device, such as an iPhone, it may be active only in the policy and category selection screens; (6) in examples on a large mobile device, such as an iPad, it may be active only on one screen, which may be designated as a country selection screen and may be displayed between the policy and category selection screens; and (7) the list of countries available for selection may be limited based on user settings or administrator controls.

In embodiments involving a currency conversion module, the currency conversion module may operate dynamically using a pre-determined converter plugin. It may synchronize and manage values for each country between the mobile device and the server. When the mobile device has a connection to the Internet, it may conduct currency conversions in real time using a server-side currency converter plugin and the most recent available exchange rates. When the mobile device is offline, it may use recent stored exchange rate values to calculate the conversion. The currency values calculated may be rounded off to two decimal places. Currency conversion information may be displayed for questions where the currency conversion is required and applicable. Currency conversion information may be excluded from screens on which it is not required or applicable. The display of currency conversion information may take the form of “A currency=B currency approx.” under the question where “A” is the value defined in the question and “B” is the converted value based on the currency for the country selected under the “You are in” section. On a mobile device, such as an iPhone, the currency converter feature may be provided in the upper-left-hand corner of relevant screens. The value of “B” may change based on the currency selected. The currency chosen by the currency converter may supersede the value set based on the country selected. The currency that is displayed based on country selection may be changed by the user by means of a rotary list option.

In embodiments involving a message center module, the message center module may include one or more of the following features: (1) availability from a sidebar link, possibly located in the lower-right-hand corner of the screen; (2) integration with email software, allowing emails to be generated from and displayed by the module, such that emails generated by the message center may be addressed by default to the compliance manager; (3) notifications and reminders, alerting the user to scheduled events, such as meetings with compliance managers; (4) links to resources, such as compliance policies, rules, messages, videos, and other materials that may be relevant to compliance efforts; (5) contact information, including the phone number and email address of the compliance manager; (6) user profile information, such as user name, silhouette image, title, city, and country, as illustrated in FIG. 7; and (7) communication protocols, allowing the notification regarding and display of responses to approval requests by the compliance manger.

In embodiments involving an interactive compliance application, the interactive compliance application may include the following additional functional elements: (1) a help feature that includes a pre-defined assistance section as applicable to each page that may be displayed as separate pages or as pop-ups depending upon the size of the screen being used; (2) a thank-you splash screen that may display at the end of each process flow; (3) navigation options that allow users to proceed through the various modules and questions in a linear fashion, but which also allow users to go back and change previous answers, such navigation options may include using a mobile device's touch screen to swipe backwards and forwards through pages and may also include forward and backward navigation buttons; (4) a lock notification feature that alerts the user to messages received by the mobile application when it is running in the background, such feature possibly using the iOS native notification feature in mobile interactive compliance application embodiments on iOS devices; (5) data synchronization functionality that checks servers on log-in to determine whether applicable data have changed and updates the mobile device accordingly, allowing the user to have full use of other applications during the update process by minimizing the mobile application; (6) notification that a message has arrived in the message center when the user is on another screen, which may be communicated by having the message center icon blink or change color or both; (7) branding information identifying the client organization, which may include a client organization logo and caption and may be displayed on an additional screen between the splash screen and the welcome screen or integrated into other screens or may be integrated into those or other screens, depending upon the screen size of the device being used; and (8) usage tracking that creates a record of pages visited and actions taken by the user, storing usage information locally on the mobile device and transmitting a copy of the information to the backend server. Usage information captured and transmitted may include one or more of the following: (1) screens visited; (2) policy, country, category, question, and other options selected by the user; (3) approval messages sent, including emails sent to the compliance manager; (4) phone calls made to and received from the compliance manager, where the mobile device is a smartphone, (5) date, time, and location of enquiries, responses, and other interactions with the application; and (6) client user inputs from screens that require it; and (7) other information that may be useful in analyzing the usage of the application.

Embodiments of the interactive decision portal may also include non-functional components, which may be intended to assist with efforts to meet security requirements, to address privacy issues, to serve aesthetic purposes, or to serve other objectives.

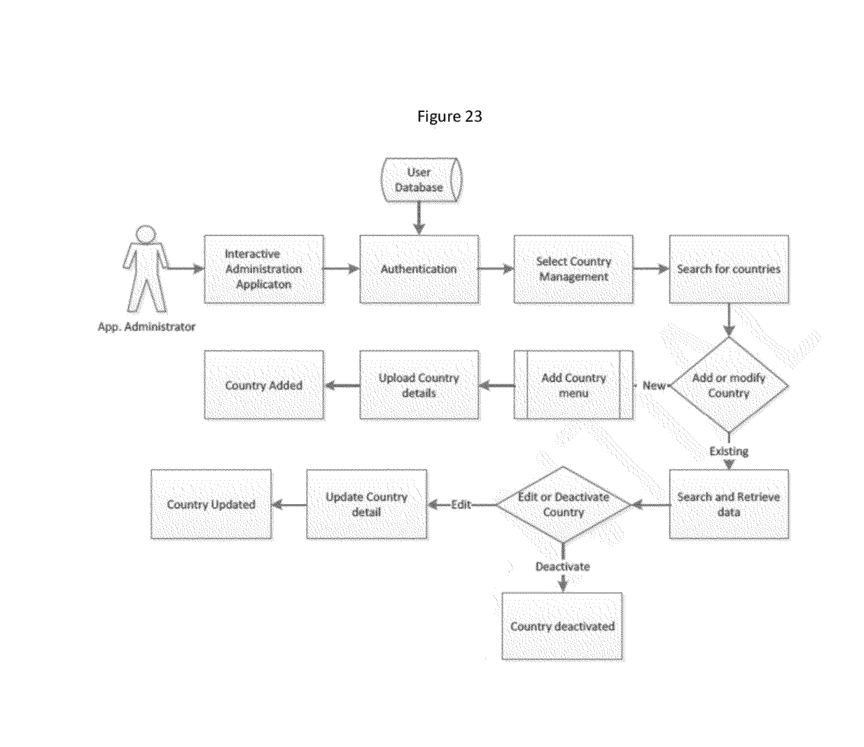

Referring to FIG. 23, in embodiments involving an interactive administration application, an application administrator may use the interactive administration application for purposes of country management, including, without limitation, editing, adding, activating, and deactivating countries. Such modifications may be done for a particular client organization (e.g. activating a country in which the client now does business that it did not previously do business) or they may be done across all clients (e.g. adding a country that was not previously included). Country management functions may include: (1) searching for a country, (2) adding a country, and (3) editing a country.

In embodiments involving an interactive administration application, searching for a country may be done by entering a string of characters into a search field and may involve pattern searching in which country names are returned that contain the string of characters entered into the search box. For example, if the word “United” were entered into the search box, the search may return countries whose names include those characters, such as “United Arab Emirates,” “United Kingdom,” and “United States.” The search results screen may have a set limit of the number of countries it will display per page. For example, there may be a limit of displaying ten results per page, with the application administrator being able to page through multiple pages of results if there are more than ten results that match the search criteria.

In embodiments involving an interactive administration application, adding a country to the compliance application may be done by the application administrator. The default list of countries may include all current sovereign states. An option to add another country may require the application administrator to enter relevant information, including (1) the continent (which may be entered via a pre-defined drop-down menu); (2) the country name (which may be limited to a predetermined length), the country's primary language (which may be limited to a predetermined length), (3) the country's currency name (which may be limited to a predetermined length), (4) an image of the country's flag (which may be limited to a predetermined file size), and (5) a description (which may be limited to a predetermined length). There may be a requirement that all fields must be completed and an error message may be displayed if an attempt to create a new country does not include all fields.

In embodiments involving an interactive administration application, editing a country may be done by an application administrator, except that the country name field may be designated as non-editable. There may be a button to deactivate the country for a given client. Such a button may operate as a toggle, change the country from active to inactive and back to active again as it is clicked multiple times with the text on top of the button changing to reflect the current state of the country (active or inactive).

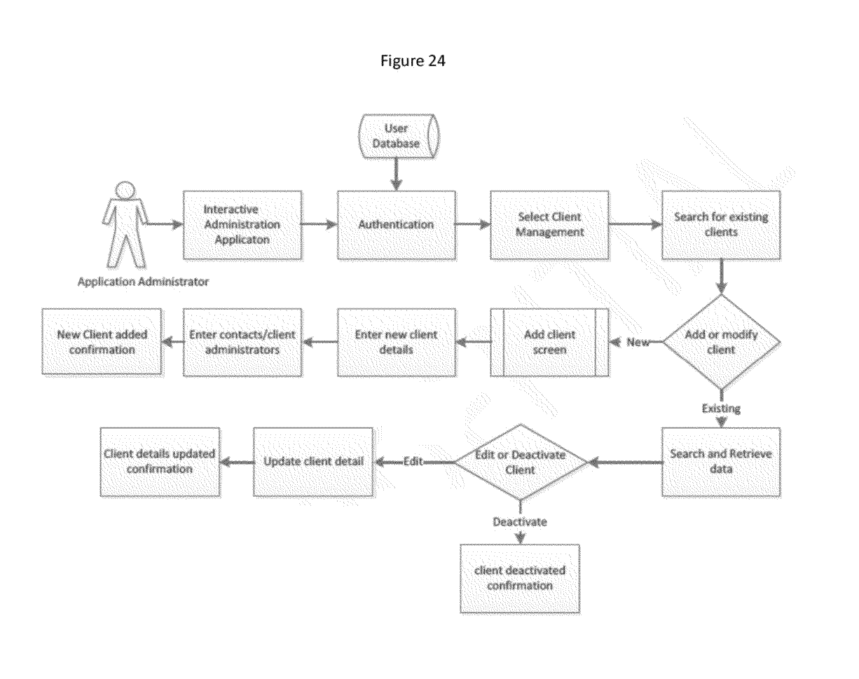

Referring to FIG. 24, in embodiments involving an interactive administration application, an application administrator may create new clients and may edit existing client information. Access to the client management functionality may be limited to the application administrator. Client management functionality may include, without limitation: (1) searching for clients, (2) adding clients, (3) editing clients, and (4) deleting clients. Searching for clients may involve an option to search for clients based on a search string. Pattern-based searches may also be possible. For example, if a search string is typed as “GE” a list of all companies containing the string “GE” would be returned on a search results screen. The search results screen may have a set limit of the number of clients it will display per page. For example, there could be a limit of displaying ten results per page, with the application administrator being able to page through multiple pages of results if there are more than ten results that match the search criteria. Search results may include one or more of the following: (1) client organization name, (2) client individual name, (3) client title, (4) client contact data, (5) client website, (6) client status, (7) total client users in results set, (8) total client administrators in results set, (9) total compliance managers in results, and (10) any other information that may be relevant.

In embodiments involving compliance functionality, adding clients may be initiated by clicking an “add client” button on a client management screen and may capture the following information: (1) client organization name, which may be limited to 100 characters; (2) client website, which may be limited to 100 characters; (3) maximum number of client users at that client, as may be determined by agreement between the application administrator and the client; (4) maximum number of client administrators at that client, as may be determined by agreement between the application administrator and the client; (5) countries of operation, which may be listed by continent and may be available in a drag and drop format; (6) the total number of countries in which that client operates, which may be calculated based on the individual countries added to the client list; (6) a client logo, which may be limited to a maximum file size (e.g. 3 MB); (7) a client caption, which may be limited to a maximum file size (e.g. 3 MB); (8) client contact information, which may include such elements as: first name (which may be limited to a maximum of 50 characters), last name (which may be limited to a maximum of 50 characters), corporate email address (which may be limited to a maximum of 150 characters and may also be designated as a mandatory field), work phone, mobile phone, and whether the individual is a client administrator (which may be a check box); (9) other relevant client information. Upon completion of the add client form, the administrative application may automatically generate an email to the client administrator with an activation link that may be used to set a password and link to access the product. The add client process may also include a validation step in which a check is done to verify that there is no other client existing with the same client name and to display an error message if there is. There may be a requirement that at least one country be mapped to a client at the time of creation. Validation may also be performed on the client logo to make sure that it is in a proper format and that its size complies with applicable requirements. An alert email may also be sent to the application administrator if the number of client users added exceeds the maximum number of client users allowed for that client. Management of the interactive decision portal may include: (1) client management, (2) metadata management, (3) policy management, (4) rule management, and (5) hierarchy rule management. A wizard in the form of “message information” may guide the application administrator through this process.

Editing existing client information need not follow a set process and may involve the application administrator opening any of the tabs from a navigation pane and performing whatever activity is appropriate based on client requirements. Possible features of the client editing process include, without limitation: (1) a requirement that the client name field be non-modifiable; (2) a client deactivation button; and (3) removal of client administrators and client users from the database by hard delete, meaning that the information is permanently removed from the application. Such a deactivation button may work as a toggle, meaning that it may be clicked to activate or to deactivate depending upon its current setting, with the label on top of the button changing as appropriate to its current setting. There may be a group deactivation feature that prevents access to all client users and client administrators under a client when a client is deactivated. When a country mapping setting is removed for a client, there may be a warning stating the consequences of proceeding. In an example, the warning may say, “The policy association defined for this client will be removed, press okay to continue.” Such a warning may appear in a pop-up window. The removal of country mapping may be subject to approval by an application administrator and may prompt the removal of the country level policy creation done through the rule management/rule hierarchy management functionality.

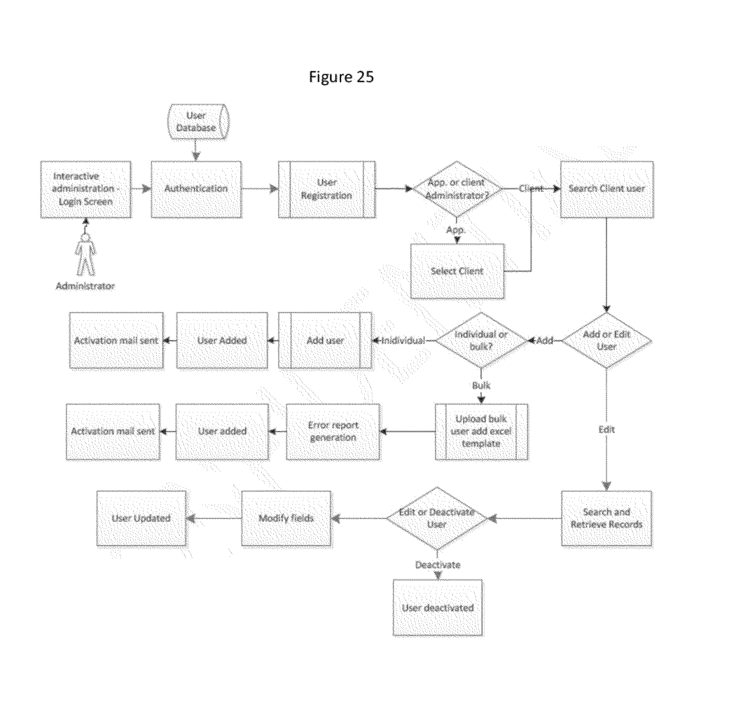

Referring to FIG. 25, in embodiments, an application administrator or a client administrator may manage client users for each client organization using the functionality available to client administrators, as well as additional administration tools. This client user management process may include, without limitation, one or more of the following functional elements: (1) searching client users; (2) adding client users individually; (3) adding client users through a bulk uploading process; (4) editing client users; and (5) sending email notifications to client users. Access to this functionality may be available both to application administrators and to client administrators and tasks may be allocated between them based on client needs.

Searching client users may involve, without limitation, one or more of the following characteristics: (1) searches may be performed using fields associated with client users, such as user name, first name and last name; (2) pattern-based searches may possible (e.g. if “Scott” is typed into the search string field, a list of all the records which contains the string “Scott” should be displayed); (3) the retrieved client record may display a range of information about the user, such as user name, first name, last name, title, country, email address, and status; and (4) if the search query returns multiple data, the search results screen may have a set limit of the number of clients it will display per page (e.g. there could be a limit of displaying ten results per page, with the application administrator being able to page through multiple pages of results if there are more than ten results that match the search criteria).

In embodiments involving compliance functionality, adding client users individually may involve, without limitation, one or more of the following characteristics: (1) an individual client user may be created using the “add new” button from the search screen; (2) a wide range of client user information may be captured during the record creation process, such as first name (which may be limited to a set number of characters), last name (which may be limited to a set number of characters), email ID first name (which may be limited to a set number of characters), title (which may be listed from metadata for the organization selected), department (which may be listed from metadata for the organization selected), city, user name (which may be pre-filled based on the email ID), country (which may be selected from the client organization's list of active countries), client manager association (which may not be an editable field), and client manager details (including first name, last name, work phone, mobile phone, and email ID); (3) by default all client users “user name” may be their email ID and may be copied automatically from the email id typed, such that the user name field is non-editable; (4) the compliance manager association may be empty during the creation of a client user and may be un-editable with its value being set in the backend based on a rule hierarchy defined for the organization after user creation is completed; (5) there may be a requirement that the user name and client ID combination be unique; (6) there may be a restriction that the country and city information captured be used only for the display of information in the welcome screen; (7) when the user is initially created, the compliance manager association screen may be empty; (8) there may be a system function that checks whether a submitted new user has an email ID that matches an existing user, such function preventing two users from having the same email ID; (9) when the client user details are entered and during the saving of the record, the hierarchy rule set for the client being entered may be compared and—based on the user's category—a compliance manager association may be established, which information may be stored for retrieval when the user data is revisited; (10) if the number of client managers is more than the number allowable under the organization's maximum hierarchy level, an error message may be displayed stating that “The number of Compliance Managers is more than the organization limit” and the user creation may be prohibited until the appropriate correction is made.

In embodiments involving compliance functionality, a bulk uploading process for client users may involve, without limitation, one or more of the following characteristics: (1) relevant client user data may be entered into a spreadsheet template, which may then be uploaded to the server; (2) the “@domain” portion of the email ID may be automatically generated by a macro based on the corporate email ID, rather than being typed in; (3) the template may be modified by the application administrator from time to time, such that it may not be available to download, instead being emailed by the application administrator to the client administrator; (4) a report may be generated and shown to client administrator after each upload is conducted, such report containing information on successful user creation and a list of failures with reasons for each user; (5) the phone number field may be set to accept only numbers, not other characters; (6) the title and department field for each user may be validated with the entries captured in the metadata section for the client; and (7) the maximum number of compliance managers may be matched with the maximum hierarchy level captured during hierarchy rule management definition and if the record has more than the set limit of compliance managers then the user may be prevented from creating the record and the result may be captured as an error.

In embodiments involving compliance functionality, editing client users may involve, without limitation, one or more of the following characteristics: (1) user name may be a non-modifiable field; (2) a button may be provided to deactivate the user; (3) once the client user has been deactivated, that user may be prevented from accessing the interactive compliance application until the user is reactivated; (4) the deactivation button may work as a toggle, meaning that it may be clicked to activate or to deactivate depending upon its current setting, with the label on top of the button changing as appropriate to its current setting; (5) the compliance manager association may be visible based on the rule set in the rule hierarchy management for the client with this field being used for verification purposes only; (6) there may be a system function that checks whether a submitted new user has an email ID that matches an existing user, such function preventing two users from having the same email ID; (7) when the client user details are entered and during the saving of the record, the hierarchy rule set for the client being entered may be compared and—based on the user's category—a compliance manager association may be established, which information may be stored for retrieval when the user data is revisited; (8) there may be a function that confirms the validity of the email ID before accepting a new user record; and (9) if the number of client managers is more than the number allowable under the organization's maximum hierarchy level, an error message may be displayed stating that “The number of Compliance Managers is more than the organization limit” and the user creation may not be allowed until the appropriate correction is made.

Email notification may take place upon creation of a new user record and may involve automatically generating an email to the email ID in the new user record, such email containing an activation URL link, which may enable the client user to set a log-in password, as well as details on how to download and install the mobile application and the URL for accessing the web application.

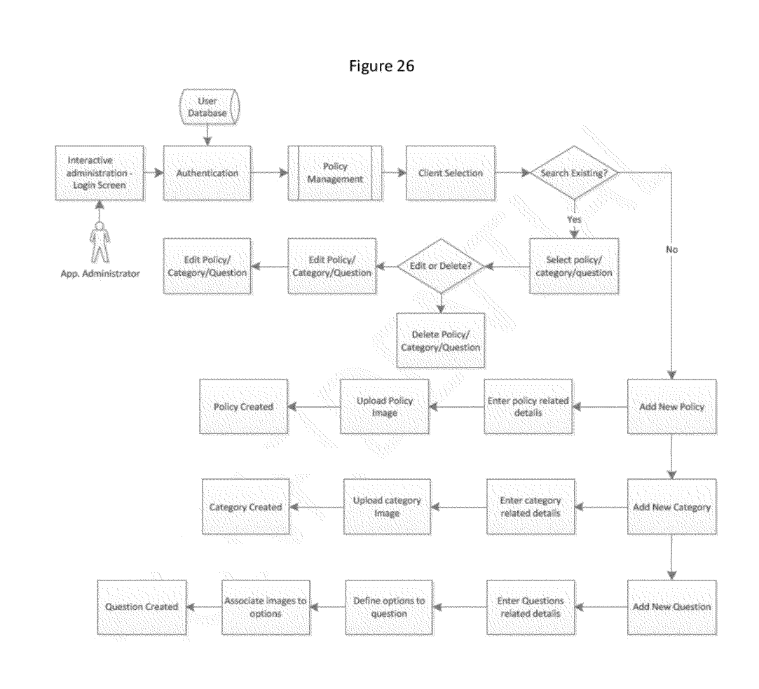

Referring to FIG. 26, in embodiments involving compliance functionality, an application administrator may conduct policy management following a structured process. Access to policy management controls may be limited to the application administrator. This policy management process may including managing policies, categories, questions, and options and may be subject to input from the client organization. The policy management process may involve, without limitation, one or more of the following functional elements: (1) searching a policy or category; (2) adding a policy; (3) editing a policy; (4) adding a category; (5) editing a category, (6) adding questions and options; (7) editing questions and options; (8) searching an approval template; (9) adding or editing an approval template; and (10) adding or editing fields in an approval template.

In embodiments involving compliance functionality, searching a policy or category may involve, without limitation, one or more of the following: (1) selection of client ID from a drop down-menu on which the list of all the clients created may be available; (2) searching by various fields, such as client ID, policy name, category name, question, and option; (3) pattern based search may be, such that if the search string is typed as “Type” a list of all the records which contains the string “Type” for that particular client should be returned; (4) if the search query returns multiple data, the search results screen may have a set limit of the number of clients it will display per page (e.g. there could be a limit of displaying ten results per page, with the application administrator being able to page through multiple pages of results if there are more than ten results that match the search criteria); (5) the retrieved record may show the following details, without limitation, based on the search performed: client ID, status, policy, category, and questions; (6) the policy, category, and questions fields may be clickable in the returned data display and clicking any of these data may cause the corresponding policy, category, or question and its related fields created to open in a separate window; (7) all policies, categories, questions, and options may be created as a separate entity under each client and the association of these entities may be handled under Rule management; and (8) search functionality may fetch individual policies, categories, questions, or options for each client and may be retrievable through a combination of client id with any of the policy, category or question parameters.

In embodiments involving compliance functionality, adding a policy may involve, without limitation, one or more of the following: (1) the association of a client, (2) the capture of a number of fields, such as client ID, which may be auto-filled and non-editable, policy, including policy name, which may be limited to a set length (e.g. 50 characters), help text, which may be limited to a set length (e.g. 1000 characters), and an upload image; (3) a preview option for the upload of images; (4) a delete button to remove policy entries; (5) restrictions on file size for uploaded images; and (6) a requirement that no two policies have the same name for a given client.

In embodiments involving compliance functionality, editing a policy may involve, without restriction, one or more of the following characteristics: (1) the policy name may be non-editable; (2) there may be a delete button to remove the policy entry; (3) upon deletion of a policy, all the associations and rules defined under the policy type may be deleted; and (4) a warning message may be shown during the deletion of a policy stating that this action could lead to serious disassociation in the rule mapping present in the rule management section.

In embodiments involving compliance functionality, adding a category may involve, without limitation, one or more of the following characteristics: (1) the association of a client, (2) the capture of a number of fields, such as client ID, which may be auto-filled and non-editable, policy, including policy name, which may be limited to a set length (e.g. 50 characters), help text, which may be limited to a set length (e.g. 1000 characters), and an upload image; (3) a preview option for the upload of images; (4) a delete button to remove policy entries; (5) restrictions on file size for uploaded images; and (6) a requirement that no two categories have the same name for a given client.

In embodiments involving compliance functionality, editing a category may involve, without restriction, one or more of the following characteristics: (1) the category name may be non-editable; (2) there may be a delete button to remove the category entry; (3) upon deletion of a category, all the associations and rules defined under the category type may be deleted; and (4) a warning message may be shown during the deletion of a category stating that this action could lead to serious disassociation in the rule mapping present in the rule management section.

In embodiments involving compliance functionality, adding questions and options may involve, without limitation, one or more of the following: (1) a question may be required to have at least one answer associated with it; (2) there may be a requirement that any questions or options created be associated with a client; (3) a number of fields may be captured during the creation of questions and options, such as client id (which may be auto filled and non-editable), question text (which may be limited to a maximum number of characters), currency value (which may be expressed as a number of up to ten digits), currency (which may be selected from among the currencies available in country management), answer type (which may be collected via a drop-down menu with a maximum of ten options), options (which may correspond to the number selected in answer type and may have a limit of 200 characters each), an image (which may correspond to the number selected in answer type), preview (which may correspond to the number of images uploaded), help text (which may be limited to a set number of characters), key points to remember (which may be limited to 2 blocks maximum), help file (which may be limited to a maximum number of characters); (4) for questions which have currency related detail in them, the application administrator may be required to enter an amount in the currency value field and associate a corresponding currency with it; (5) answer type may have drop-down button with options from 1 to 10; (6) key points to remember may have two text boxes and a checkbox associated with the second text box and may default to having only one text box active, such that the second text box activates when the check box is clicked; (7) typing a tab from the last “Key points to remember” text box should populate the entire content of the help file and “Key points to remember” file section into the mobile device help file text box; (8) the option may be shown as text on a tablet and/or Web versions of the interactive compliance application and the image may be shown for mobile device native version of the application; (9) upper and lower file size limits may be defined for the mobile device image.

In embodiments involving pre-defined questions and options, editing questions and options may involve, without restriction, one or more of the following characteristics: (1) the client ID may be non-editable; (2) upon deletion of a question or option, all the associations and rules defined under the question or option may be deleted; and (4) a warning message may be shown during the deletion of a question or option stating that this action could lead to serious disassociation in the rule mapping present in the rule management section.

In embodiments involving approval templates, searching an approval template may involve, without limitation, one or more of the following: (1) each category for a client may have an approval mail template associated with it; (2) search may be based on the client ID and category; (3) there may be a limited number of templates for each category, such that the search query returns only one result; (4) clicking on the “add” button may take the user an add/edit approval template screen with the client ID and category chosen in the search screen; and (5) the “add” button may be inactive if there is no client ID/category combination selected.

In embodiments involving approval templates, adding or editing an approval template may involve, without limitation, one or more of the following: (1) the system may be restricted to allow creation of only one mail template for each category for a client; (2) client ID and category may be non-editable fields and should be pre-populated with the options selected from the search approval template screen; (3) each approval mail template may be identifiable with the approval template name; (4) each row that has to be added for an approval mail template may have a label, a field type, and a data type; (5) multiple labels and associated field type may be added to each template; (6) each row of these labels should have an option to delete it; (7) for labels like country or currency, an option may be provided to populate the list from the existing data captured in the country management; (8) options may be provided to create lists for dropdown menus, rolling options, check boxes, and radio buttons; and (9) there may be a restriction that, for a given category, only one approval template may be allowed to be created.

In embodiments involving field approval templates, adding or editing a field approval template may involve, without restriction, one or more of the following characteristics: (1) clicking on an “add field” button may invoke this screen; (2) each label may be required to have a label name; (3) each label may be required to have a field type associated with it and the selection may be made through a radio button option; and (4) each label may have a data type associated with it.

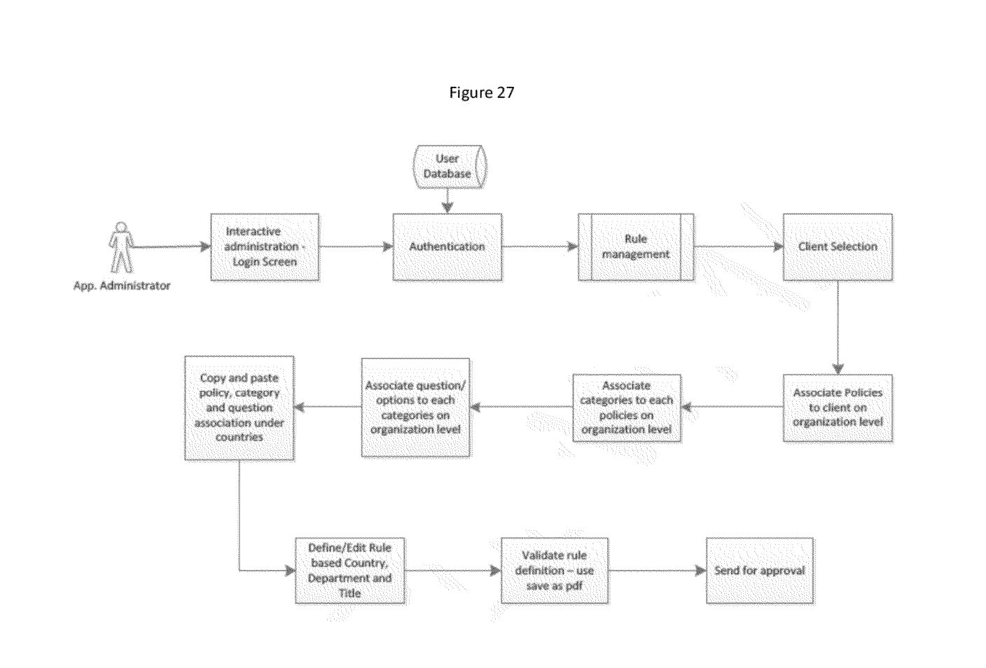

Referring to FIG. 27, in embodiments, an application administrator may conduct rule management following a structured process that may involve, without limitation, one or more of the following: (1) a client search function, (2) a function for creating policy mapping and rule definitions; and (3) a function for editing policy mapping and rule definitions. Access to this functionality may be limited to the application administrator.

In embodiments involving a client search function, the client search function may include, without limitation, one or more of the following characteristics: (1) searches may be performed based on the client ID field; (2) pattern based searches may be possible (e.g. if “GE” is typed into the search field, a list of all the records which contains the string “GE” may be displayed; (3) if the search query returns multiple results, the search results screen may have a set limit of the number of clients it will display per page (e.g. there may be a limit of displaying ten results per page, with the application administrator being able to page through multiple pages of results if there are more than ten results that match the search criteria); (4) an edit option to be create new or edit existing policy mapping for each client; and (5) the search option may retrieve a range of client-related information, such as client name, client website, and status (whether the client is active or inactive).

In embodiments involving a policy mapping and rule definition function, the policy mapping and rule definition function may include, without limitation, one or more of the following characteristics: (1) the name of the client for which the rules are being defined may be shown as a non-editable field; (2) the association of the policies, categories, questions, and options may be managed as a folder/sub-folder tree structure; (3) for organization-wide policy mapping, each client may be assigned an organization level rule where policies forms the top hierarchy and under which there is an option to include list of categories and under each category there may be provision to add set of questions and answers; (4) selecting a category may open a separate adjoining window where the questions and options under them are defined; (5) all countries associated with the organization (captured during client management) may by default be present under the organization tree; (6) under each country an option may be provided to add a department or a title; (7) under each country, there may be an option to add a department, under which a title may be added and then policy, category, and question options may be added in the same order, provided that it may still be appropriate for a policy node to be added under the country or department; (8) there may be an option to copy the process flow defined under each policy or category and such process may be replicated and used under country, department or title, including the possibility that there may be functionality that allows the copying and pasting of a policy/category and its underlying rule (sub-folder structure) definition; (9) the added department or title may be provided as a list where only the department and title created for that specified organization are visible; (10) rule management may have two blocks wherein the block on the right may contain organization, country, department, title, policy, and category association; (11) selection of categories may open the category in the left block where questions and options may be associated with the categories; (12) in any part of the tree structure, an option may be provided to delete the current node, which will by default may delete all of its sub-nodes; (13) an option to save the decision tree as a .pdf file may be provided; (14) a save button to save the rules and associations defined may be provided; (15) a cancel button to cancel the ongoing task may be provided; (16) there may be a submit-for-approval function that generates an email to a pre-defined application administrator; (17) there may be a prohibition on replacement of questions, which prevents questions from being changed without the application administrator deleting the node and then recreating the node with the corrected questions; (18) the hierarchy on which the policy definition may be created is as follows: organization->country->department->title; and (19) policy and its sub-nodes (category, question, and options) may be created under any of the organization, country, department or title nodes.

In embodiments involving a policy mapping and rule definition editing function, the policy mapping and rule definition editing function may include, without limitation, one or more of the following characteristics: (1) the name of the client for which the rules are defined may be shown as a label; (2) the decision tree which contains the already-defined policy, category, and rule mapping may be visible and accessible; (3) clicking once on the policy, category, questions, or options should open the decision tree and show process defined below each topic; (4) clicking again on the policy, category, questions, or options may close and hide the decision tree and the associated processes for each topic; (5) in any part of the tree structure, an option may be provided to delete the node and its sub-node; (6) there may be an option to save the decision tree as a .pdf file; (7) there may be an option to print the decision tree; (8) there may be a save button that enables saving the rules and associations defined; (9) there may be a cancel button that cancels the ongoing task; and (10) there may be a submit-for-approval form that automatically generates an email to a pre-defined application administrator.

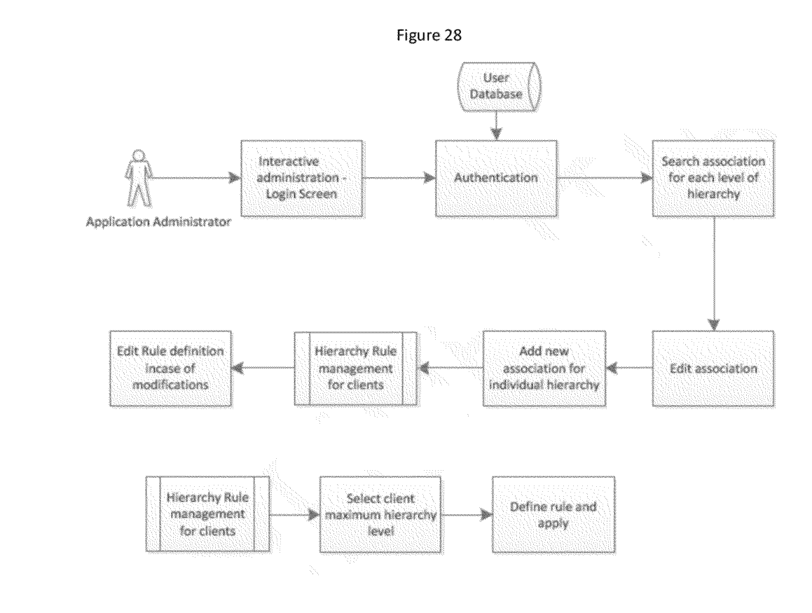

Referring to FIG. 28, in embodiments, an application administrator may conduct rule hierarchy management following a structured process, which may include, without limitation, one or more of the following functions: (1) search association, (2) create association, (3) modify association, and (4) rule tree management.

In embodiments involving a search association function, the search association function may include, without limitation, one or more of the following characteristics: (1) an option to search existing associations; (2) the ability to search based on hierarchy level, possibly through the use of a drop-down menu; (3) if the search query returns multiple data, the search results screen may have a set limit of the number of clients it will display per page (e.g. there could be a limit of displaying ten results per page, with the application administrator being able to page through multiple pages of results if there are more than ten results that match the search criteria); and (4) the search query may return the existing associations created, including such fields as hierarchy level, associated image, and the text related to that image.

In embodiments involving a create association function, the create association function may include, without limitation, one or more of the following characteristics: (1) from the search screen the application administrator may be able to create associations using the ‘add new’ button; (2) in the hierarchy add/edit window, the application administrator may be able to add images, add connectors (e.g. “and” or “or”) between images, and add groups; (3) groups may be a collection of images which is associated by a parenthesis (e.g. if the user types 3 and clicks ‘Add ‘OR’ group’ button, the association should look like [A OR B OR C]); (4) the application administrator may be allowed to create only as many associations with images as permitted by the hierarchy level set (e.g. if the association is to be done for level ‘3’, then the user may be required to create associations between three images and may be prohibited from creating the associations with fewer than or more than three images; (5) hierarchies may be required to start and end with images; (6) there may be a requirement that images be separated with connectors; and (7) there may be a requirement that there be a connector between an image and a group; a text window may be available where the elaborate definition of the image will be captured.

In embodiments involving a modify association function, the modify association function may include, without limitation, one or more of the following characteristics: (1) from the search screen, the application administrator may be able to retrieve already-created associations and, using the edit button, may be able to edit the existing hierarchies; (2) in the hierarchy add/edit window, the application administrator may be able to modify image associations, modify connectors (‘and’ or ‘or’) between images, modify the group in the image; (3) editing the content of the text window which elaborates the definition of the association may be possible; and (4) based on the hierarchy level set, the application administrator may be allowed to create associations with only that many numbers of images (e.g. if the association is to be done for level 3, then the user may be required to create associations between three images and cannot create associations with fewer than or more than three images.

In embodiments involving a rule management tree function, the rule tree management function may include, without limitation, one or more for the following characteristics: (1) rule management may be used for defining the various associations that the client users of the organization could have; (2) the rules set may be used by the interactive compliance application to manage the approval process for each client user and for determining to whom emails with approval requests should be sent; (3) for each client a maximum hierarchy level limit may be set, possibly using a drop-down menu, which may offer a range of options from 1 through 99; (4) the nodes defined up to the title level (organization, country, department and title) from the policy mapping may be present as the default hierarchy rule management; (5) the order of hierarchy definition may follow a set sequence, which may be organization, country, department, title, policy, and category; (6) the selection of rule definition may be limited, such that it does not exceed the maximum hierarchy level set and the image associations may be available via a drop-down menu that should have all the hierarchy created up to the maximum level set (e.g. if the maximum hierarchy level is set as 3, then this drop-down menu may list all the hierarchy created up to 3 levels); (7) the application administrator may validate that the rule hierarchy is properly set for each organization; (8) the rule definition may follow a bottom-to-top approach; and (9) the hierarchy association may be added under any of the nodes that are created.

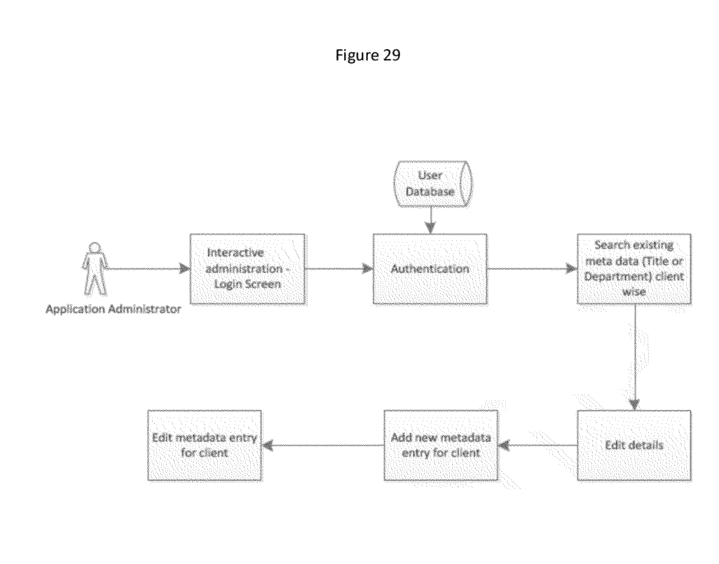

Referring to FIG. 29, in embodiments, an application administrator may conduct metadata management following a structured process. Metadata management may be limited to only an application administrator. Among the information captured by this process may be the title and department of each client user. Metadata management may include (1) searching metadata, (2) adding metadata, (3) editing metadata, and (4) deleting metadata. Searching metadata may include default search fields for department and title and may offer a client name search box by drop-down option. Pattern-based searching may also be enabled, such that if the search string “HR” is entered, all records containing “HR” will be returned regardless of whether that character string appears in the department or title field. The search results screen may have a set limit of the number of clients it will display per page. For example, there could be a limit of displaying ten results per page, with the application administrator being able to page through multiple pages of results if there are more than ten results that match the search criteria. The process of adding metadata may include, without limitation, one or more of the following characteristics: (1) client names may be picked from the client name selected from the search metadata section and may be non-modifiable; (2) there may be fields for metadata name (which may be limited to a set number of characters) and type (which may be selected from a list); (3) department and title may be captured when an new entry is created; and (4) the delete button may be inactive. Editing metadata may involve, without limitation, one or more of the following characteristics: (1) a requirement that client name be picked from the client name selected from the search metadata section and be non-modifiable; (2) there may be fields for metadata name (which may be limited to a set number of characters) and type (which may be selected from a list); (3) department and title may be captured when an new entry is created; (4) the delete button may be active and may show a warning when pressed that the rules defined in rule management and rule hierarchy management will be removed where the meta data is used (for either department or title, whichever is deleted) for the client to which the association is done; and (5) if the application administrator proceeds to delete the metadata, the nodes where the rules are defined (both rule management and rule hierarchy management) and subsequent rules defined below the node may be removed (both rule management and rule hierarchy management).

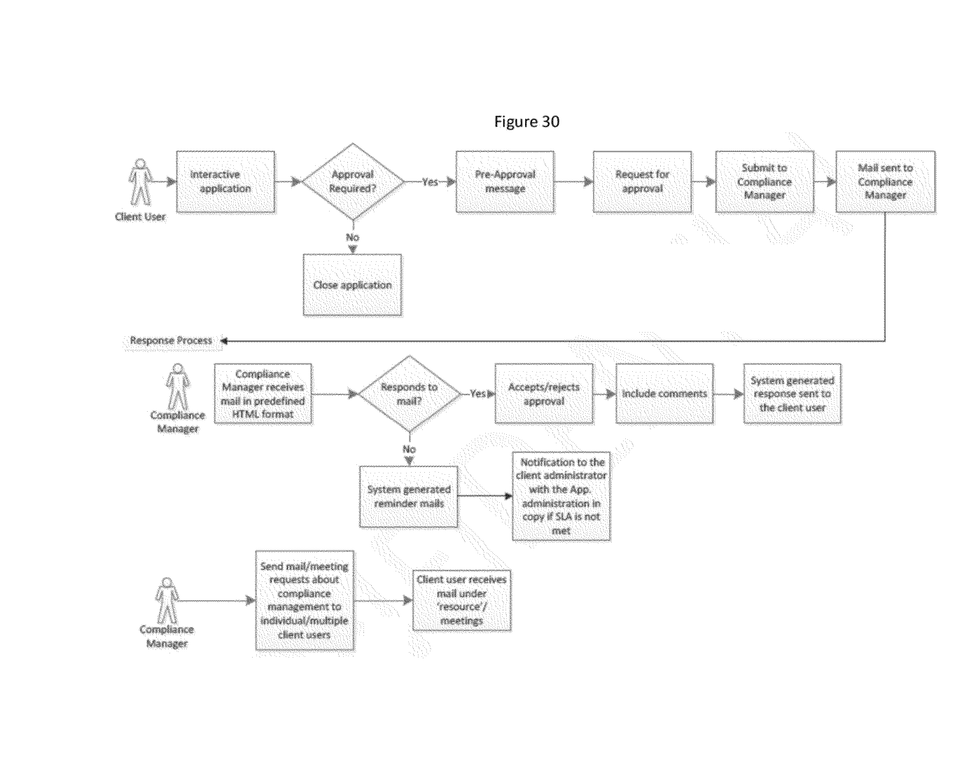

Referring to FIG. 30, in embodiments involving compliance functionality, the approval process may involve the interaction between a client user and a compliance manager following a pre-defined process flow in which the client user needs approval from the compliance manager in order to perform some task that may or may not conform with the rules defined by the organization. The client user may use a message center module, as defined herein, to manage communication and the compliance manager may use the corporate email client to communicate with the client user. This approval process may include, without limitation, one or more of the following functions: (1) submitting an approval request email; (2) accepting, rejecting or requesting additional information regarding an approval request email; (3) providing a reminder notification; (4) sending a resource email; (5) facilitating a phone call to a compliance manager; and (6) facilitating an offline approval submission process.

In embodiments involving compliance functionality, submitting an approval request email may involve, without limitation, one or more of the following characteristics: (1) based on defined questions and options, certain requests may require prior approval from the compliance manager; (2) based on the approval template created for each client by the application administrator, the request for approval screen may vary in the details captured and incorporated into the approval request email; (3) upon submission of the request, the interactive compliance application may generate an automated email to the corresponding compliance manager(s) based on the rule defined for each client user; and (4) a built-in mail exchange server may handle all the mail transactions between the various users of the application.

In embodiments involving compliance functionality, reminder notifications may involve, without limitation, one or more of the following characteristics: (1) if there is no action taken in response to an approval request email, reminder notification emails may be sent every day to the first level compliance manager starting at an established interval after the first approval request email; (2) if all the required compliance managers (based on the hierarchy rule set) have not approved the request, an established waiting period may be observed and then daily notification emails may be sent to that compliance manager who has not responded until either the compliance manager responds or a defined deadline has been crossed (whichever is the first); (3) this process may be followed until all the compliance managers have responded to the approval process, as defined for the client user; and (4) once the deadline date for the request treatment is crossed, the notification mail being sent to the compliance managers may be stopped and a one time notification email may be sent to the client administrator for the client, with a copy being sent to the application administrator, containing information on the client user and list of compliance managers who were required to review the application.

In embodiments involving compliance functionality, sending resource emails may involve, without limitation, one or more of the following characteristics: (1) resource emails may be sent by the compliance manager using their default mail client to specific client users; (2) these emails may contain embedded http links to videos, documents or any other resources pertaining to compliance policy; (3) there may be a requirement that these emails not include attachments; (4) the system may identify these emails through the token present and place a notification as an image in the client user's message board resources folder; (5) the number on the resource folder images may change based on the number of unread resource emails; and (6) when a resource email is read, the number count displayed should decrease accordingly.

In embodiments involving compliance functionality, functionality to facilitate calls to compliance managers may be different on embodiments running on a smartphone, such as an iPhone, than in embodiments running on a tablet device or web server. On a smartphone (e.g. iPhone), the phone number of the first level compliance manager may be available under the “help desk” option and upon clicking or touching should dial a call to the compliance manager. On a tablet (e.g. iPad) and web versions of the interactive compliance application, the list of the entire compliance managers and their work phone number may be listed and accessible through the alternative sidebar or dropdown menu.

In embodiments involving compliance functionality, functionality to facilitate offline approval submissions may include, without limitation, one or more of the following characteristics: (1) for the mobile application, if the device is offline and the user tries to submit an approval form to the compliance manager, a notification may appear stating that “the device does not have an internet connection and the approval will be submitted once a connection has been established”; (2) the application may capture the request submission and temporarily store it locally on the device; (3) once the device is online, the application may submit the captured approval request; and (4) once the submission is completed, an information message may be shown to the user confirming that the approval has been sent.

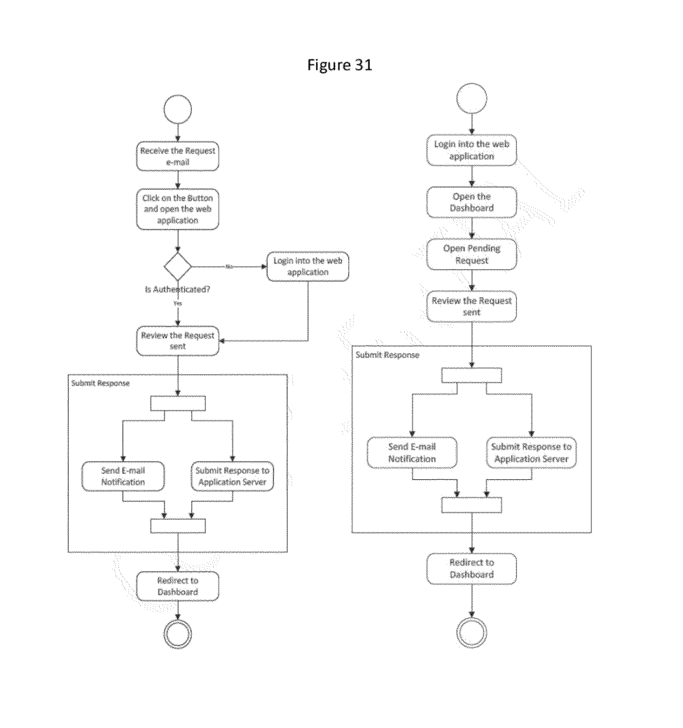

Referring to FIG. 31, in embodiments involving compliance functionality, a compliance manager may use the web application to review and reply to client user requests for approval.

Embodiments of the disclosure involving compliance functionality may include a number of features designed to improve functionality and efficiency, which may include one or more of the following: (1) multi-tenancy support; (2) user interfaces for web connections and smart devices (which may include, without limitation, iPhones, iPads, iPods, and other smartphones, tablet computers, wearable computers, personal media players, implantable computers, and similar devices); (3) form authentication and authorization to control web access; (4) error handling and logging; (5) administrative functionality with easy access to support personnel; (6) use of enterprise design concepts; (7) re-use of components for multiple functions where practical and effective; (8) an email feature; (9) client, country, and user management tools; (10) a request submission screen, which may be used for reviewing and approving requested actions by users; (11) a message center, which may offer information on various items related to compliance efforts, such as responses, reminders, resources, and copies of compliance policies; and (12) a policy rule engine, which may consist of algorithms, data, and other components useful for such purposes as responding to requests, providing information, and performing other functions as may be necessary or helpful for the disclosure to achieve its purposes.

Embodiments of the disclosure may make use of one or more of the following design concepts: (1) extensibility, which may allow an implementation to take into consideration possible future growth; (2) configurability, which may allow a system to be manipulated with minimal effort for such purposes as lifecycle management, customization, and flexibility; (3) performance, which relates to components and features of a system that may contribute to (a) its meeting user expectations, administrator expectations, and other standards set for it, (b) the system's effectiveness in managing, documenting, and providing data in a regular and timely manner, and (c) achieving other goals and objectives; and (4) scalability, which indicates a system's capacity for growth through means such as (a) handling growing amounts of work and data without problems, (b) the system's ability to be enlarged, and (c) other features or characteristics that are useful in increasing the workload of the system.

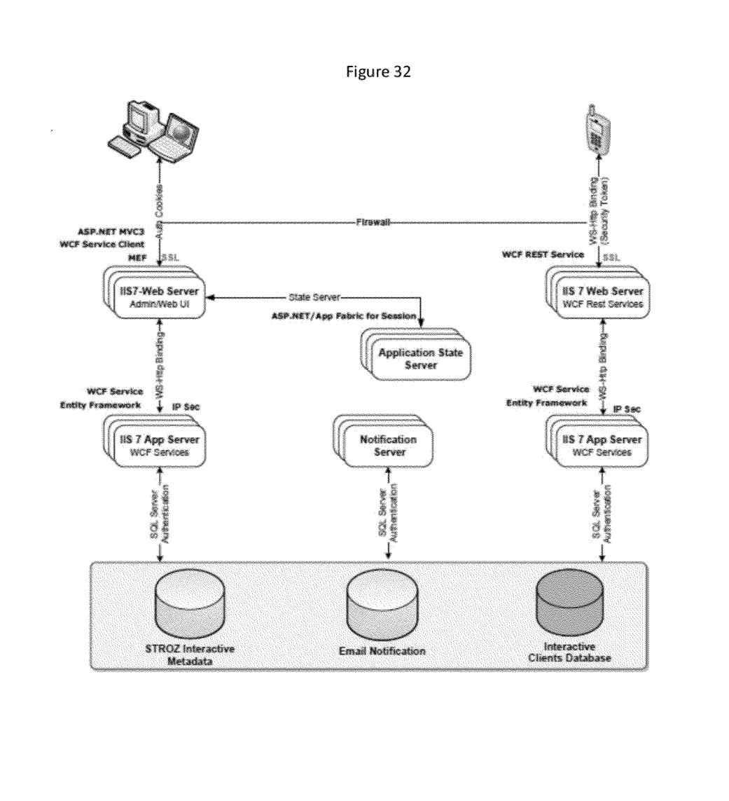

Referring to FIG. 32, the interactive decision portal may use an N-Tier design, with clear separation of concerns between the user interface layer, the business logic layer, and the data layer. In embodiments, these layers may be separated not only logically, but physically. Such layering may provide greater flexibility for re-use, as well as the ability to scale out any specific tier. The interactive decision portal may have one or more of the following characteristics: (1) the crisp, professional look and feel of a native application; (2) fast, seamless interactions between components of the system, including between mobile devices and the administration application; and (3) sufficient scalability for expansion to other platforms and operating systems. In an example of these embodiments, the interactive decision portal may make use of cross-platform development tools, such as Appcelerator Titanium.

In embodiments, the interactive decision portal may make use of a modular development approach in which each functional component may be developed as a separate project, but which are combined before deployment into a seamless application, such that these plug-in modules (“plugins”) are called to perform tasks as needed by the main application. In an example of these embodiments, these functional components may include one or more of the following: (1) a user interface layer, which may include a model view controller application built to execute within the context of a host application; (2) a service layer, which may include interface contracts and service adapters that locate and execute appropriate business logic; (3) a business layer, which may include an application tier façade and business components; (4) a resource access layer, which may include service agents and data access logic; and (5) a business entity, which may interact with a particular domain or with external business entities.

In embodiments, such a user interface layer's application architecture may be based on a model-view-controller (“MVC”) pattern that is intended to separate the application logic from input and presentation, which may allow for independent development and testing of each component. The user interface may also be designed to deploy a plugin that provides business functionality without needing to deploy the entire application. In an example, the user interface layer may use the Microsoft implementation of the MVC pattern, ASP.NET MVC 3, which may offer one or more of the following benefits: (1) it may provide complete control over the HTML markup, (2) it may enable rich AJAX integration, (3) it may allow the use of intuitive website URLs, and (4) it may provide clear separation of concerns, allowing the creation of web applications that are easier to maintain and to extend over time. In another example, the user interface layer may use Microsoft's Managed Extensibility Framework (“MEF”) to enable shared use of infrastructure by multiple plug-ins, which may have one or more of the following benefits: (1) it provides a standard way for the host application to expose itself and for it to consume external extensions; (2) it may offer a set of discovery approaches for the application to locate and to load available extensions; and (3) it may allow extensions to be tagged with additional metadata, facilitating rich querying and filtering. In this example, a custom controller factory may use MEF to discover the appropriate module to control the rending of content, allowing for independent development and deployment of modules.

In embodiments, the user interface layer may contain only logical algorithms specific to presentation of application data and may call into the application tier via a method that executes business logic and returns it as data to be presented, communication with the application tier helping to separate presentation processing from business logic. In examples of these embodiments, Windows Communication Foundation (“WCF”) services may be used as the method for calling into the application tier.

In embodiments, the service interface makes use of communications tools designed to expedite the remote programming model of instantiating for which purpose a proxy may be used, allowing the same configuration and hosting and the same programming model to be used for the local and remote cases and further allowing locations to be switched without affecting the client. In an example of these embodiments, WCF services may serve as such a communications tool.

In embodiments, there may be a service interface that makes use of a service oriented architecture (“SOA”) to achieve one or more of the following objectives: (1) enabling the delivery of new generations of dynamic applications (sometimes called composite applications), which may provide end users with more accurate and comprehensive information and insight into process and may also provide the flexibility to access the service interface in the most suitable form and presentation factor, whether through the Web or through a rich client or mobile device; (2) enabling the improvement and automation of manual tasks; (3) offering a consistent view of interactive and partner relations; (4) orchestrating business processes that comply with internal mandates and external regulations; (5) helping businesses to gain the agility necessary for superior marketplace performance; (6) facilitating improved scalability of the number of services in an application tier, particularly if there are bottlenecks; (7) enabling changes to the underlying implementation without impacting the clients that are using the service by encapsulating the functionality in a service behind a service interface; and (8) enabling cross-platform communication with the enterprise.

In embodiments, there may be a business layer that has one or more of the following characteristics: (1) it may take advantage of implementation workflow in a structured manner; (2) it may be configurable through configuration files; (3) it may be capable of implementing a business rules engine that provides integrated workflow and rules experience; and (4) it may be isolated from the service layer, such that those two layers share no code or dependencies. Examples of these embodiments may make use of the C# class, Windows Workflow, or both.

In embodiments, there may be a resource access layer that may be used to access data. Such data may come from one or more sources, which may include a SQL server that is accessed directly by the portal application and external sources exposed through web services. Existing systems' core functionality may be re-used through Web Services. A generic data access provider may be used to implement direct access to databases. Use of such a generic data access provider may provide a layer of abstraction between the business entities and the underlying storage structure. This layer of abstraction may be useful to maintainability. Such external services may be accessed through WCF clients. In some examples of these embodiments, the data accessed directly in the SQL Server may be limited to portal-specific data under the control of the portal team, such as interactive and policy data.

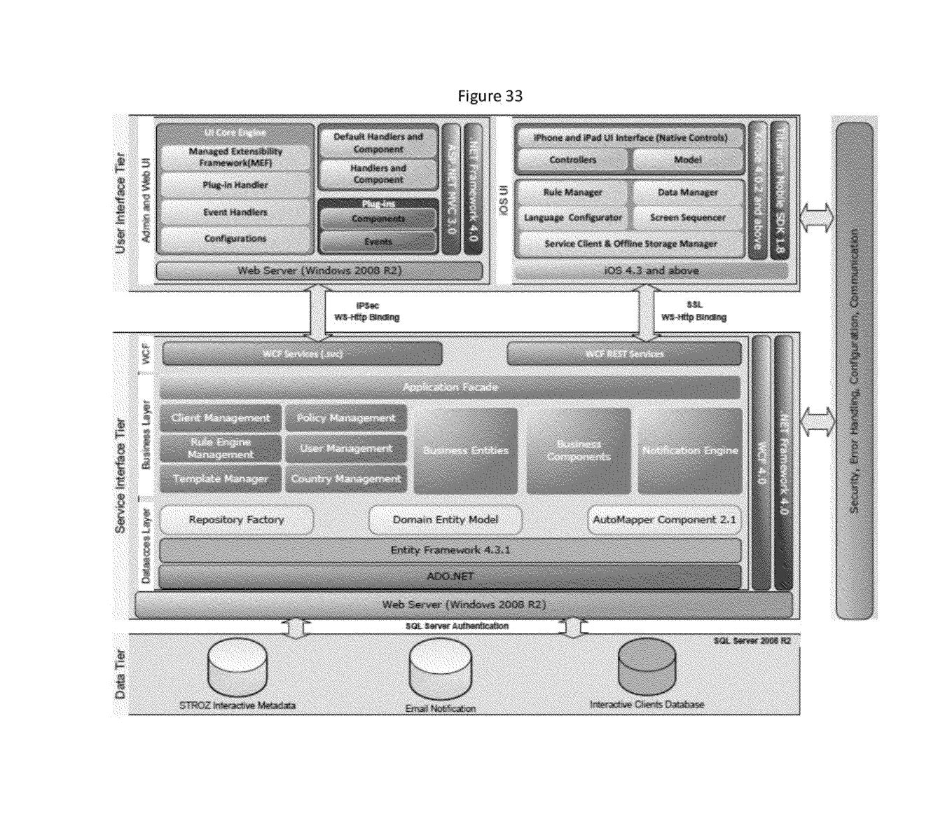

Referring to FIG. 33, the disclosure may include an interactive portal logical application architecture that layers the component-based architecture across multiple tiers. Such layering may offer advantages with respect to flexibility for re-use and may also facilitate the scaling-out of any given tier. Such layering may also allow business logic to be re-used by other applications and may secure the business logic behind the service layer.

In embodiments, there may be an administration user interface or a web user interface, one or both of which may make use of one or more of the following technologies or similar technologies, including updated versions: (1) ASP.NET MVC3, which may be used to control packaging of business logic into a presentation view via HTML or for other purposes; (2) the Microsoft .NET Framework 4; (3) C#4.0; (4) JQuery, which may or may not be mixed with ASP.NET Ajax scripts, as well; (5) AutoMapper 2.1; (6) Entity Framework 4.3.1; (7) Managed Extensibility Framework (MEF); (8) Windows Server 2008 R2; (9) Internet Information Server (IIS) 7/7.5; (10) Windows Communication Foundation; (11) Session State Server; and (12) Microsoft SQL Server 2008 R2.

In embodiments, there may be a mobile device user interface that has the same or similar look and feel to that of native applications designed for that mobile platform. In an example of these embodiments, a mobile device user interface designed to run on iOS may appear similar to native iOS applications and may be designed to be readily extendable to other mobile operating systems, including Android OS. In these embodiments, the mobile application may be built using the Appcelerator Titanium framework, which may be used to generate both a typical XCode (Objective-C based) project as well as binary code on the iOS platform. Such iOS binary code may be used in an application that interacts with the iOS device just like any other application. In an example, it may be possible to convert the same code into a fully functional Android application with minimal effort, with the only changes that are needed in porting the code being to correct for OS-specific mapping of various APIs that may be used to interact with the device itself. In these examples, the mobile device user interface may make use of the Appcelerator Titanium platform, which may make include one or more of the following technologies: (1) the Macintosh OSX 10.6.8 operating system or a more recent version of that operating system as a development operating system; (2) the Titanium Mobile SDK 1.8 or later as a cross-platform framework; (3) Xcode 4.02 or later as a native development library; (4) Eclipse (Helios) based Titanium Studio Studio 2.1 or later as an integrated development environment (“IDE”); (5) iOS 4.3 and above as supported mobile device operating systems; (6) iPhone 4 devices and iPad 3 devices as simulators for configuration testing; (7) iPad3 and iPod touch devices for direct on-device configuration testing; and (8) Xcode Organizer and Apple Distribution Certificates and mobile provisions (from Customer Enterprise Apple accounts) for packaging and code-signing.

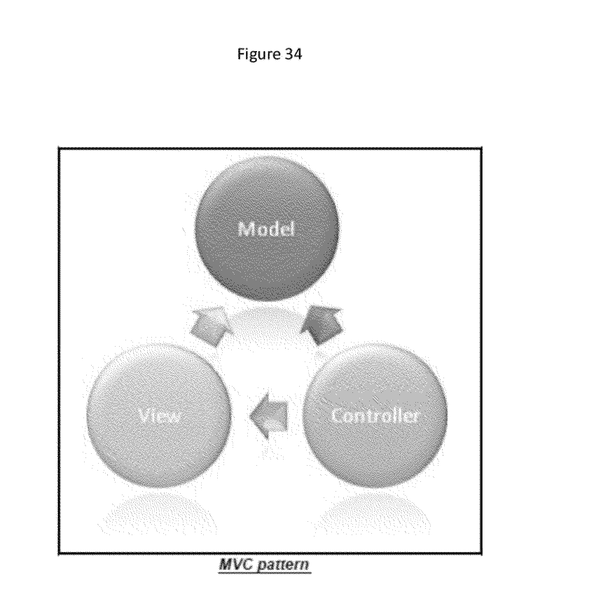

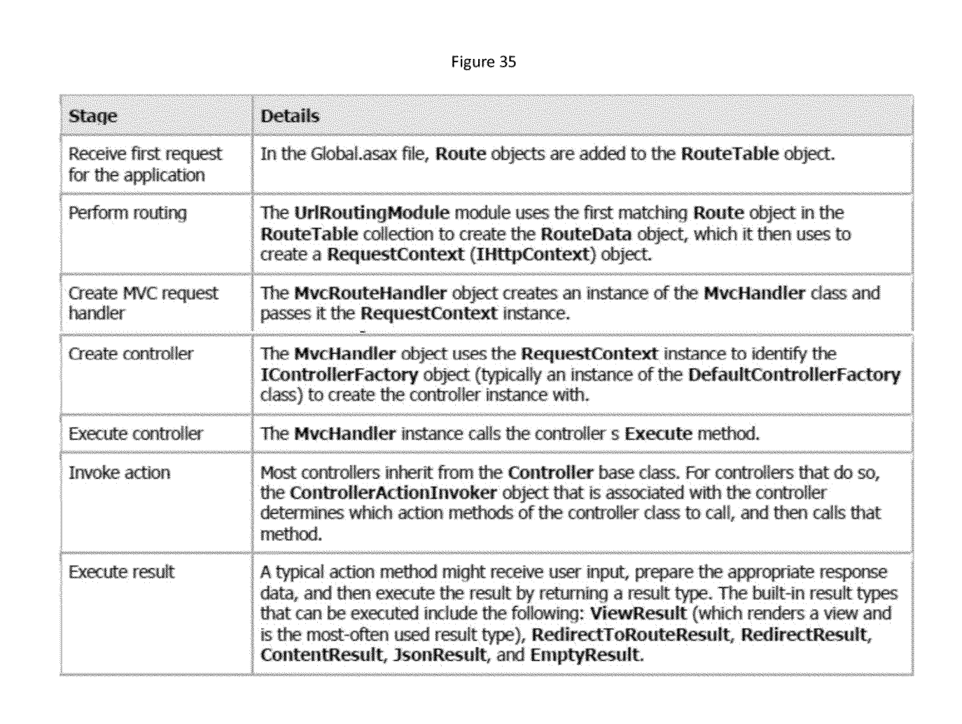

Referring to FIG. 34, in embodiments the flow of the interactive decision portal's user interface may follow a model-view-controller pattern in which a controller layer sends information to a view layer and to a model layer and in which the view layer sends information to the model layer. In examples of these embodiments, Microsoft ASP.NET MVC 3.0 or later or a similar product may be used for implementation of the user interface design. In these examples, one or more of the following functions may be performed, as described in FIG. 35: (1) an initial request for the application may be received by the user interface; (2) routing functions may be performed; (3) an MVC request handler may be created; (4) a controller may be created; (5) the controller may be executed; (6) an action may be invoked; and (7) a result may be executed.

In embodiments, the interactive decision portal's user interface application may follow a pattern that incorporates one or more of the following elements: (1) launch of the application; (2) establishment of a default route of {module}/{controller}/{action}; (3) search by the application using MEF of a folder containing plug-in modules, components, and a component handler; (4) initialization of all of the plugin modules; (5) initialization of the application_start routine of each module, which may perform all of the defaults database entries; (6) setting of personalized goal characteristics, which may include master page, menu, role management, and script handlers; and (7) initialization of the session_start routine, which may take place when a user starts a new session in the browser, which may include overriding default personalization with user-specific personalization through identification of the client based on the URL used to connect to the server.

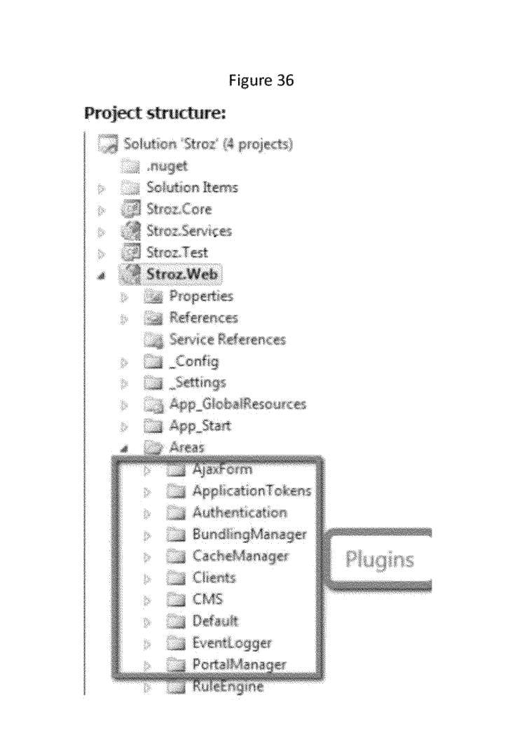

In embodiments, the interactive decision portal may use MEF to address module-level development goals and to satisfy one or more of the following requirements: (1) facilitating sharing of the underlying services and databases used by the portal application; (2) permitting modules to be distinct projects that can be deployed independently from other modules; (3) including within a given module the panel application assets that are necessary to provide that module's desired user experience; and (4) including within a given module the business logic and data access assets necessary to achieve that module's desired functionality. Referring to FIG. 36, in embodiments, such modules may include one or more of the following: (1) AjaxForm; (2) ApplicationTokens; (3) Authentication; (4) BundlingManager; (5) CacheManager; (6) Clients; (7) CMS; (8) Default; (9) EventLogger; (10) PortalManager; and (11) RuleEngine.

In embodiments, MEF may be used to create a runtime catalog of modules, which catalog may have one or more of the following characteristics: (1) it may be implemented as its own ASP.NET MVC project, provided that the MVC controllers used in such cataloged projects are marked with a ControllerMetadata Attribute, such ControllerMetadata Attribute defining the metadata by which objects are to be queried at runtime; (2) during the build process, build scripts may copy the assembly and its associated files to a “plugins” folder (see FIG. 36) in the host MVC application; (3) the path may be defined dynamically, which may help to support versioning of modules and may also be useful to the deployment of individual versions to specific clients; (4) at application startup, the MEF controller factory may be created, during which process the application may query the plugins folder within the host application to identify assemblies that are MEF-enabled; (5) MEF-enabled assemblies may be added to a catalog with their metadata ready to be queried; (6) a ClientConfiguration table may be used to hold pertinent data, such as the metadata for each client regarding which panels should be displayed and where they should be displayed; (7) at runtime, the host application may query the database for the panels that should be loaded into each placeholder; (8) the view module may then loop over the list of panels and call into an HTMLHelper extension method that may use the ControllerMetadata to create a new MVC route specifically for the panel; (9) during the execution of the new route, the MEFControllerFactory may query the MEF catalog for a controller with metadata matching the client configuration; and (10) once a controller is identified, ASP.NET MVC may perform the rendering of the panel that is to be shown to the user. Such ClientConfiguration table may be contained in a SQL server file. Such HTMLHelper extension methods may include a routine called RenderDynamicPartial.

In embodiments, one or more of the following types of measures may be taken: (1) measures to reduce and to control risk to assumed independent deployments that may be introduced in cases where modules interact with other modules; (2) measures to reduce performance penalties that may result from separation and dynamic loading of application assets; and (3) measures to address the complexity in managing builds and deployments that may result from there being a variable number of application assets that could change over the course of the release.

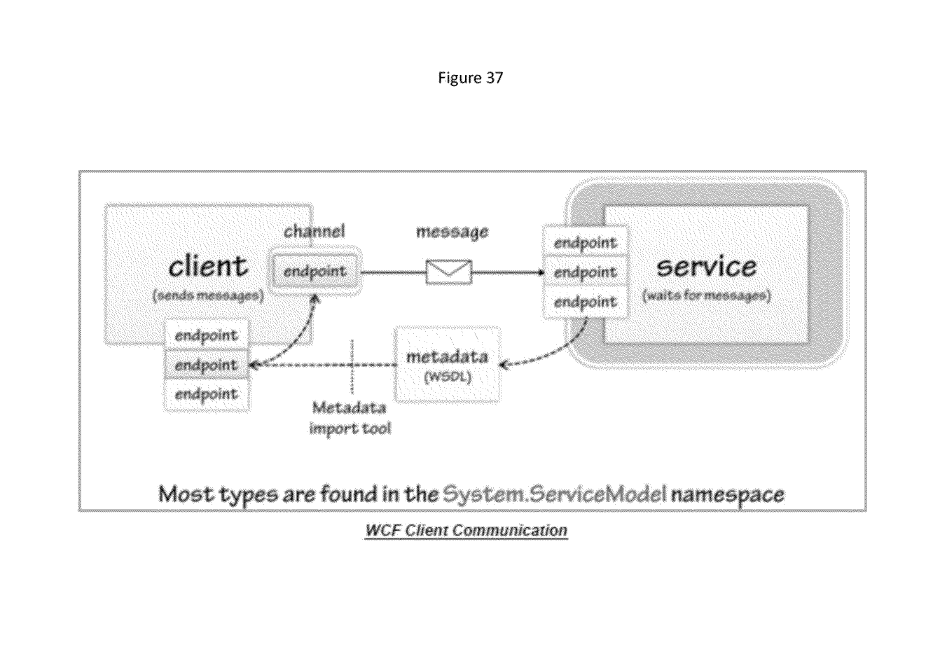

Referring to FIG. 37, the interactive decision portal may include a WCF client. Such WCF client may have one or more of the following characteristics: (1) it may be a local object that represents a WCF in a form that the client can use to communicate with the remote service; (2) it may implement the target service contract, allowing the use of a client object to invoke service operations; (3) it may receive values as return values or out of ref parameters from the WCF run time, where these values are the result of the WCF runtime converting method calls into messages, sending them to the service, and listening for the reply, before returning the values received in the reply to the WCF client.

In embodiments, mobile device applications of the interactive decision portal may include a view layer, a controller layer, and a service layer. Such a view layer may have one or more of the following characteristics: (1) it may be responsible for the visual aspects of the application; (2) it may manage interactions within the application; (3) it may serve as the guideline for the other components of the user interface; and (4) it may be written as a native application for a given device operating system and therefore have controls—such as buttons, text boxes, and labels—that are defined within the user interface specification of that operating system. Such a controller layer may have one or more of the following characteristics: (1) it may be available to be used for all decision-making and interactions among and between the other two layers (the view layer and the model layer); (2) it may initiate the application's data fetch and synchronization routines; (3) it may provide look-up methods that facilitate providing context-appropriate data to the view layer; (4) it may collect and parse data before passing those data onto the view layer; and (5) it may include a local caching mechanism that stores fetched data in a local database, allowing the application to run in offline mode. Such a service layer, which may also be referred to as a “service client and sync layer,” may have one or more of the following characteristics: (1) it may interact with the application's backend web service to retrieve data, possibly by forming an HTTP connection with the web service and initiating calls to retrieve specific data and then storing those data locally on the device; (2) it may use JavaScript Object Notation (“JSON”) format for the calls to the service requesting data and the return data from the service, which may facilitate interoperability and ease of communication between the mobile device operating system and the backend web service; (3) it may make use of a local database such as SQLite; (4) it may be updated based on the update of data online; (5) it may include a synchronization mechanism that attempts to prevent stale data that is not in sync with the online data from appearing on the mobile device, which prevention may be accomplished by checking for updates on the backend upon login and performing updates as needed at that time, such an update mechanism relying on the granularity of the updates being high enough to provide a good balance between the amount of data synchronized and the number of such checks required; and (6) it may store various data elements on the mobile device, possibly including one or more of the following: (a) user profile details, (b) branding and organization metadata, (c) policy and rule data, (d) pre-approval form submitted data, and (e) local data.

In embodiments, the interactive portal's application tier may contain a service interface layer, a business layer, and a resource access layer. Such service interface layer may provide communication between the application tier and the user interface tier, which may be accomplished through the use of contracts by which external entities can access the business logic functionality, known as service interfaces, and through the use of service adapters.

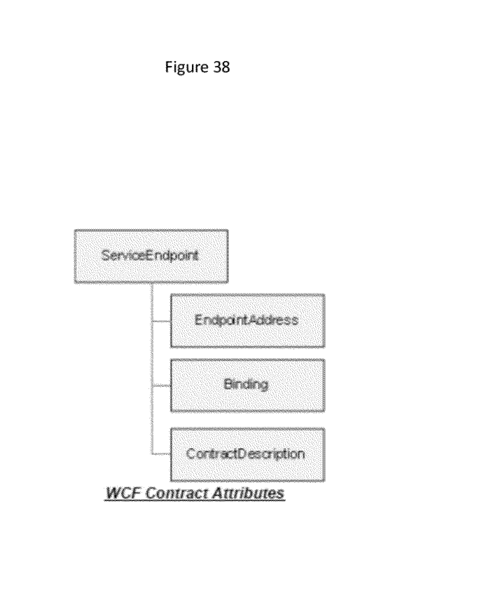

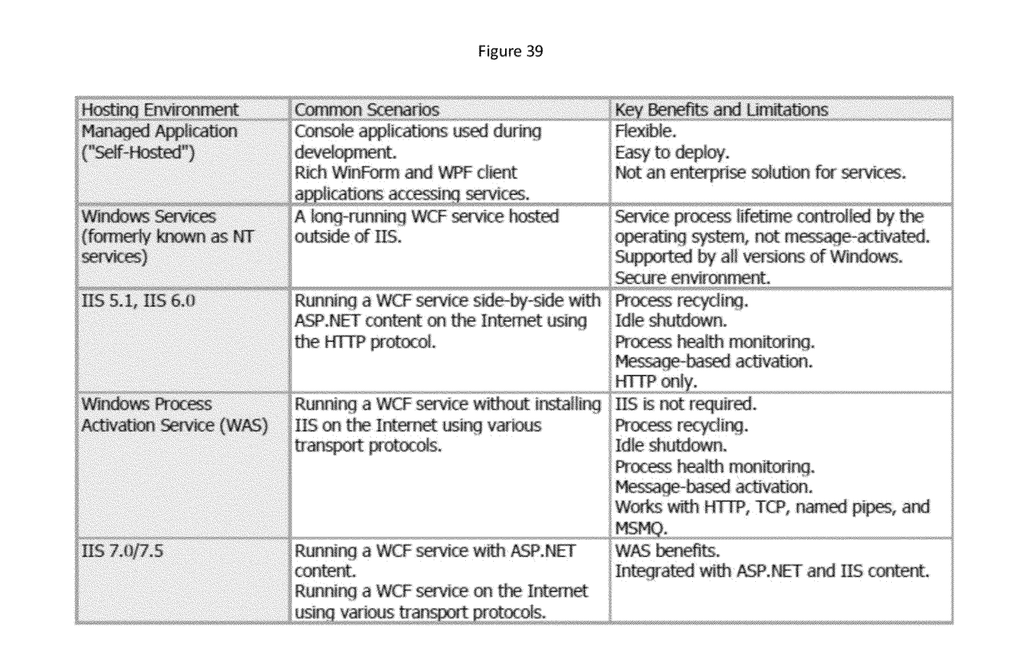

In embodiments involving a service interface layer, the service interface layer may be implemented through the use of WCF services. Such WCF services may include programs that expose a collection of endpoints used for communication, where a service endpoint is defined as having an address, a binding, and a service contract. Such an endpoint address may be defined as being the network address at which the endpoint resides. Such binding may specify how the endpoint communicates, which specification may include one or more of the following characteristics: (1) designation of a protocol, such as HTTP, TCP, or another communication protocol; (2) designation of an encoding type, such as text or binary, or another encoding type; and (3) designation of a security protocol, such as secure sockets layer (“SSL”), simple object access protocol (“SOAP”) message security, or another security protocol. Referring to FIG. 38, such a service contract may outline what functionality is provided by the service and may be created by marking an interface with one or more off the following attributes: (1) it may identify an interface as a WCF Service Client; (2) it may identify a method as an operation of the interface available to external clients; (3) it may define the message exchange pattern; (4) it may include a DataContract attribute, which may be required for serializing data types across WCF boundaries, such that no data type that is not marked with a DataContract attribute will be serialized across WCF boundaries; and (5) it may include a DataMember attribute, which may be required for serializing members of a data type across WCF boundaries, such that no data member that is not marked with a DataMember attribute will be serialized across WCF boundaries, but any data member—public or private—that is marked with the Datamember attribute will be serialized across WCF boundaries. Such message exchange pattern may have one or more of the following settings, one of which may be set as the default: (1) a request/reply setting in which the client makes a request to the service and ordinarily stops all processing until it receives a reply from the service, even in cases where the method has a void return value, but with the exception of cases in which it is implemented with an asynchronous call; (2) a one-way setting in which the client does not wait for a response to finish processing and does not process SOAP faults, which pattern may be useful in some logging instances; and (3) a duplex setting in which the client and service pass messages to each other independently, which pattern may be useful for providing an asynchronous experience or event-like behavior, such as when conducting a long-running process that returns updates to the client. Such duplex setting may be more complicated to implement than the other two settings and may require a callback contract to be implemented form the client, as well. In examples of these embodiments, all communication between the user interface tier and the business tier may be required to go through WCF interfaces. In examples of these embodiments, there are a number of hosting environment options for WCF. Referring to FIG. 39, these options have varying benefits and limitations and include IIS 7.0/7.5, which has the advantages of levering the benefits of Windows Process Activation Services (“WAS”) and being integrated with ASP.NET.

In embodiments, there may be a service adapter, which may serve as a bridge between the service interface and the business layer and may have one or more of the following characteristics: (1) it may call directly into the business layer; (2) it may communicate responses from the business layer to the user interface; (3) it may include a factory that chooses which particular business objects to use, such business components possibly including client-specific components, versions on the business tier, and other business components; (4) it may include a service adapter class library, which may implement a factory pattern to resolve the correct business layer components to execute, such class library possibly obviating the need for module-specific libraries; and (5) module-specific service adapters, which may be helpful in cases where the interfaces are complex. In examples of these embodiments, a dependency injection container, such as Unity, may be used to implement some or all of the service adapter functionality.

In embodiments, there may be a business layer, which may have one or more of the following characteristics: (1) the business layer has no knowledge of the service layer and (2) the business layer and any business logic layer code have no dependencies on code in the service layer.

In embodiments, there may be an application façade, which may be an object that provides a simplified interface to a larger body of code, such as a class or library and may have one or more of the following characteristics: (1) the application façade may make a software library easier to use and to understand, possibly through the use of convenient methods for common tasks; (2) the application façade may reduce dependencies of outside code on the inner workings of a library, thereby allowing more flexibility in developing the system, particularly given the possibility that most of the code in the disclosure will use the façade; (3) the application façade may wrap a poorly-designed collection of APIs with a single well-designed API; (4) the application façade may help to improve performance in SOA applications through the avoidance of interfaces that engage in wasteful or excessive communication by combining fine-grained operations into course-grained operations; and (5) the application façade may consolidate some tasks that use the same methods and classes into a single method call for the service.

In embodiments, there may be business components, which are re-usable pieces of business logic within a module and may be hidden from the service layer and called only from the façade and may be broken down into small pieces of code, which may help to achieve reusability and may prevent repeating sections of code.

In embodiments, there may be a domain model layer, which may have one or more of the following characteristics: (1) it may create a schema that matches the domain entities; (2) it may map domain entities to the database structure; (3) it may create self-tracking Plain Old CLR Objects (“POCOs”); (4) it may pass POCOs through to the user interface tier as objects; and (5) it may be limited in what it contains, such that it does not contain the context objects that perform database operations, which limitation may be beneficial in that having the context objects in the domain model could create a security gap in the application. Such POCOs may have one or more of the following characteristics: (1) they may be C# objects representing the entity model, where an entity is something in the application that must be represented by data; (2) they may be created using the ADO.NET Self-Tracking Entity Generator code generation template provided in Visual Studio; (3) they may be serialized across boundaries, modified, and sent back, containing a graph of their changes; and (4) they may have WCF [DataContract] and [DataMember] attributes attached, allowing them to be passed through WCF boundaries.

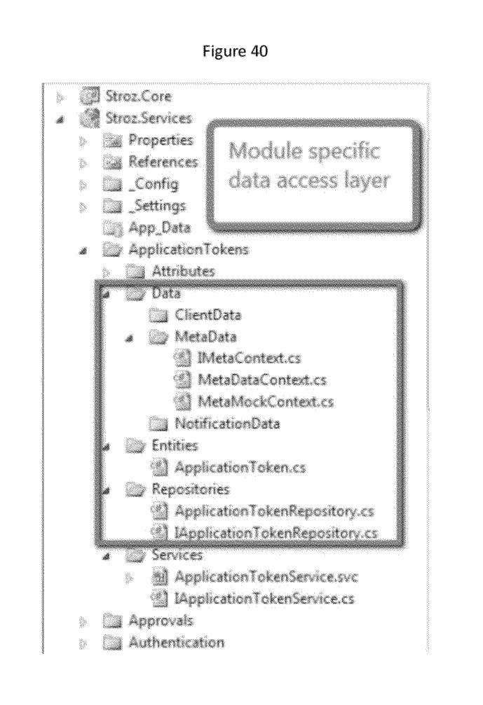

Referring to FIG. 40, in embodiments there may be a module-specific data access layer, which may contain repository files, entity files, and data files, including client data, metadata, and notification data.

In embodiments, there may be a resource access layer, which may contain data access logic and a service agent. Such data access logic may make use of the ADO.NET Entity Framework (“EF”), an object relational tool that may be used to develop applications that interact with data. The EF may have one or more of the following characteristics: (1) it may provide mapping between the relational database schemas and objects; (2) it may be helpful for architecting, designing, and developing at a conceptual level without worrying about details; (3) it may permit programming against the entity relationship (object) model, as opposed to querying against the relational database, which may allow programmers to concentrate mainly on the data; (4) it may have the benefit of making data-oriented applications maintenance-friendly; (5) it may handle access to such databases as SQL databases; (6) it may avoid using stored procedures except when such procedures are absolutely essential, which avoidance may help to prevent problems from arising during the code versioning process; and (7) it may involve one or more of the following three methods of defining entity models: (a) by starting with a legacy database (the “Database First” approach); (b) by using the Model First workflow to design a model in designer; and (c) by using Code First workflow to define classes, letting EF work with these classes. The Database First approach may have one or more of the following characteristics: (1) it may be very popular in cases where a database is designed by a database administrator, either separately or using an existing database; (2) it may be easy to implement, since EF creates entities after modification of mapping, such as by using a T4 template to generate POCO entities; (3) it may allow additional features in be added to POCO entities either by modifying the T4 template or through the use of partial classes; and (4) it may facilitate manual changes to the database, as the database defines the domain model, which in turn may facilitate updating the model from the database. The Model First approach may have one or more of the following characteristics: (1) it may involve drawing a model using a Visual Studio development tool, allowing workflow to generate a database script, and using a T4 template to generate POCO entities classes; (2) it may allow additional features in be added to POCO entities either by modifying the T4 template or through the use of partial classes; (3) it may involve the loss of manual changes to the database because the model defines the database, which may work better if the database generation power pack is installed; and (4) it may allow updating of database schema (as opposed to having to recreate them) or updating projects in Visual Studio. The Code First approach may have one or more of the following characteristics: (1) it may avoid the use of designers and the need to define mapping in Entity Data Model XML (“EDMX”), which can be very complex; (2) it may offer full control over the code by forgoing the use of any auto-generated code, which may be difficult to modify; (3) it may be limited to logic code, not including the database, which may be storage with no logic; (4) it may offer better maintainability and control over the entities; (5) it may result in manual changes to the database being lost because the model defines the database; and (6) it may leverage the benefits of object-relational mapping (“ORM”) and be integrated with the .NET framework, which may make it the best approach to use within the EF whenever possible.

In embodiments, there may be a service agent, which may have one or more of the following characteristics: (1) it may encapsulate the concerns of service consumers with regard to the web service; (2) it may manage the semantics of communication between applications and external services in instances where an application needs functionality from an external service; (3) it may isolate the idiosyncrasies of calling diverse services from applications; (4) it may provide additional services, such as basic mapping between the format of the data exposed by the service and the format required by the application; and (5) it may be capable of conducting web service integration in a manner similar to short message service (“SMS”) applications, acting on behalf of the client to request and operation on a service. In examples of these embodiments, the business components of a retail application could use a service agent to manage communication with a credit card authorization service and could use a second service agent to manage communication with a courier service.

In embodiments involving a service agent, the Windows Service Layer may be used on computers running the Microsoft Windows operation to run Windows services. Such Windows services may have one or more of the following characteristics: (1) they may be configured to start when the operating system is booted and run in the background as long as Windows is running or they may be started manually when required; (2) they may be similar in concept to UNIX daemons; (3) they may appear in the processes lists of systems running Windows in the Windows Task Manager, possibly with a username of SYSTEM, LOCAL SERVICE, or NETWORK SERVICE; and (4) they may run through svchost.exe as DLLs loaded into memory. In examples of these embodiments, one or more of the following steps may be used to manages the services in computers running Windows operating systems: (1) start, stop, pause, or restart services; (2) specify save parameters; (3) change the startup type, which may include (a) Automatic, which starts the services at system logon, (b) Manual, which may start a service as required or when called from an application, but does not always do so, (c) Disabled, which completely disables a service and prevents it and its dependencies from running; and (d) Automatic (Delayed), which is a new startup type introduced in Windows Vista, that may start a service a short time after the system has finished booting and initial busy operations have been completed, said delay being intended to increase boot-up speeds; (4) change the account under which the service logs on; (5) configure recovery options upon service failure; (6) export the list of services in a standardized format, such as text or CSV; and (7) send a notification email.

In embodiments, interactive portal data tier design may involve various data storage architecture options, including managing data in a shared database or in a dedicated database. Such shared databases may involve housing multiple tenants in the same database with each tenant having its own set of tables that are grouped into the same schema for the tenant and may have the lowest hardware and backup costs, because the sharing of databases allows the system to serve the largest number of tenants per database server. Storing tenant data in dedicated databases may be the simplest approach to data isolation. The shared approach may be appropriate when it is important that the application be capable of serving a large number of tenants with a small number of servers and when prospective users are willing to sacrifice data isolation in exchange for the lower costs that this approach makes possible. In an example, computing resources and application code may be shared between the tenants on a server, but each tenant may have its own set of data that remains logically isolated from data belonging to all other tenants.

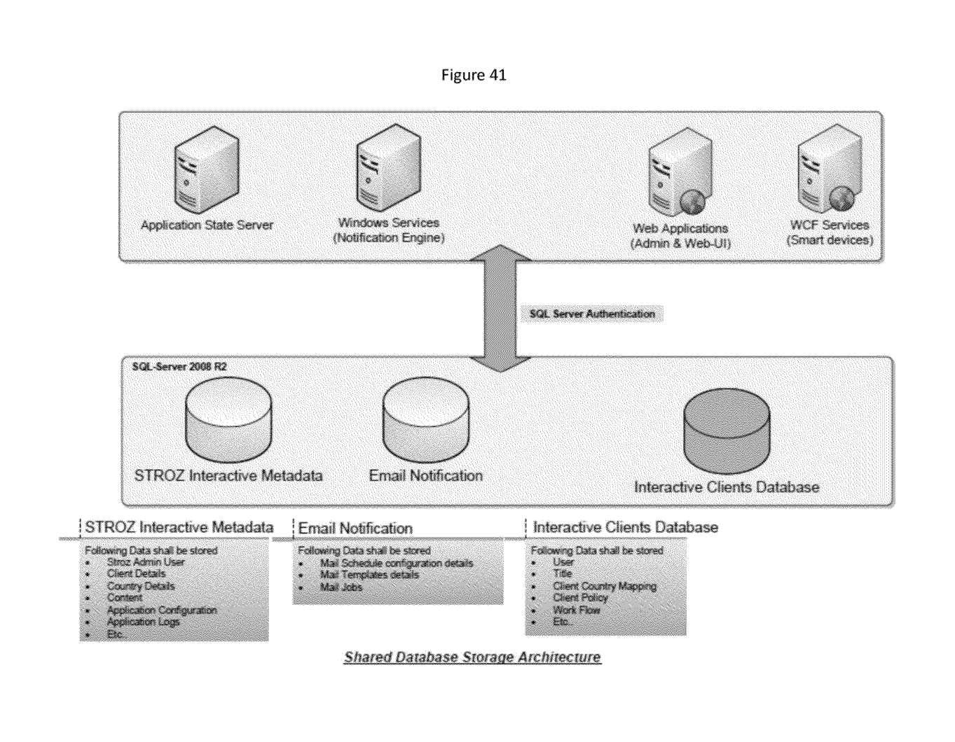

Referring to FIG. 41, in embodiments there may be a shared database storage architecture that includes one or more of the following: (1) an application state server, (2) a notification engine for Windows Services; (3) an administration and web user interface server that runs web applications; (4) a server that administers WCF services to smart devices; (5) interactive metadata; (6) an email notification system; and (7) an interactive clients database.

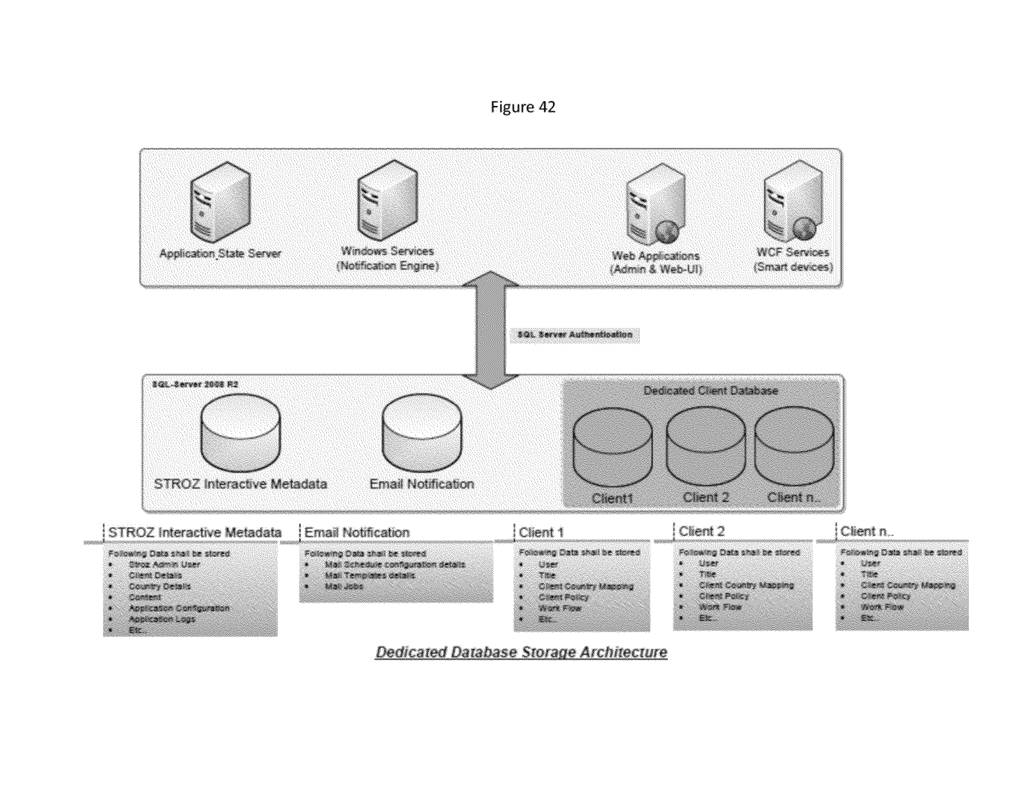

Referring to FIG. 42, in embodiments, there may be a dedicated database storage architecture in which metadata may associate each database with the correct tenant and database security may prevent any tenant from accidentally or maliciously accessing other tenants' data. Giving each tenant its own database may facilitate extending the application's data model to meet tenants' individual needs and may make restoring a tenant's data from a backup in the event of a failure a relatively simple procedure.

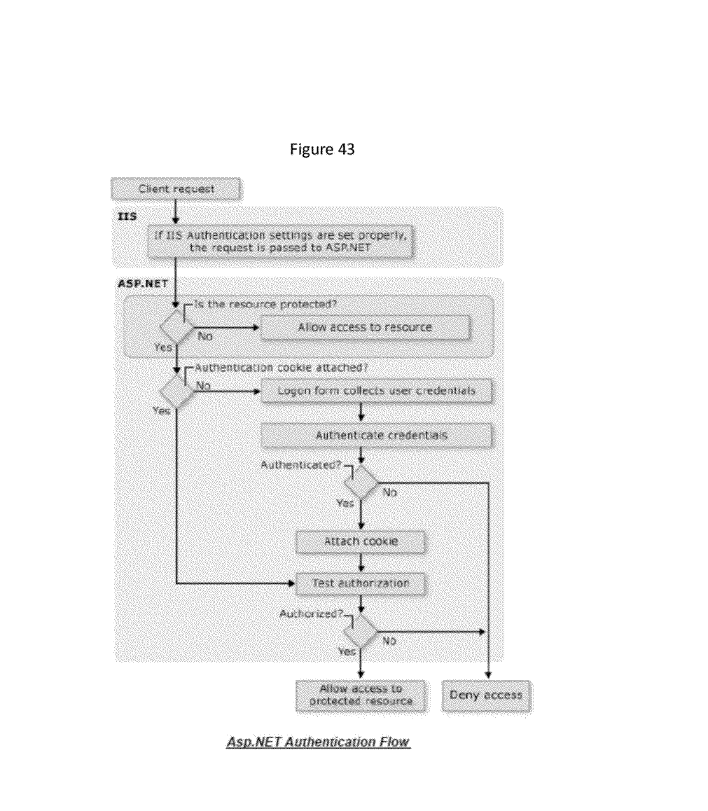

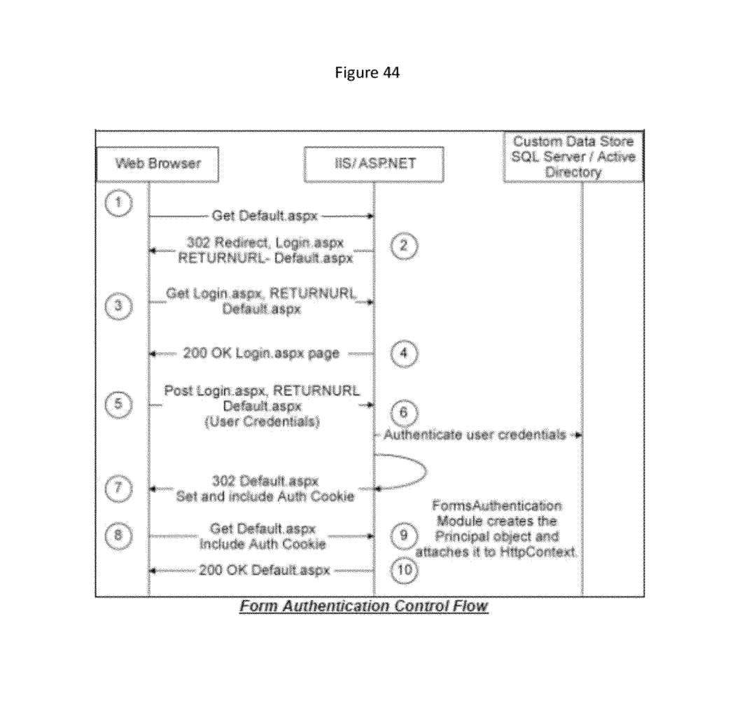

Referring to FIGS. 43 and 44, in embodiments the interactive portal may have security management features that include a forms authentication protocol, which may have one or more of the following characteristics: (1) it may use an authentication ticket that is created when a user logs on to a site; (2) it may track the user throughout the site; (3) it may be contained within a cookie or it may be located somewhere else, possibly through the use of ASP.NET's cookieless forms authentication option, which may pass the ticket in a query string; and (4) in cases where a user requests a page that requires authenticated access and the user is not logged onto the site, the user may be redirected to a configured logon page, which may prompt the user to supply credentials, such as a user name and password, and then be passed to the server and validated against a user store, such as a SQL Server database, and then be redirected to the originally requested page if the credentials were validated or to an access denied page if they were not.

In embodiments, the interactive decision portal may include an ASP.NET membership provider, which may provide a built-in way to validate and to store user credentials, may facilitate management of user authentication in web sites, and may be used with ASP.NET forms authentication through use of the ASP.NET login controls to set classes' libraries, facilitating the creation of a complete system for authenticating users. In addition, ASP.NET membership may be helpful for one or more of the following: (1) creating new users and passwords; (2) storing membership information, such as user names passwords, and supporting data, in a database store, such as a Microsoft SQL server, an Active Director, or an alternative data store; (3) authenticating users who visit the site, which may be accomplished programmatically or through use of the ASP.NET login controls to create a complete authentication system that requires little or no code; (4) password management, including creating, changing and resetting passwords, as well as possibly implementing a password-reset system that takes a user-supplied question and response; (5) exposing unique identifications for authenticated users that may be used in other applications and that may also integrate with ASP.NET personalization and role-management (authorization) systems; (6) specifying custom membership providers, which may allow developers to substitute custom code for membership management and to maintain membership data in a custom data store; and (7) supporting multiple providers for the same applications.

In embodiments, the interactive decision portal may use form authorization to control access. Such form authorization may determine whether an entity should be granted access to a specific resource. In some of these embodiments, ASP.NET may be used to authorize access resources, which it may do using file authorization or URL authorization. Such file authorization may have one or more of the following characteristics: (1) it may be performed by ASP.NET's FileAuthorizationModule; (2) it may check the access control list (“ACL”) of the .aspx or .asmx handler file to determine whether a user should have access to the file; and (3) it may verify ACL permissions for the user's Windows identity if Windows authentication is enabled or it may verify ACL permissions for the Windows identity of the ASP.NET process. Such URL authorization may have one or more of the following characteristics: (1) it may be performed by ASP.NET's UrlAuthorizationModule, which maps users and roles to URLs in ASP.net applications; and (2) it may be used selectively to allow or to deny access to arbitrary parts of an application, such as directors, for specific users and roles.

In embodiments involving an ASP.NET role management module, the ASP.NET role management module may be used to help manage authorization. This role management module may be used in one or more of the following ways: (1) it may facilitate specifying which resources various users in the application are allowed to access; (2) it may allow the grouping of users by assigning users to roles; (3) it may allow access roles to be set for each group; (4) it may facilitate the establishment of types of rules independent from individual application users, such that it may not possible to grant access to certain pages to the role of member and then simply add and remove users from that role as people sign up or let their memberships lapse, rather than having to grant individual members of a site access to member-only pages individually. In an example of these embodiments, custom role providers may be created to support client-wise authorization data sourcing, such creation leveraging the benefits of ASP.NET Role Provider and being integrated with ASP.NET.

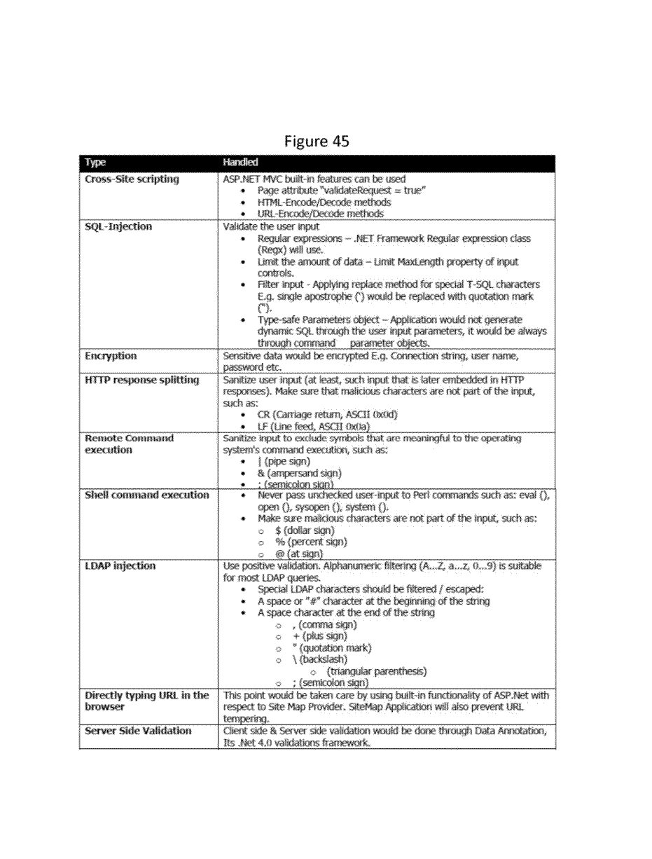

Referring to FIG. 45, in embodiments certain security coding standards may be used to perform various functions.

In embodiments, data encryption may be accomplished through the use of Secure Hash Algorithm 1 (“SHA-1”) or another data encryption method and may have one or more of the following characteristics: (1) it may use Federal Information Processing Standard (“FIPS”)-compliant algorithms, such as SHA-1, to conduct password one-way encryption, possibly using built-in class libraries; and (2) it may use 256-bit encryption to conduct two-way encryption, where a public key may be stored in a resource file with the same key possibly being shared with a system administrator, such two-way encryption with a 256-bit key possibly being used to encrypt sensitive data, such as email identifications, contact information, and personal user information.

In embodiments, exception management may be accomplished using an Error Logging class to log errors, such that appropriate custom-defined messages may be provided to users. Each such custom error message may have an associated identification code, allowing the message to be retrieved when called by its identification code. In an example, P20-002 could be the message identification code for the message, “We're sorry for the inconvenience. Your policy date is currently unavailable. Please check back later.” Such an approach to error management may allow error messages to be changed at any time in the future using the Update SQL script, not requiring any code change.

In embodiments, exception management may include one or more of the following: a DataAccess Layer, a Business Layer, a Service Layer, and a Presentation Layer. Such DataAccess Layer may have one or more of the following characteristics: (1) it may include implementation of a Try-Catch-Finalize block wherein catch provides the actual exception to the BO layer; (2) it may lack a Logger call function; and (3) it may have a condition for the check database validation operation in which a value of 0/false returns a Custom exception class with a validation message. Such Business Layer may have one or more of the following characteristics: (1) it may include implementation of a Try-Catch-Finalize block wherein there are two catch blocks, Custom Exception and System Exception; (2) it may have an Application Logger call function; (3) it may provide the custom exception class only to the Service Layer; (4) in passing the Custom Exception catch to the Service Layer, it may leave the error as it is, logging an exception message; and (5) it may respond to an Exception state by passing a Custom Exception class with the actual message fetched from the database. Such Service Layer may have one or more of the following characteristics: (1) it may include implementation of a Try-Catch-Finalize block wherein there is only one catch block Custom Exception; (2) it may lack a Logger call function; (3) it may pass only the Custom Exception class to the WCF layer; and (4) it may pass a Custom Exception catch as it is to the Presentation Layer. Such Presentation Layer may have one or more of the following characteristics: (1) it may include implementation of a Try-Catch-Finalize block wherein there are two catch blocks, Custom Exception and System Exception; (2) it may have an Application Logger call function; (3) it may show messages received from the Service Layer in a Custom Exception catch; and (4) when there is an Exception catch, it may log the error to the Application Logger and display a generic message fetched from the database.

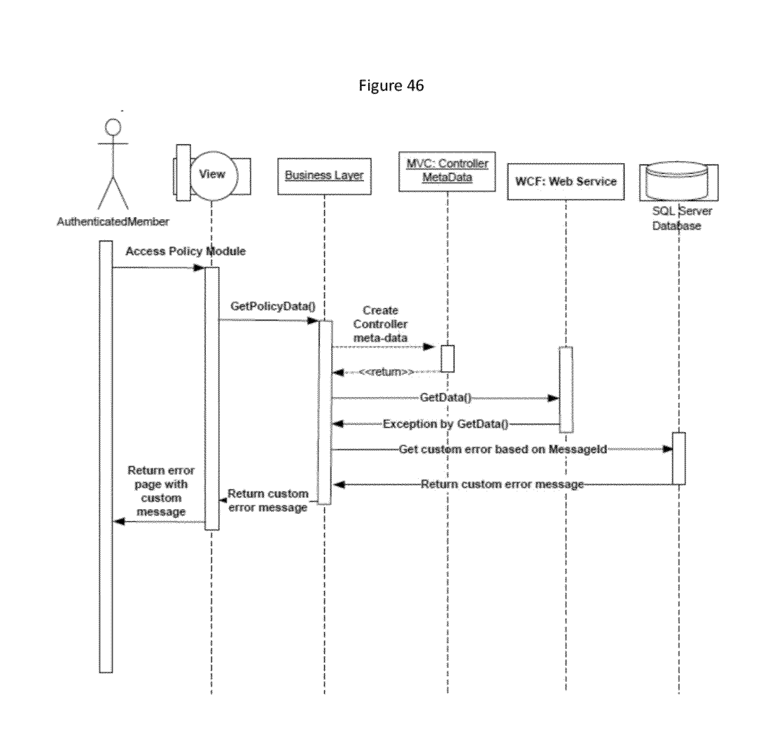

Referring to FIG. 46, in embodiments exception management may follow a proscribed sequence.

In embodiments, logging methods may be used for tracking such characteristics as usability, performance, errors, and related debugging activity, and notification of fatal exceptions. Such logging methods may include a Login Tracer Logger and an Application Logger. Such Login Tracer Logger may manage the process of tracing login and logout data in the port and may be connected at the Login and Logout button and link. Such Application Logger may have one or more of the following characteristics: (1) it may manage the process of logging data relating to such things as fatal exceptions, errors, validation, performance, warnings, and other information details; (2) it may be connected at various places such as error handling, production server debugging, performance data capturing, and integration scenarios; (3) it may be turned on and off through configuration; and (4) it may be classified in a category.

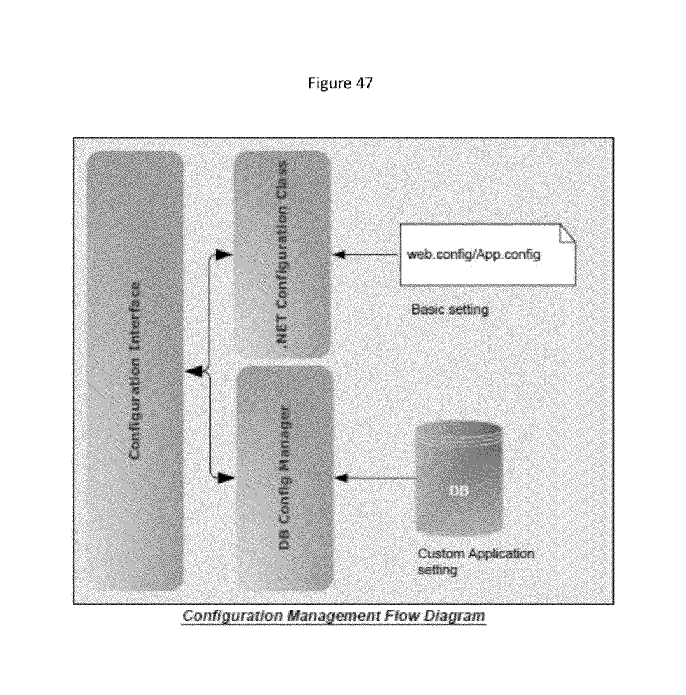

In embodiments, there may be a Configuration Management module that provides configuration setting information. Referring to FIG. 47, such Configuration Management module may have one or more of the following characteristics: (1) it may be designed in such a way as to allow configuration setting modifications to be made in the system without affecting the user's experience; (2) it may divide portal configuration data into multiple types of sources, with associated database tables; (3) it may include a set of elements defined by the .NET Framework that implement configuration settings; and (4) it may make use of elements in the ASP.NET configuration schema that control how ASP.NET web applications behave.

In embodiments, the Application State Management protocols may include use of caching and session management techniques. Such caching techniques may facilitate building high-performance, scalable web applications by storing items—including data, objects, pages, elements of pages, among other items—in memory the first time they are requested. Such caching techniques may have one or more of the following characteristics: (1) they may involve storing these items on the web server or other software in the request stream, such as the proxy server or browser, which may help to avoid having to recreate information that satisfied a previous request, particularly information that demands significant processor time or other resources; and (2) they may make use of ASP.NET caching techniques to store page output or application data across HTTP requests and to re-use such outputs and data. Such session management protocols may facilitate the storage and retrieval of user values as a user navigates ASP.NET pages in a web application, which may be helpful since HTTP is a stateless protocol that does not retain variable values from previous requests. Use of ASP.NET session state identifiers, which are enabled by default for ASP.NET applications, may allow information from earlier requests from the same browser during a limited time window (i.e. a session) to be accessed, providing a way to persist variable values for the duration of that session.

In examples, it may be possible to create high-performance web applications using the ASP.NET framework, which provides two types of caching mechanisms, output caching and data caching. Such output caching may allow values to be saved using session state, an instance of the HttpSessionState class, for each active web-application session. Session state may be similar to application state, except that it may be scoped to the current browser session with each user having a different session state, even when multiple users are accessing the application simultaneously. Similarly, when a user leaves the application and returns subsequently, that user will be assigned a new session state. Session state may be structured as a key/value dictionary for storing session-specific information that is designated to be stored between server round trips and between requests for pages. Such data caching may be configured in multiple modes, for example In-Proc and Out-Proc. OutProc may be further configured in two sub-modes, State Server and DQL-Server.

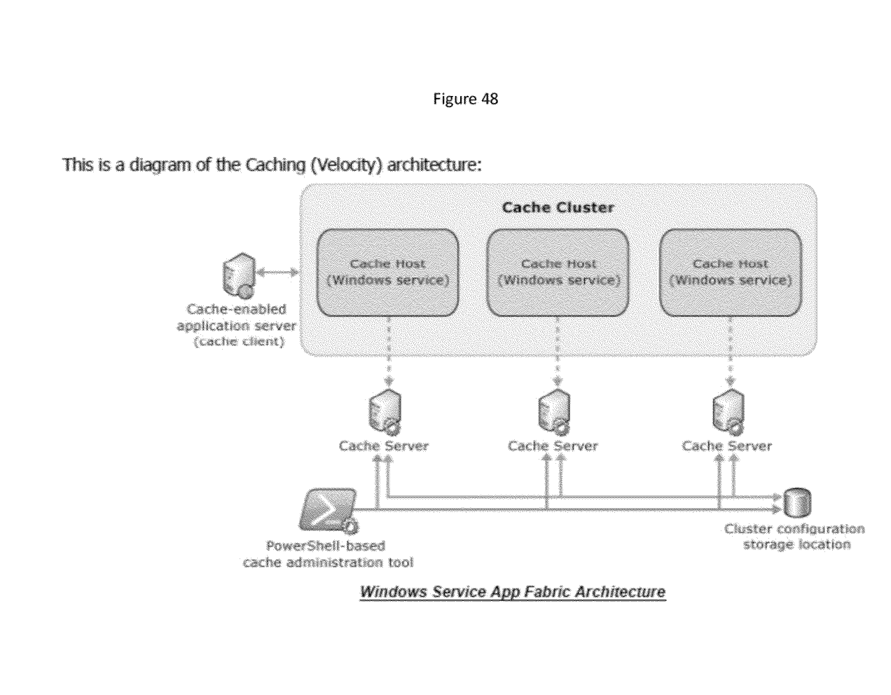

Referring to FIG. 48, in embodiments there may be a Windows Service Application Fabric Architecture in which AppFabric Caching may provide a cluster of cache hosts, potentially providing high scalability for the caching or “Velocity” architecture, and may serve as the host for ASP.NET sessions. It may be managed using a PowerShell administration tool and its configuration may be stored in a database or an XML file. Database configuration storage may be more secure than XML storage. In examples of these embodiments, the Velocity architecture may run on one or more servers in the form of a Windows service named the “cache host service.” Each server that runs a cache host service is referred to as a “cache server,” but Velocity may also be installed on servers that perform other functions, too, such as web and application servers. In these examples, only one instance of the cache host service may be installed for each cache server. The cache server may be a member of the same domain as the primary data source server used by the application. The cache host service may be installed to run under the Network Service account, which means that for operation over the network, the cache host service may use the security credentials of the cache server's domain computer account. Such cache host service may use the lower-privileged Network Service account to help mitigate the damage that could be caused by malicious attacks. One important security consideration that may exist when using AppFabric Caching is that in order to perform at a high level and to meet the scalability needs of the cache, communication between the main cache server and additional cache hosts in the cluster is unencrypted, and thus may be vulnerable to malicious network attacks that log or modify network traffic. This concern may be addressed by deploying the cache servers behind a firewall and by modifying firewall rules to allow the web servers to communicate with the cache port. In examples, the default port for a cache cluster may be 22233.

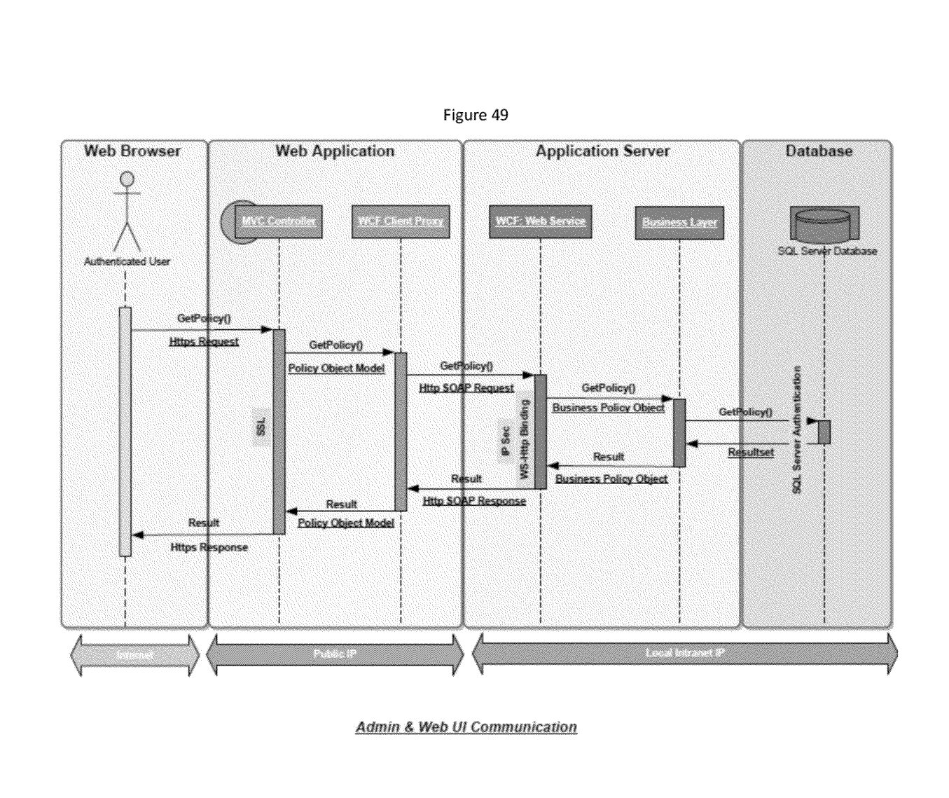

Referring to FIG. 49, in embodiments, there may a system of administrative and web user-interface communication that includes one or more of the following elements: (1) an authenticated user using a web browser to communicate with a web application; (2) a web application that may include an MVC Controller and a WCF client proxy and which may communicate both with the authenticated user and an application server; (3) an application server that may include both a WCF service and a business layer and which may communicate both with the web application and a database; and (4) a database that may be an SQL server database and may communicate with the application server.

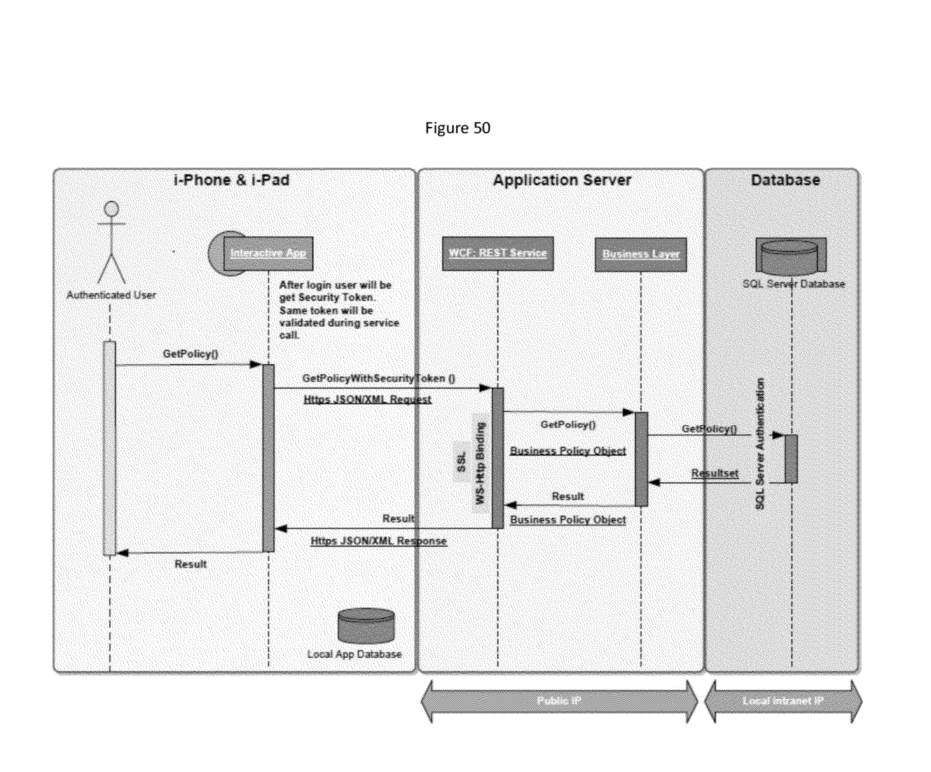

Referring to FIG. 50, in embodiments, there may be a system of communication with mobile devices that may include one or more of the following components: (1) an authorized user using a mobile device, such as an iPhone or iPad, where such device communicates with an application server; (2) an application server that may include both a WCF Representational State Transfer (“REST”) service and a business layer and which may communicate with both the web application and a database; and (3) a database that may be a SQL server database and may communicate with the application server.

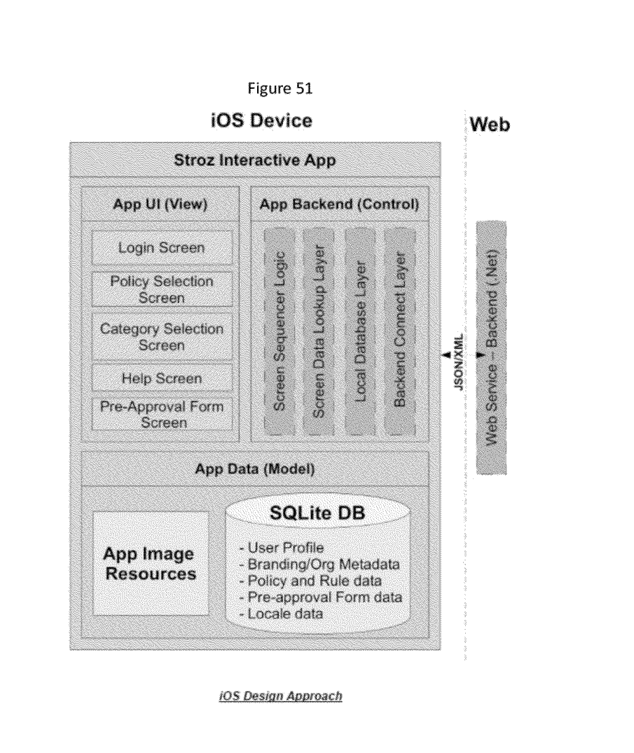

Referring to FIG. 51 in examples, the core mobile device user interface may be comprised of various controls native to the iOS platform, such that the alignment of these controls may be based on the height and width of the screen of the device on which they are being displayed, possibly requiring re-implementation to achieve proper look and feel orientation for screens with different aspect ratios.

In embodiments, there may be a DataConnect library that may contain all of the interaction and method calls that are be used to communicate with a backend service. Such a DataConnect library may allow for fetching and storing of data locally within the SQLite database, which may have the effect of allowing the application to run in offline mode. There may be a lookup controller that allows for interfacing between the user interface and data. Such a lookup controller may fetch appropriate data from the model layer and send those data to the view layer.

In embodiments, the interactive decision portal may include a mobile application, which may include one or more of the following modules: (1) a Splash Screen Module that may be responsible for the process of fetching a client-specific splash image and displaying that image on start up of the application; (2) a Login Screen Module that may show the user interface for the screen and use the controller layer to pass authentication information into a local database; (3) a Welcome Screen Module that may display user interface and profile information; (4) a Message Center Module that may be responsible for accessing the user's mailbox and looking for specific compliance messages—which may include pre-approval responses, compliance-related material, and compliance reminders—and displaying the indicators as well as a list of such messages in a Message List screen; (5) a Country Selection Module that may pre-select the current country by using GPS or other locational technology to determine where the mobile device is located; (6) a Policy Selection Module that may select the current context of what the user would like to see, such that the policy selected may be a determining factor in the rest of the flow; (7) a Category Selection Module that may allow a user to choose one of various categories depending on the current context, these categories having been loaded dynamically based on the organization's internal categorization; (8) a Help/Information Module that may retrieve and display context-specific information depending on which module the user is in, providing navigation elements that permit the user to return to the screen from which the user navigated to the help screen; (9) a Multilevel Interactive Question Module that may offer choice screens, such that the user's answer to each choice determines the next screen that will be displayed in the tree; (10) a Pre-Approval Form Module that may display a form into which relevant data may be inputted, the exact nature of the form depending upon the current user's context, with data entered into the form either being returned to the backend or, if the user is off-line, stored locally until such time as an internet connection can be established; (11) a Multi-Lingual Support Module that may provide for use of the application in selected languages other than English by translating text into such other languages; and (12) a Tracing Module that may capture the path followed by the user during the user's interaction with the application and may store data on the traversed path in a database on the device and then upload that database to the backend for analytics and data mining. In addition to these modules, the application may include other modules and Navigation Components, which may be spread across various areas of the application and which may allow the user to navigate among the areas of the application.

In embodiments, the client-server interactions may make use of state of the art security technology to provide secure access to all aspects of the application and to the data it stores and processes. In an example, applications running on iOS devices may implement iOS-specific security features as well as other appropriate security features.

In embodiments, the application may connect and interact with the backend over HTTPS and may make use of a security token on the backend to verify that each connection is valid and is authorized to access backend methods and services.

In embodiments, a mobile device may connect to the backend using HTTP/HTTPS, including standard GET, POST, DELETE, and PUT calls to specific web-service methods made available by the backend. The request and response packets for the web-service calls may be JSON-based.

In embodiments, a state management protocol involving a token that is established after login may be utilized for calls made from the device to the backend.

In embodiments, exceptions may be managed on the device with appropriate measures to resolve exceptions being coded into the application. Such an exception may prompt a user-friendly alert messages to inform the user about the exception. Additional messages may alert the user as to whether the user is working in online or offline mode and what features and functions are consequently available.

In an examples of embodiments involving mobile device applications running on iOS devices, distribution of one or more mobile device applications to large numbers of iOS mobile devices may be facilitated through use of an Apple Enterprise account. Such an account may be used to code-sign the iOS application, allowing it to be placed on internal websites and otherwise distributed to its target audience of employees and agents. Such a downloaded application may then be personalized to the individual and organization through the log-in process with specific branding data such as a company logo and images that may be designed to make the user's experience more readily associated with the user's organization.

In embodiments involving a mobile device application, data required by the mobile device application may be downloaded from the backend service, which may be accomplished through the use of JSON calls made to the backend with the return JSON data being parsed on the device. Such calls may be initiated using an HTTP Client, which would require the device to have an active internet connection. In these embodiments, the backend web-service may be required to be available 24 hours a day, seven days a week. In these embodiments, since the backend may provide all the data, it may be necessary to have a caching mechanism to save the downloaded data. In examples of these embodiments, the mobile device application may be optimized to run on recent versions of iOS devices, including the iPhone 5S and above and the iPad Air and above, running the most recent versions of iOS. In examples of these embodiments involving a mobile device application running on an iPad, resolution for customer images may be set at the highest current iPad fidelity.

In examples of embodiments involving a mobile device application, the mobile device application may include one or more of the following system resources: (1) an application icon, which may be 512 by 512 pixels, 264 dpi, and have a file size of approximately 1 MB; (2) a developer splash logo, which may 256 by 256 pixels, 72 dpi, and have a file size of approximately 1 MB; (3) a login page dummy profile image, which may be 256 by 256 pixels, 72 dpi, and have a file size of approximately 125 KB; (4) country flags, which may be 256 by 256 pixels, 72 dpi, and have a file size of approximately 125 KB; (5) a profile user image for each user, which may be 256 by 256 pixels, 72 dpi, and have a file size of approximately 125 KB; (6) a policy bookshelf book background image, which may be 256 by 256 pixels, 72 dpi, and have a file size of approximately 125 KB; (7) a “help me” image, which may be 128 by 128 pixels, 72 dpi, and have a file size of approximately 50 KB; (8) a messages image, which may be 128 by 128 pixels, 72 dpi, and have a file size of approximately 50 KB; (9) a return image, which may be 128 by 128 pixels, 72 dpi, and have a file size of approximately 50 KB; (10) a help desk image, which may be 128 by 128 pixels, 72 dpi, and have a file size of approximately 50 KB; (11) a stop image, which may be 128 by 128 pixels, 72 dpi, and have a file size of approximately 50 KB; (12) a submit request image, which may be 128 by 128 pixels, 72 dpi, and have a file size of approximately 50 KB; (13) a green tick-mark (checkmark) image, which may be 128 by 128 pixels, 72 dpi, and have a file size of approximately 50 KB; and (14) a phone image, which may be 128 by 128 pixels, 72 dpi, and have a file size of approximately 50 KB.

In examples of embodiments involving a backend application, the backend application may include one or more of the following system resources: (1) a customer splash logo, which may be 1024 by 1024 pixels, 72 dpi, and have a file size of approximately 1 MB and (2) category images corresponding to such categories as gift, entertainment, meal, hospitality, favor, and contribution, which may be 512 by 512 pixels, 72 dpi, and have a file size of approximately 250 KB.

In embodiments involving a mobile compliance application, the mobile compliance application may make use of a typical MVC pattern and may also have other patterns for other stages of its operation, such as a Cache Management pattern that may be used to have data readily available for a particular category. In general, the mobile compliance application may mold itself to have a flow over a tree branch, which aligns itself to have a pre-built structure within memory with all the branches loaded upfront. The mobile compliance application requirements may include storage space to hold form data when there is not an internet connection available. The mobile application may use a snapshot pattern to temporarily persist the pre-approval form data into a database locally before initiating its submission to the backend service once an Internet connection is restored. In examples, typical patterns such as Singleton, Abstract Factory, and Delegation may be used as necessary in various modules.

In embodiments involving compliance functionality, one or more of the following considerations may be relevant to implementation of the disclosure: (1) the interactive decision portal may be designed to cater to the needs of business users; (2) user authentication details may be stored in a database and active directory may be out of scope; (3) the authentication state may be marinated in client cookies, possibly using a built-in feature of ASP.NET; (4) the application may use available open ports based on firewall settings; (5) the Microsoft-recommended .NET, C#, and SQL-Server coding standards may be followed; (6) page size exclusive of images, external JavaScript, and external CSS files, may be taken into consideration; (7) user acceptance testing may be performed by the developer and may be taken into account in making changes to the application; (8) mobile device connection speed may be considered in estimating upload and download times of application files; (9) orientation may be limited to landscape only for certain devices, possibly including the iPad; (10) user interface changes may be limited after application planning is completed, so as to avoid unnecessary delays in development; (11) orientation may be limited to portrait only for certain devices, possibly including the iPhone; (12) the email coordinator may launch the email editor to set the email address of the compliance manager defined for the current user in that user's profile; (13) distribution of the iOS versions of the application may require an Enterprise Apple Developer Account; (14) the iOS versions of the mobile device application may be distributed directly to users rather than being submitted to the Apple for inclusion in Apple's App Store; (15) the developer may need to create application binaries for organization end-users; (16) data synchronization speeds may vary from country to country depending upon network speeds and web service response times; and (17) there may be distinct online and offline modes for the mobile application, such that during the offline mode, the user will only be able to view data that has been previously downloaded and stored on the device.

In examples, software elements of the disclosure may be developed using the Microsoft .NET framework 4.0 or later environment and the iOS platform. Such .NET framework may use an N-Tier design with clear separation of concerns between the Presentation Tier, the Application Tier, and the Data Tier. Such tiers may be physically separated. Such an architecture of layered components across multiple tiers may provide greater flexibility for re-use, as well as the ability to scale-out any specific tier and may also provide support for plug-in modular applications and SOA for the service layer. Such modules may create separate components, such as Client, Country, and Policy management. Such iOS applications may be designed like typical client-server applications and may follow an MVC pattern, wherein user interface components are in the View Layer, data components are in the Model Layer, and the entire business logic may be implemented in the Control Layer.

In embodiments, the interactive decision portal may enable investigatory and forensic functionality (herein referred to “investigatory” functionality). In embodiments involving investigatory functionality, the interactive decision portal may provide mobile device software designed for use by investigators, which shall be referred to herein, as an “investigation application.” Such an investigation application may include, but is not limited to, one or more of the following characteristics: (1) client users who are investigators may access the interactive decision portal via mobile devices or web-based clients; (2) such client users may use the interactive decision portal to facilitate their investigations of accidents, crimes, or other incidents; (3) the interactive decision portal may be used to facilitate investigations involving multiple investigators, some of whom may be assigned different tasks; (4) the interactive decision portal may pose questions to a client user regarding investigation-related issues, such as whether the investigator is at the scene of the incident, whether there are witnesses, what the names of the witnesses are, which witnesses the investigator has interviewed, whether the investigator has collected or photographed evidence, and the like; (5) the interactive decision portal may respond to the answers to such questions with further questions, with instructions, by seeking input from supervisors or other parties, or by taking other actions appropriate to the circumstances; (6) the interactive decision portal may keep records of all investigatory actions, decisions, communications, and related activities; (7) the interactive decision portal may analyze data gathered in the course of an investigation; (8) the interactive decision portal may produce reports regarding investigatory data and progress; (9) the interactive decision portal may produce charts, tables, graphs, or other materials that graphically illustrate investigation-related data and/or analysis; (10) there may be investigation managers who play a similar role in investigation embodiments that compliance managers play in compliance embodiments; (11) there may be appropriate data fields for investigation-related information, such as location of incident, type of incident, weather conditions, mechanical problems, and the like; and (12) the interactive decision portal may have access to and make use of applicable laws, regulations, rules, and procedures in performing its functions.

In an example embodiment of the interactive decision portal's investigatory functionality, an insurance company may use the interactive decision portal to facilitate the investigation of a train crash. A number of client users, investigating the crash, may access the interactive decision portal through their mobile devices. Some of these client users may be provided with instructions to investigate different aspects of the crash (e.g. one could look for obstructions on the tracks, one could investigate whether the train conductor was incapacitated, one could check the train's breaking systems, etc.). An investigator may indicate, using the interactive decision portal, that he had arrived on the scene of the accident and request instructions, triggering a series of questions and answers drawn from a decision tree, relating to available witnesses and evidence, site safety, injuries and deaths, damage to property, and the like. When a witness interview is arranged, the portal may record the interview using the mobile device's camera and microphone. The investigator may also be prompted with additional post-interview questions, such as whether the witness has or is willing to sign a statement, whether a lawyer was present during the interview and, if so, what the lawyer's contact data are, and the like. In this example, information provided to the interactive decision portal could prompt questions or instructions to another investigator. For example, if one investigator indicated that the conductor appeared to be under the influence of alcohol, other investigators could be instructed to find additional witnesses who were aware of when and how much the conductor had been drinking.

In other examples of embodiments involving the investigatory functionality of the interactive decision portal, a police department may use the interactive decision portal to investigate crimes; a regulatory agency may use the interactive decision portal to investigation securities or financial fraud; a corporation may use the interactive decision portal to facilitate the investigation of embezzling by employees; and the like.

In embodiments, the interactive decision portal may enable operational management functionality, referred to herein, as an “operational management application.” Such an operational management application may include one or more of the following characteristics: (1) client users who have responsibility for entering into relationships with other entities may use it to evaluate entities to determine the risk of initiating, continuing, or expanding relations with those entities; (2) client users who have human resources responsibility may use it to determine what activities are appropriate when conducting research on prospective and current employees, such as social media-related research; (3) client users who have financial reporting responsibility may use it to determine whether transactions or other activity should be reported to regulatory agencies; (4) client users who have supply chain responsibility may use it in supply chain operation and development; (5) the interactive decision portal may generate documentation to support decisions regarding relationships with other entities and employee, decisions regarding the content and timing of regulatory filings, and decisions regarding supply chain operation and development; (6) the interactive decision portal may produce charts, tables, graphs, and other displays relating to management decisions and associated portal data; (7) the interactive decision portal may analyze data related to management decisions; (8) the interactive decision portal may produce reports regarding management issues; (9) the interactive decision portal may produce charts, tables, graphs, or other materials that graphically illustrate operational and planning considerations and results; (10) there may be operational managers who play a similar role in investigation embodiments that compliance managers play in compliance embodiments; (11) there may be appropriate data fields for management-related information, such as human resources data, financial data, supply chain information, and the like; and (12) the interactive decision portal may have access to and make use of applicable laws, regulations, rules, and procedures in performing its functions.

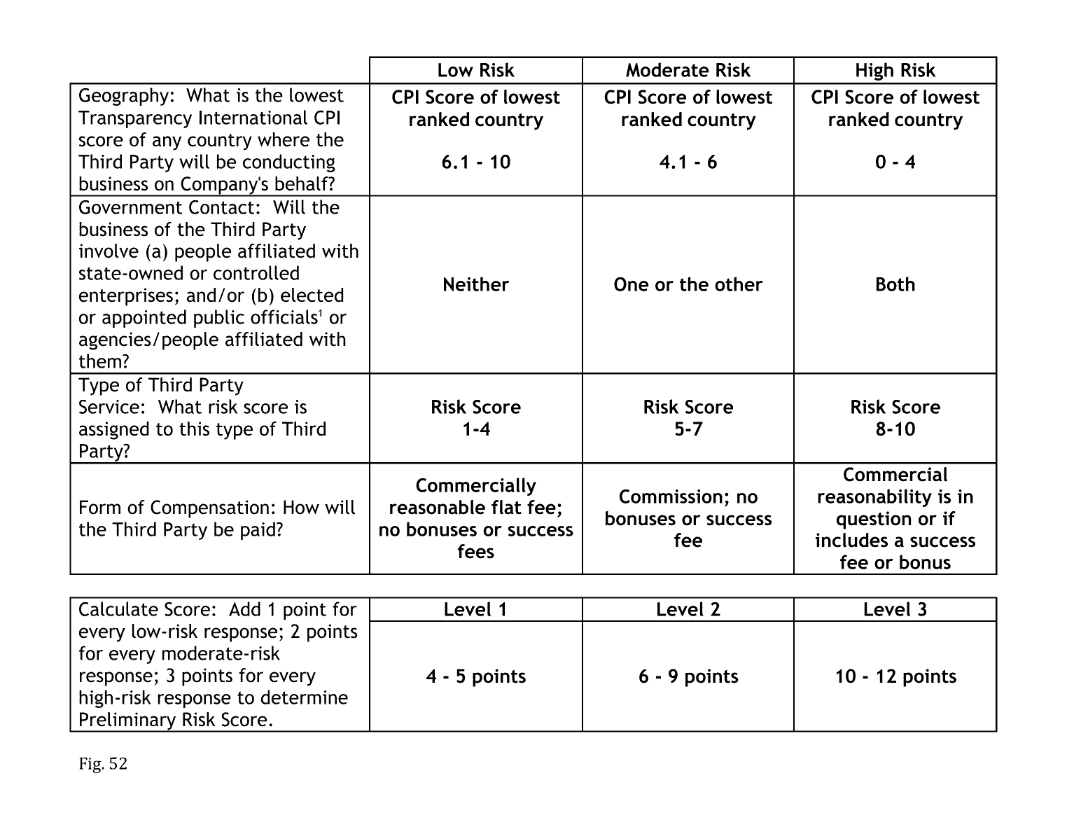

In an example of an embodiment involving operational management or due diligence functionality, the operational management application may conduct a corruption risk assessment of entities with which the client organization is considering entering into a business relationship or approaching a decision point regarding whether to continue or to expand an existing business relationship. Such a corruption risk assessment, as illustrated in FIG. 52, may evaluate the corruption risk of doing business with an entity based on such factors as where that entity operates, whether it is affiliated with state owned entities and government officials, the type of product or service it provides, and the form of compensation involved in the transaction. Continuing the example, a risk perception score may be generated by rating the entity as low risk, moderate risk, or high risk in each of these four categories and adding one point for each low risk response, two points for each moderate risk response, and three points for each high risk response to generate a rating from 4 to 12, with a rating of 4-5 being designated as a Level 1 risk, a rating of 6-9 being designated as a Level 2 risk and a rating of 10-12 being designated as a Level 3 risk. In this example, risk assessments could be run each time a relationship changes or when a change to the relationship or the operations of an associated entity appears to be imminent. Preliminary risk scores could be correlated with separate ratings of the value of strategic partnerships to determine acceptable risk thresholds. Similarly, currency risk, political instability, and other factors could be used to create more complex risk assessments.

In another example of an embodiment involving operational management functionality, human resources managers may wish to research current and prospective employees through such means as access to their social media networks. Client users who are human resources managers could use the interactive decision portal to determine which channels of social media investigation are appropriate. For example, the interactive decision portal may be used to answer such questions as whether it permitted to look at the Facebook page of an employee located in France when evaluating that employee for a potential promotion and whether it is appropriate to “friend” a potential employee in the United States in order to review her Facebook posts as part of a hiring process.

In embodiments, the interactive decision portal may enable collaborative research functionality, referred to herein, as a “collaborative research application.” Such a collaborative research application may include one or more of the following characteristics: (1) client users who are researches may access the interactive decision portal via mobile devices or web-based clients; (2) such client users may use the interactive decision portal to facilitate their scientific research by allocating research tasks across multiple organizations and institutions; (3) the interactive decision portal could pose questions to a client user regarding avenues of research, such as amounts of reagents to be varied, duration of exposure, control groups, etc. and could develop a research protocol based on those responses that could be shared with collaborators at remote locations, potentially accelerating the pace of scientific research and enabling the collection of large data sets in cases where a primary researcher has limited access to resources; (4) the interactive decision portal may determine that assumptions and protocols should be confirmed by an independent expert in the field and could generate requests to other researchers asking them for input into these questions; (6) the interactive decision portal may keep records of all laboratory results, research protocols, actions, decisions, communications, and related activities; (7) the interactive decision portal may analyze data gathered in the course of a research project; (8) the interactive decision portal may produce reports regarding research data and progress; (9) the interactive decision portal may produce charts, tables, graphs, or other materials that graphically illustrate research-related data and/or analysis; (10) there may be research managers who play a similar role in investigation embodiments that compliance managers play in compliance embodiments; (11) there may be appropriate data fields for research-related information, such as details of experiments conducted, protocols used, assumptions, timetables, collaborators, and the like; and (12) the interactive decision portal may have access to and make use of related research and scientific resources as it carries out its functions.

In an example embodiment of the collaborative research functionality, a team of researchers at a university in Country A attempting to isolate a gene that may be useful in treating a disease could work with teams of researchers in Countries B, C, and D with the researchers in Country B attempting to sequence the entire DNA of the organism containing the gene, the team in Country C splicing various genes from the organism into bacteria, and the team in Country D infecting mice with those bacteria. In this example, the research director in Country A serves as the client administrator and the other research teams are client users.

It should be readily apparent from these embodiments and examples how the interactive decision portal may be adapted for use in other group endeavors.

In embodiments, the disclosure may be developed using a test-driven approach that may involve developing test cases for each component and testing to determine whether that component performs as expected when presented with test cases. Such testing may be expanded to include additional test cases that are identified during the development process. In order for some test cases to run successfully, it may be necessary for developers to create stub functions until they can build the actual functions.

In embodiments, all code may be unit tested in a number of test scenarios, which may include one or more of the following: (1) check valid and invalid input; (2) check exception handling; (3) verify all return cases; and (4) verify side effects. In these embodiments, each unit test may cover every line of code with a given code unit.

In embodiments, each developer may be given responsibility for executing Style-Cop to coding standard and commenting, as well as responsibility for executing test cases. Code that fails such unit test cases may be subject to exclusion from the source code management system.

In embodiments, Ghostdoc or a similar utility may be used to record detailed code comments. Such comments may be extracted from the source code using the VC# compiler and NDoc may be used to extract comments into a Help file.

In embodiments, a code repository may be used for the development of implementations of the interactive decision portal. Such code repository may be subject to access restrictions, such as requiring that it be checked out by only one developer at a time and requiring that it be checked in daily. In an example of these embodiments, Tortoise SVN or a similar product may be used as the code repository.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A method for facilitation of enterprise compliance with managed rules or policies, the method comprising:
deploying an interactive mobile device compliance application to each of a plurality of enterprise users, wherein the compliance application includes a decision tree structure with decision nodes, wherein an enterprise user answers one or more specific questions and compliance guidance with respect to one or more managed rules or policies is provided according to received answers to the questions; and
managing an interactive decision facilitation portal to enable the decision tree structure, wherein the interactive decision facilitation portal enables both computer-algorithm-implemented decision nodes and human-aided decision nodes for the decision tree structure.

2. The method of claim 1, wherein the managed rules or policies are promulgated by at least one of a government and an enterprise.

3. The method of claim 1, further comprising recording, in a database, interactions of each of the enterprise users with the compliance application to provide a searchable record of enterprise compliance with the managed rules or policies.

4. The method of claim 3, further comprising analyzing the recorded interactions of the enterprise users and preparing reports regarding compliance with the managed rules or policies by the enterprise users.

5. The method of claim 1, further comprising establishing bi-directional communication between enterprise users to facilitate a decision with respect to a human-aided decision node.

6. The method of claim 5, wherein the bi-directional communication comprises an least one of email messages and voice communication.

7. The method of claim 1, wherein the decision tree structure includes decision nodes relating to at least one of: a selection of a rule or policy, a selection of a country in which a rule or policy applies, a selection of a language, a selection of a currency, a currency amount, a help process relating to a rule or policy, an education process relating to a rule or policy, and an approval process relating to a rule or policy.

8. The method of claim 1, further comprising receiving from an administrative user at least one of: information regarding which enterprise users are allowed access to the interactive decision facilitation portal, information regarding country management, information regarding rule and policy management, and metadata management related to an enterprise structure.

9. A method for facilitation of enterprise compliance with managed rules or policies promulgated by governments or organizations, the method comprising:
providing access for each of a plurality of enterprise users to a web-based compliance application, wherein the compliance application includes a decision tree structure with decision nodes, wherein an enterprise user answers one or more specific questions and compliance guidance with respect to one or more managed rules or policies is provided according to received answers to the questions; and
managing an interactive decision facilitation portal to enable the decision tree structure, wherein the interactive decision facilitation portal enables both computer-algorithm-implemented decision nodes and human-aided decision nodes for the decision tree structure.

10. The method of claim 9, further comprising recording, in a database, interactions of each of the enterprise users with the compliance application to provide a searchable record of enterprise compliance with the managed rules or policies.

11. The method of claim 10, further comprising analyzing the recorded interactions of the enterprise users and preparing reports regarding compliance with the managed rules or policies by the enterprise users.

12. The method of claim 9, further comprising managing bi-directional communication between enterprise users to facilitate a decision with respect to a human-aided decision node.

13. The method of claim 12, wherein the bi-directional communication comprises an least one of email messages and voice communication.

14. The method of claim 9, wherein the decision tree structure includes decision nodes relating to at least one of: a selection of a rule or policy, a selection of a country in which a rule or policy applies, a selection of a language, a selection of a currency, a currency amount, a help process relating to a rule or policy, an education process relating to a rule or policy, and an approval process relating to a rule or policy.

15. The method of claim 9, further comprising receiving from an administrative user at least one of: information regarding which enterprise users are allowed access to the interactive decision facilitation portal, information regarding country management, information regarding rule and policy management, and metadata management related to an enterprise structure.

16. A method for facilitation of enterprise compliance with governmental rules, the method comprising:
deploying an interactive mobile device compliance application to each of a plurality of enterprise users, wherein the compliance application includes a decision tree structure in which a user answers one or more specific questions and compliance guidance with respect to government rules is provided according to received answers to the questions;
managing an interactive decision facilitation portal to enable the decision tree structure, wherein the interactive decision facilitation portal enables both computer-algorithm-implemented decision nodes and human-aided decision nodes for the decision tree structure; and
recording, in a relational database, interactions of each of the enterprise users with the compliance application to provide a searchable record of enterprise compliance with government rules.

17. The method of claim 16, wherein the government rules include rules related to gift giving.

18. The method of claim 16, further including analyzing the recorded interactions of the enterprise users and preparing reports regarding compliance with the managed rules by the enterprise users according to each specific managed rule.

19. The method of claim 16, wherein the interactive compliance application includes various versions for multiple platforms.

20. The method of claim 16, further comprising providing a user interface for analyzing and viewing the recorded interactions of the enterprise users.
